(19) United States
(12) Patent Application Publication
(10) Pub. No.: US 2024/0164979 A1
(43) Pub. Date: May 23, 2024

(54) SYSTEM, METHOD AND DEVICE FOR MONITORING AND EXPRESSING COMPLIANCE OF A MEDICAL TREATMENT

(71) Applicant: KPR U.S., LLC, Dublin, OH (US)

(72) Inventors: Laura BRAMES, Chesterfield, MO (US); Jerald BROOKS, Creve Coeur, MO (US); Meghan FOX, St. Louis, MO (US); Steve MALLIEN, Florissant, MO (US); Daniel SCHNETTGOECKE, O'Fallon, MO (US); Daniel TAYLOR, St. Louis, MO (US); Megha MAHADEVAN-SHAH, Arlington Heights, IL (US)

(21) Appl. No.: 18/514,510

(22) Filed: Nov. 20, 2023

Related U.S. Application Data
(60) Provisional application No. 63/384,359, filed on Nov. 18, 2022.

(51) Int. Cl. A61H 9/00

(52) U.S. Cl. CPC A61H 9/0092; A61H 9/0007; A61H 2201/0119; A61H 2201/0188; A61H 2201/165; A61H 2201/5007; A61H 2201/5046

(57) ABSTRACT

A compression garment controller and a method for monitoring compliance of a user wearing a compression garment wrapped around a limb of the user in accordance with a compression therapy. The method comprising directing a flow of fluid from a pressurized fluid flow source to cyclically inflate and deflate an inflatable bladder of the compression garment; receiving pressure signals indicative of fluid pressure in the inflatable bladder from a pressure sensor communicatively coupled thereto during at least one of inflation and deflation of the inflatable bladder in a plurality of successive compression cycles; processing the received pressure signals to determine compliance or non-compliance with the compression therapy; causing at least one a light emitting diode (LED) to illuminate in a first color indicating compliance with the compression therapy; and causing the at least one LED to illuminate in a second color indicating non-compliance with the compression therapy.

### CLAIM OF PRIORITY

This application claims the benefit of U.S. Provisional Patent Application Ser. No. 63/384,359, filed Nov. 18, 2022, titled “SYSTEM, METHOD AND DEVICE FOR MONITORING AND EXPRESSING COMPLIANCE OF A MEDICAL TREATMENT”, the disclosure of which is hereby incorporate by reference.

### TECHNICAL FIELD

Aspects of the present disclosure relate to a system, method and a device for controlling, monitoring and expressing compliance of a medical treatment and more specifically the controlling, monitoring and expressing compliance of compression therapy.

### BACKGROUND

Intermittent pneumatic compression (IPC) systems include devices used to apply pressurized fluid, such as air, to a limb of a patient or wearer. In some instances, pressurized air is applied to the lower limb of a patient at risk for the formation of deep vein thrombosis (DVT). An IPC system typically includes a pumping unit to manage pressurization of the fluid, a tubing set to extend the delivery of fluid beyond the pumping unit, and a compression garment which is wrapped around the patient's limb and contains the pressurized fluid. The IPC system intermittently pressurizes the garment to apply therapeutic compression to the patient's limb, moving blood from that area of the limb. The effectiveness of such IPC systems for DVT prophylaxis, however, depends on the patient's adherence to a compression therapy or a prescribed treatment protocol including the IPC system.

### SUMMARY

In some aspects, the techniques described herein relate to a compression garment controller for monitoring compliance of a user with respect to wearing a compression garment in accordance with a compression therapy, the controller including: a display screen configured to display a graphical user interface; at least one light emitting diode (LED) configured to selectively illuminate different colors; at least one computer readable storage medium configured for storing one or more monitored parameters; one or more processors coupled to at least one computer readable storage medium; and computer-executable instructions embodied on at least one computer readable storage medium, the computer-executable instructions including instructions for causing the one or more processors to: direct a flow of fluid from a pressurized fluid flow source to cyclically/repeatably inflate and deflate at least one inflatable bladder of the compression garment configured to be wrapped around a limb of a wearer of the garment; receive pressure signals indicative of fluid pressure in at least one inflatable bladder from a pressure sensor communicatively coupled thereto during at least one of inflation and deflation of at least one inflatable bladder in a plurality of successive compression cycles; process the received pressure signals; cause at least one LED to illuminate a first color in response to the received pressure signals indicating compliance with compression therapy; and cause at least one LED to illuminate a second color in response to the received pressure signals indicating an interruption of operation or non-compliance with compression therapy.

In some aspects, the techniques described herein relate to a controller attachment configured to couple a compression garment controller with a pole, the controller attachment including: a first receiving portion including a concave portion adapted to receive a portion of a handle of the compression garment controller; a second receiving portion coupled with the first receiving portion and including a channel adapted to receive one or more wires or tubes; an interconnector coupled with the second receiving portion; and a pole attachment portion coupled with the interconnector and having a U shape adapted to captively receive a pole.

In some aspects, the techniques described herein relate to a method for a compression garment controller for monitoring compliance of a user wearing a compression garment wrapped around a limb of the user in accordance with a compression therapy, the method comprising: directing a flow of fluid from a pressurized fluid flow source to cyclically inflate and deflate an inflatable bladder of the compression garment; receiving pressure signals indicative of fluid pressure in the inflatable bladder from a pressure sensor communicatively coupled thereto during at least one of an inflation and deflation of the inflatable bladder in a plurality of successive compression cycle; processing the received pressure signals to determine compliance or non-compliance with the compression therapy; causing at least one light emitting diode (LED) to illuminate in a first color in response to the received pressure signals indicating compliance with the compression therapy; and causing the at least one LED to illuminate in a second color in response to the received pressure signals indicating an interruption of operation or non-compliance with compression therapy.

In some aspects, the techniques described herein relate to a compression garment system comprising: a compression garment; and a controller, wherein the controller includes: a display screen configured to display a graphical user interface (GUI); a plurality of light emitting diodes (LEDs) arranged at a visible angle on the controller; a memory; a processor coupled to the memory and configured to: direct a flow of fluid from a pressurized fluid flow source to cyclically inflate and deflate an inflatable bladder of the compress garment configured to be wrapped around a limb of a wearer of the compression garment; receive pressure signals indicative of fluid pressure in the inflatable bladder from a pressure sensor communicatively coupled thereto during at least one of inflation and deflation of the inflatable bladder in a plurality of successive compression cycles; process the received pressure signals to determine compliance or non-compliance with the compression therapy; cause the plurality of LEDs to illuminate in a first color in response to the received pressure signals indicating compliance with the compression therapy; and cause the plurality of LEDS to illuminate in a second color in response to the received pressure signals indicating an interruption of operation or non-compliance with the compression therapy.

Other aspects, features, and advantages will be apparent from the description and drawings, and from the claims.

### BRIEF DESCRIPTION OF THE DRAWINGS

FIG. 1 is a perspective view of a compression system including a compression garment and a controller in accordance with an aspect of the present invention.

FIG. 2 is a schematic representation of the compression system of FIG. 1, including a schematic of a pneumatic circuit in accordance with an aspect of the present invention.

FIG. 3 is a schematic representation of another exemplary compression system of FIG. 1, including a schematic of a pneumatic circuit in accordance with an aspect of the present invention.

FIG. 4 is a graphical representation of a pressure profile produced by the compression system of FIG. 1 when the compression garment is in a wrapped configuration on a leg form, simulating a limb of a wearer in accordance with an aspect of the present invention.

FIG. 5 is a graphical representation of a pressure profile produced by the compression system of FIG. 1 when a compression garment of the system is in an unwrapped configuration and away from a leg form, simulating a limb of a wearer in accordance with an aspect of the present invention.

FIG. 6 is a graphical representation of the manifold pressure signals of the compression system of FIG. 1, the manifold pressure signals corresponding to manifold pressure signals for the wrapped and unwrapped compression garment configurations in FIGS. 4 and 5, respectively.

FIG. 7 is a perspective view of a controller of the compression system in accordance with an aspect of the present invention.

FIG. 8 is a side view of a controller being attached to a bed board in accordance with an aspect of the present invention.

FIG. 9A is a back view of a pole attachment portion of an attachment member prior to being attached to a pole in accordance with an aspect of the present invention.

FIG. 9B is a back view of a pole attachment portion of an attachment member attached to a pole in accordance with an aspect of the present invention.

FIG. 10A is a front perspective view of an attachment member in accordance with an aspect of the present invention.

FIG. 10B is a front view of an attachment member in accordance with an aspect of the present invention.

FIG. 10C is a side view of an attachment member in accordance with an aspect of the present invention.

FIG. 10D is a back view of an attachment member in accordance with an aspect of the present invention.

FIG. 10E is a top view of an attachment member in accordance with an aspect of the present invention.

FIG. 10F is a perspective view of a controller attached to an attachment member in accordance with an aspect of the present invention.

FIG. 11 is a front view of a display of a controller in accordance with an aspect of the present invention.

FIGS. 12A and 12B is an exemplary flow diagram of a method of a startup of a controller in accordance with an aspect of the present invention.

FIGS. 13A and 13B is an exemplary flow diagram of a method for expressing compliance of a compression therapy in accordance with an aspect of the present invention.

FIG. 14A is a graphical representation of a graphical user interface (GUI) displaying a single three bladder leg sleeve garment icon in accordance with an aspect of the present invention.

FIG. 14B is a graphical representation of a foot cuff icon in accordance with an aspect of the present invention.

FIG. 14C is a graphical representation of a three bladder leg sleeve icon in accordance with an aspect of the present invention.

FIG. 14D is a graphical representation of a single bladder leg sleeve icon in accordance with an aspect of the present invention.

FIG. 14E is a graphical representation of a vascular refill detection icon in accordance with an aspect of the present invention.

FIG. 14F is a graphical representation of a garment mismatch error icon in accordance with an aspect of the present invention.

FIG. 15 is a graphical representation of a graphical user interface (GUI) displaying a compliance meter graphic for a compression therapy in accordance with an aspect of the present invention.

FIG. 16 is a graphical representation of a graphical user interface (GUI) displaying multiple compliance meter graphics for a compression therapy in accordance with an aspect of the present invention.

FIG. 17 is an exemplary flow diagram for selecting a current time zone in accordance with an aspect of the present invention.

FIG. 18 is a graphical representation of a graphical user interface (GUI) displaying a menu in accordance with an aspect of the present invention.

FIG. 19 is a graphical representation of a graphical user interface (GUI) displaying a world map for selecting a current time zone in accordance with an aspect of the present invention.

FIG. 20 is an exemplary flow diagram of a method of compliance monitoring using the compression system of FIG. 1 in accordance an aspect of the present invention.

FIGS. 21A and 21B are flow diagrams of exemplary implementations of a sleeve removed detection method in accordance with aspects of the present invention.

FIG. 22 is a flow diagram of an exemplary implementation of a sleeve reapplied detection method in accordance with aspects of the present invention.

FIG. 23 is a graphical representation of polynomial curve fit lines of the pressure in the manifold during an inflation phase of a bladder of the compression garment in both the wrapped and unwrapped configurations in accordance with an aspect of the present invention.

FIG. 24 is a graphical representation of a first pressure profile produced by the compression system of FIG. 1 when the compression garment is in a wrapped configuration on a limb of a wearer in accordance with an aspect of the present invention.

FIG. 25 is graphical representation of a first pressure profile produced by the compression system of FIG. 1 when the compression garment is in an unwrapped configuration and away from a limb of a wearer in accordance with an aspect of the present invention.

FIG. 26 is a flow diagram of a first method of compliance monitoring using the compression system of FIG. 1 in accordance with aspects of the present invention.

FIG. 27 is a flow diagram of a second method of compliance monitoring using the compression system of FIG. 1 in accordance with aspects of the present invention.

FIGS. 28A-28C are graphical representations of a first set of pressure profiles produced by the compression system of FIG. 1 when the compression garment is in a wrapped configuration on a limb of a wearer in accordance with aspects of the present invention.

FIG. 29 is graphical representation of a second pressure profile produced by the compression system of FIG. 1 when the compression garment is in an unwrapped configuration and away from a limb of a wearer in accordance with an aspect of the present invention.

FIGS. 30A and 30B are graphical representations of a third pressure profile produced by the compression system of FIG. 1 when the compression garment is in a wrapped configuration on a limb of a wearer in accordance with aspects of the present invention.

FIG. 31 is a flowchart of an exemplary method of analyzing waveform data received from a pressure sensor to determine whether the compression garment is in the wrapped or unwrapped configuration around a limb of a wearer of the garment by detecting pulsations associated with the heartbeat of the wearer in accordance with aspects of the present invention.

FIG. 31

FIG. 32 is a flowchart of an exemplary method of analyzing waveform data received from a pressure sensor to determine whether a compression garment is in the wrapped or unwrapped configuration during a garment verification process in accordance with aspects of the present invention.

FIG. 33 is a flowchart of an exemplary method of analyzing waveform data received from a pressure sensor to determine whether the compression garment is in the wrapped or unwrapped configuration following the end of a cycle pressure in accordance with aspects of the present invention.

FIG. 34 is a flowchart of an exemplary method of analyzing waveform data received from a pressure sensor to determine whether the compression garment is in the wrapped or unwrapped configuration during a Venous Refill Determination (VRD) in accordance with aspects of the present invention.

FIG. 35 is a flowchart of an exemplary method of analyzing waveform data received from a pressure sensor to determine whether the compression garment is in the wrapped or unwrapped configuration as an independent cycle in accordance with aspects of the present invention.

FIGS. 36A-36C are flow diagrams of a first exemplary method of analyzing waveform data received from the pressure sensor to determine whether the compression garment is in the wrapped or unwrapped configuration around a limb of a wearer of the compression garment by detecting pulsations associated with the heartbeat of the wearer in accordance with an aspect of the present invention.

FIG. 37 is a graphical representations of a signal after passing through a low pass filter when the compression garment is in a wrapped configuration on a limb of a wearer in accordance with aspects of the present invention.

FIG. 38 is a graphical representations of peak detection when the compression garment is in a wrapped configuration on a limb of a wearer in accordance with aspects of the present invention.

FIGS. 39A-39C are flow diagrams of a second exemplary method of analyzing waveform data received from the pressure sensor to determine whether the compression garment is in the wrapped or unwrapped configuration around a limb of a wearer of the compression garment by detecting pulsations associated with the heartbeat of the wearer in accordance with an aspect of the present invention.

FIG. 40 is a block diagram of an example system diagram of various hardware components and other features, for use in accordance with an aspect of the present disclosure.

Corresponding reference characters indicate corresponding parts throughout the drawings.

An attached Appendix includes additional description and figures the form a part of this disclosure.

### DETAILED DESCRIPTION

As used herein, the terms “proximal” and “distal” represent relative locations of components, parts and the like of a compression garment when the compression garment is worn. For example, a “proximal” component is disposed most adjacent to the wearer's torso, a “distal” component is disposed most distant from the wearer's torso, and an “intermediate” component is disposed generally anywhere between the proximal and distal components. Further, as used herein, the terms ““wrapped” or “wrapped configuration” refers to a compression garment being properly wrapped around a wearer's limb. “Unwrapped” or “unwrapped configuration” refers to a compression garment this is not wrapped around a wearer's limb, a compression garment in a laid out configuration, a compression garment wrapped but not around a wearer's limb (e.g., wrapped upon itself), or a compression garment wrapped loosely around a wearer's limb but providing indeterminate readings by one or more pressure sensors. “Prescribed treatment protocol,” “prescribed therapeutic,” “compression treatment regimen” and “compression therapy” are used interchangeably and describe the use of the compression system. Some of the methods in this application include the step of venting a bladder to a target value or target pressure. Alternatively, the bladder can be vented and then inflated to the target value or target pressure.

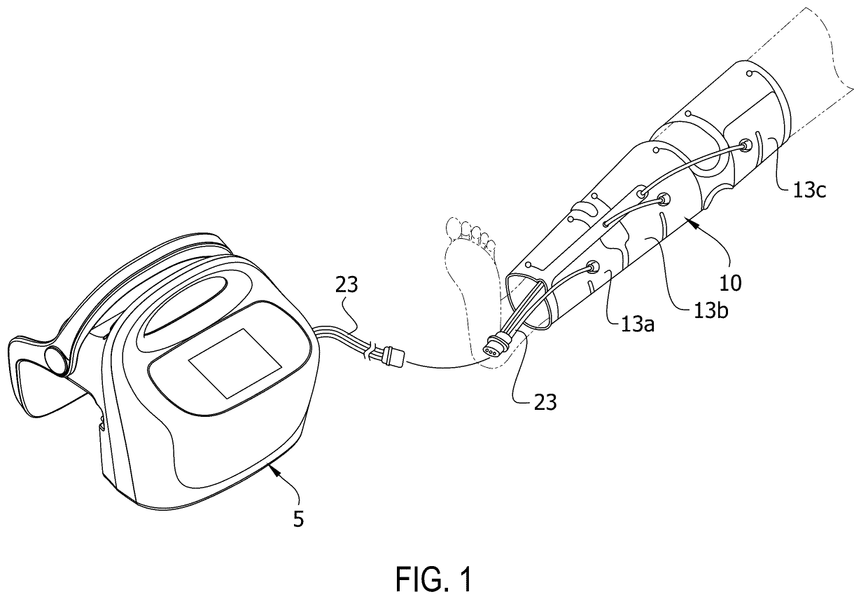

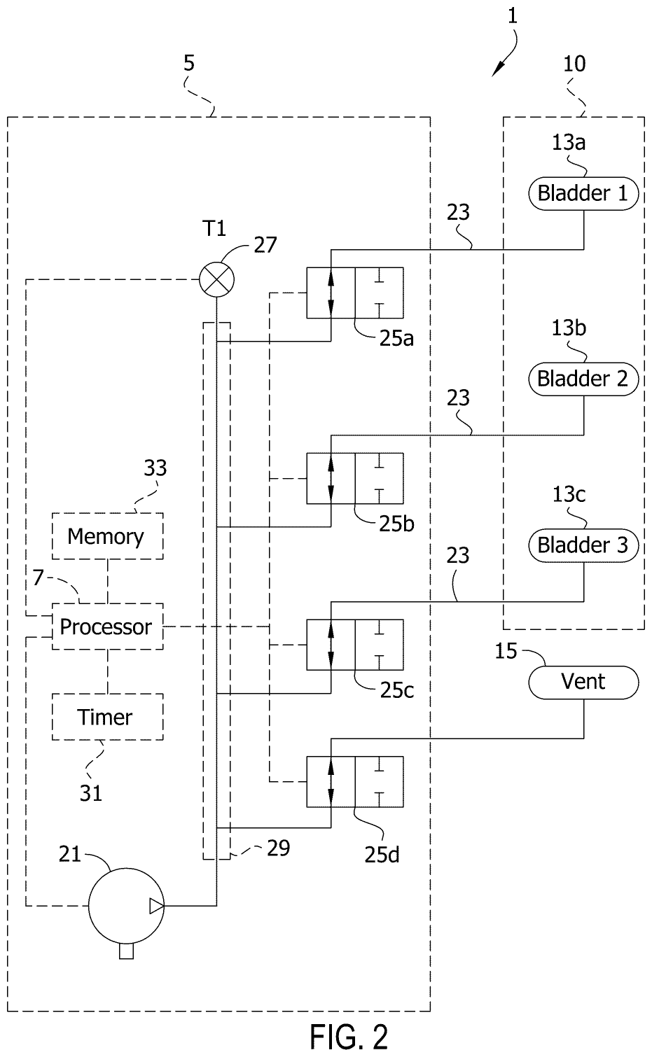

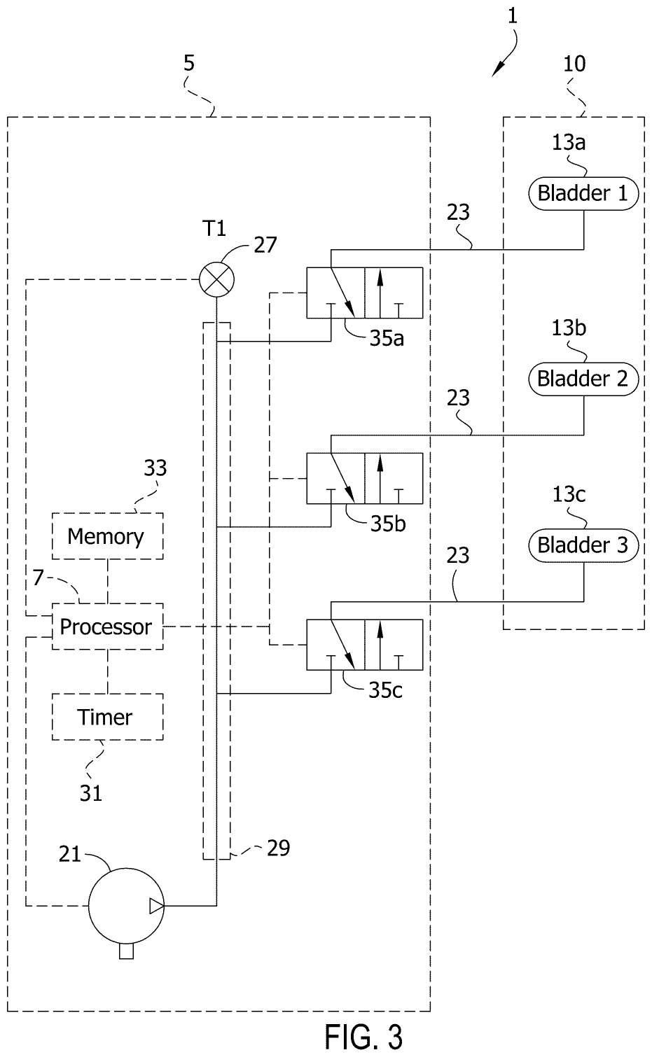

Referring to FIGS. 1-3, a compression system 1 includes a compression garment 10 for applying compression therapy to a limb of a wearer and a controller 5 having one or more processors 7 and computer executable instructions (“CEI”) 33a embodied on a computer readable storage medium 33 (shown as “memory” in FIGS. 2 and 3), the computer executable instructions including instructions for causing the one or more processors to control operation of the compression system 1. The compression therapy can be sequential or non-sequential compression therapy depending on the compression garment 10. The compression garment can be a three bladder compression sleeve, a single bladder compression sleeve, a foot cuff, or any other type of compression garment that can be used in compression therapy. Although this application describes the use of a three bladder compression sleeve, one of ordinary skill in the art would understand that the compression garment 10 can be a single bladder compression sleeve, a foot cuff and/or any other type of compression garment that can be used in compression therapy without departing from the scope of the invention. As shown, the compression garment 10 includes a distal inflatable bladder 13a, an intermediate inflatable bladder 13b, and a proximal inflatable bladder 13c. The compression garment 10 can be fastened around the wearer's limb and in one aspect is adjustable to fit limbs of different circumferences.

As described in further detail below, the controller 5 controls operation of the compression system 1 to perform an inflation cycle, in which the inflatable bladders 13a, 13b, 13c are inflated to apply pressure to the wearer's limb to establish a gradient pressure applied to the wearer's limb by the inflatable bladders 13a. 13b, 13c of the compression garment 10 during one or more compression cycles. As also described in further detail below, for purposes of this description, each therapeutic compression cycle includes inflation phases for all three bladders 13a, 13b, 13c, a decay phase for bladders 13a and 13b, and a vent phase for all three bladders 13a, 13b, 13c. The end-of-cycle pressure of each bladder 13a, 13b, 13c is the pressure in each bladder 13a, 13b, 13c prior to initiation of the vent phase of the respective bladder 13a. 13b, 13c. As will be explained in greater detail below, the controller 5 determines, based at least in part on a measured pressure of one or more of the inflatable bladders 13a, 13b, 13b, whether or not the compression garment 10 is applied to (i.e., in a wrapped configuration around) a wearer's limb and, in some aspects of the disclosure, provides an indication of the determination (e.g., by incrementing a timer, by pausing a timer, by providing an audible alarm, and/or by providing a visual indication on a graphical user interface (GUI) and/or light emitting diodes (LEDs)). Determining whether the compression garment 10 is being worn (i.e., in a wrapped configuration around a wearer's limb) provides a compliance monitoring function which enables the compression system 1 to track when the garment is being properly used to achieve a prescribed treatment, e.g., compression therapy. As also described in further detail below, the controller 5 can control operation of the compression system 1 to perform an inflation cycle, in which the inflatable bladders 13a, 13b, 13c are inflated to apply pressure to the wearer's limb to establish, for example, a gradient pressure applied to the wearer's limb by the inflatable bladders 13a, 13b, 13c of the compression garment 10 during one or more compression cycles.

The compression garment 10 is a thigh-length sleeve positioned/positionable around the leg of the wearer, with the distal bladder 13a around the wearer's ankle, the intermediate bladder 13b around the wearer's calf, and the proximal bladder 13c around the wearer's thigh. The inflatable bladders 13a, 13b, 13c expand and contract under the influence of fluid (e.g., air or other fluids) delivered from a pressurized fluid source 21 (e.g., a pump or compressor) in electrical communication with the controller 5. The pressurized fluid source 21 delivers pressurized fluid (e.g., air) to the inflatable bladders 13a, 13b, 13c through tubing 23.

Referring to FIG. 2, each inflatable bladder 13a, 13b, 13c is in fluid communication with a respective valve 25a, 25b, 25c. A pressure sensor 27 is in communication (e.g., fluid communication) with a manifold 29 to measure a signal indicative of pressure in the manifold 29. Fluid communication between the manifold 29 and the respective inflatable bladders 13a, 13b, 13c can be controlled through control of the position of the respective valves 25a. 25b, 25c (e.g., through activation and/or deactivation of the respective valves 25a, 25b, 25c). The pressure sensor 27 is in electrical communication with the controller 5 such that the controller 5 receives from the pressure sensor 27 signals indicative of the pressure of the manifold 29 and/or one or more of the inflatable bladders 13a, 13b, 13c in fluid communication with the manifold 29 as a result of the positions of the respective valves 25a, 25b, 25c. If only one bladder 13a, 13b or 13c is in fluid communication with the manifold 29, the signal received from the pressure sensor 27 is indicative of the pressure of the respective bladder 13a, 13b, 13c in fluid communication with the manifold 29. For example, the pressure sensor 27 provides a signal indicative of the pressure in the inflatable bladder 13a when valve 25a is open and valves 25b, 25c are closed. Similarly, the pressure sensor 27 provides a signal indicative of the pressure in the bladder 13b when the valve 25b is open and the valves 25a and 25c are closed. Likewise, the pressure sensor 27 provides a signal indicative of the pressure in the inflatable bladder 13c when the valve 25c is open and the valves 25a and 25b are closed. In one aspect of the disclosure, a vent valve 25d is actuatable to control fluid communication between the manifold 29 and a vent port 15, which vents to ambient atmosphere. All bladders 13a, 13b, 13c can be vented using the vent valve 25d. In another aspect of the disclosure a vent valve may not be implemented on the device.

Each valve 25a, 25b, 25c is a 2-way/2-position, normally open, solenoid valve. Each valve 25a, 25b, 25c includes two ports (X and Y) and is actuatable to place an inlet port in fluid communication with a bladder port in a first, open position. Each valve 25a, 25b, 25c is further actuatable to shut off fluid communication between the inlet port and the bladder port. The inlet port of each valve 25a, 25b, 25c is in fluid communication with the pressurized fluid source 21 and the manifold 29. The bladder port of each valve 25a, 25b, 25c is in fluid communication with a respective inflatable bladder 13a, 13b, 13c.

Any one of the bladders 13a, 13b, 13c can be placed in fluid communication with the pressurized fluid source 21 and the manifold 29 by the respective valve 25a, 25b, 25c to deliver pressurized fluid to the bladder 13a, 13b, 13c. After the bladder 13a, 13b, 13c is inflated, the respective valve 25a, 25b, 25c can hold the fluid in the respective bladder 13a, 13b, 13c. Thus, the bladders 13a, 13b, 13c of the compression garment 10 can be individually inflated by opening the respective valve 25a, 25b, 25c and closing the other valves 25a, 25b, 25c so that only the one bladder 13a, 13b, 13c associated with the opened valve 25a, 25b, 25c is in fluid communication with the pressurized fluid source 21 and the manifold 29.

The vent valve 25d is also a 2-way/2-position, normally open, solenoid valve. The vent valve 25d includes two ports (X and Y) and is actuatable to place an inlet port in fluid communication with a vent port 15 in a first position. The vent inlet port is in fluid communication with a vent port 15 in a first position. The vent valve 25d is further actuatable to shut off fluid communication between the inlet port and the vent port 15. The inlet port of vent valve 25d is in fluid communication with the pressurized fluid source 21 and the manifold 29. The vent port 15 of the vent valve 25d is in fluid communication with ambient atmosphere.

It should be appreciated that the valves 25a, 25b, 25c, 25d could be other types and have other arrangements within the compression system 1 without departing from the scope of the present disclosure. For example, referring to FIG. 3, the valves can be valves 35a, 35b, 35c, which are 3-way/2-position solenoid valves and are actuatable to control the pressure in bladders 13a, 13b, 13c without a vent valve.

With reference again to FIG. 2, the computer executable instructions embodied on the computer readable storage medium 33 include instructions to cause the one or more processors 7 to pressurize (e.g., inflate) the inflatable bladders 13a, 13b, 13c to provide cyclical therapeutic compression pressure to a wearer's limb. For example, the computer executable instructions embodied on the computer readable storage medium 33 include instructions to cause the one or more processors 7 to control the pressurized fluid source 21 and/or the valves 25a, 25b, 25c, 25d to pressurize the inflatable bladders 13a, 13b, 13c to therapeutic compression pressures for a predetermined amount of time to move the blood in the limb from regions underlying the inflatable bladders 13a, 13b, 13c. The length of time the bladder 13a, 13b is held at the compression pressure is referred to herein as a decay phase. Following the decay phase is a vent phase in which the computer executable instructions include instructions to cause the one or more processors 7 to control the pressurized fluid source 21 and/or the valves 25a, 25b, 25c, 25d to reduce the pressure in the inflatable bladders 13a, 13b, 13c to a lower pressure (e.g., atmospheric pressure).

The compression system 1 can determine whether or not the compression garment 10 is applied (i.e., wrapped) to a wearer's limb and, in certain aspects of the disclosure, can provide an indication of that determination, which can facilitate, for example, tracking the wearer's compliance with a prescribed therapeutic, e.g., compression therapy, use of the compression garment 10. The computer executable instructions embodied on the non-transitory computer readable storage medium 33 include instructions to cause the one or more processors 7 to analyze pressure signal data received from the pressure sensor 27 during a decompression period of a therapeutic cycle of the compression system 1. The computer executable instructions embodied on the non-transitory computer readable storage medium 33 include instructions to cause the one or more processors 7 to determine whether or not the characteristics of the received pressure signal data satisfy one or more conditions indicative of the compression garment 10 positioned on a wearer's limb.

In an exemplary aspect, the computer executable instructions cause the one or more processors 7 to receive pressure signal data from the pressure sensor 27. The computer executable instructions can include instructions to cause the one or more processors 7 to process a single waveform representative of the pressures within one or more of the bladders 13a, 13b, 13c. It should be appreciated that the one or more processors 7 can process multiple waveforms without departing from the scope of the present disclosure. By monitoring the pressure signals and corresponding pressure data during, for example, a decompression period of the therapy cycle, the one or more processors 7 can detect certain characteristics on the waveform that are indicative of whether the compression garment 10 is properly wrapped on a wearer's limb or is unwrapped from a wearer's limb. In certain aspects, during the decompression period, the pressure sensor 27 remains (or is intentionally placed) in constant communication (e.g., fluidic and/or mechanical communication) with one or more of the bladders 13a, 13b, 13c. Exemplary static periods include non-therapeutic cycles (e.g., pressures in bladders 13a, 13b, 13c of less than about 29 mmHg), a subset of an initial garment detection period, and/or a venous refill measurement period.

In an exemplary operation of aspects of FIG. 3, in which 3-way/2-position valves (e.g., 3-way/2-position solenoid valves) are utilized, the computer-executable instructions embodied on the computer readable storage medium 33 include instructions to cause the one or more processors 7 to control one or more valves 35a, 35b, 35c for one or more of a particular bladder 13a, 13b, 13c such that a fluidic path is established between the pressure sensor 27 and one or more of the bladders 13a, 13b, 13c.

In an exemplary operation of aspects of FIG. 2, in which 2-way/2-position valves (e.g., 2-way/2-position solenoid valves) are utilized, the computer-executable instructions embodied on the computer readable storage medium 33 include instructions to cause the one or more processors 7 to open or close the vent valve 25d such that the manifold 29 can no longer vent. One or more of the computer-executable instructions causes the one or more processors 7 to determine whether the signal received from the pressure sensor 27 for random pressure impulses and spikes that are expected to occur as the wearer moves (e.g., moving leg, flexing calf, coughing, sneezing, general breathing, etc.). Due to a volume of fluid (e.g., air) that is retained within one or more of the bladders 13a, 13b, 13c and extends to the manifold 29, and thus the pressure sensor 27, even slight movement causes the bladder to move or change shape and produce a pressure spike in the pressure signal generated by pressure sensor 27. Conversely, for a compression garment 10 that has been removed from a limb of the wearer, the pressure signal generated by pressure sensor 27 is static and devoid of random noise or pressure impulses.

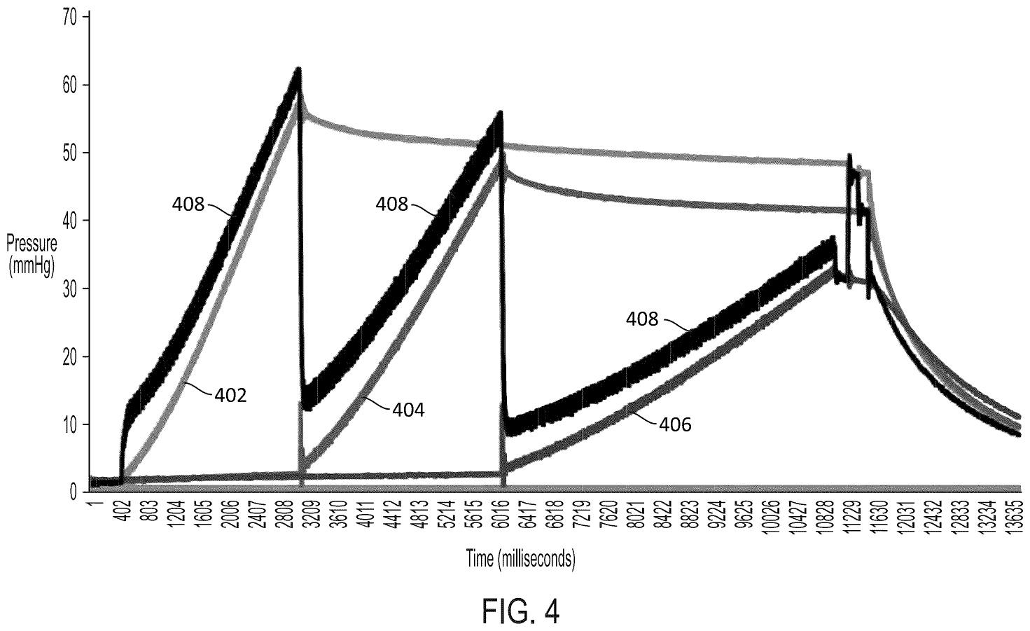

Referring now to FIG. 4, a representative compression cycle pressure profile is shown for the compression garment 10 in a wrapped configuration around a leg form, which simulates a leg of a wearer. The leg form has a size, shape, and rigidity similar to those of a human leg. Accordingly, for the purpose of analyzing the performance of the algorithms described in this disclosure, the leg form is a suitable analog for a leg of a human wearer. Unless otherwise specified, all data shown herein were acquired in an experimental set-up using a leg form.

This graph shows signals from an experimental set-up in which pressure sensors are used to measure pressure in the individual bladders 13a, 13b. 13c and the pressure sensor 27 is used to measure pressure in the manifold 29. As described in further detail below, using this experimental set-up, the pressures measured in the bladders 13a. 13b. 13c and compared to the pressure measured by the pressure sensor 27 in the manifold 29. It should be appreciated that, in normal use, the controller 5 receives the signals from pressure sensor 27 to control operation of the compression system 1. FIG. 4 shows the correspondence between the manifold pressure measured by pressure sensor 27 and the pressure measured by pressure sensors disposed in each bladder 13a. 13b, 13c.

A single compression cycle for at least one of the bladders 13a. 13b, 13c includes an inflation phase, a decay phase, and a vent phase for the bladders 13a. 13b, and an inflation phase and a vent phase for the bladder 13c. Pressure plot 402 shows a pressure signal throughout a single therapeutic compression cycle for the distal bladder 13a, pressure plot 404 shows a pressure throughout a single therapeutic compression cycle for the intermediate bladder 13b, pressure plot 406 shows a pressure throughout a single therapeutic compression cycle for the proximal bladder 13c, and pressure plot 408 shows the manifold pressure measured by pressure sensor 27 during each of the aforementioned therapeutic compression cycles. Each plot 402, 404, 406 includes an initial bladder fill period which defines the inflation phase of the therapeutic compression cycle for the respective bladders 13a, 13b, 13c. Once a respective target pressure is achieved in the bladders 13a, 13b, inflation is stopped and the pressure in the bladder can be held at or near the target pressure defining the decay phase of the therapeutic compression cycle for bladders 13a, 13b. After the decay phase, in the case of bladders 13a, 13b, or immediately after the inflation phase, in the case of bladder 13c, fluid in each bladders 13a, 13b, 13c is evacuated from the respective bladder during the vent phase of the therapeutic compression cycle for each bladder 130, 13b, 13c.

At the beginning of the therapeutic compression cycle, the valves 25b, 25c, and 25d are energized to a closed position. To inflate the distal bladder 13a, pressurized fluid from the pressurized fluid source 21 is delivered to the distal bladder 13a via the valve 25a and the tubing 23. Once a target pressure for the distal bladder 13a is achieved, or after a period of time measured by timer 31 after which the target pressure is expected to be achieved, the valve 25a is energized to close, holding the pressurized fluid in the distal bladder 13a. Next the intermediate bladder 13b is inflated by de-energizing valve 25b to an open position such that pressurized fluid from the pressurized fluid source 21 flows into the intermediate bladder 13b. Once a target pressure for the intermediate bladder 13b is achieved, or after a period of time measured by the timer 31 after which the target pressure is expected to be achieved, the valve 25b is energized to close, holding the pressurized fluid in the intermediate bladder 13b. Next, the proximal 13c is inflated by de-energizing valve 25c to an open position such that pressurized fluid from the pressurized fluid source 21 flows into the proximal bladder 13c. Once a target pressure for the proximal bladder 13c is achieved, or after a period of time measured by the timer 31, after which the target pressure is expected to be achieved, valves 25a, 25b, and 25d are also de-energized to respective open positions. The open vent valve 25d allows for the fluid in each of the bladder 133, 13b. 13c to vent to atmosphere.

The compression system 1 has been described as individually inflating each bladder 13a, 13b, 13c such that only one bladder is being filled with pressurized fluid at a time. It should be appreciated, however, that the bladder 13a, 13b. 13c can additionally or alternatively be inflated simultaneously or in any combination with one another. In certain embodiments, the opening and closing of valves 25a, 25b, 25c, and 25d are timed such that only one bladder 13a, 13b, 13c is in fluid communication with the pressure sensor 27 and the manifold 29 at a time. This facilitates, for example, the use of the pressure sensor 27 to measure a signal indicative of each of the pressure of each of the bladder 13a, 13b, 13c.

The computer executable instructions embodied on the computer readable storage medium 33 include instructions to cause the one or more processors 7 to receive a measured pressure signal from the pressure sensor 27 throughout the therapeutic compression cycle. As the distal bladder 13a is inflated, the one or more processors 7 receive from the pressure sensor 27 a signal indicative of pressure in the manifold 29, which is representative of the pressure in the distal bladder 13a. In this manner, pressure throughout the inflation phase of the distal bladder 13a is measured, including an end of inflation pressure just before valve 25a is closed. As the intermediate bladder 13b is inflated, the one or more processors 7 receive from the pressure sensor 27 a signal indicative of the pressure in the manifold 29, which is representative of the pressure in the intermediate bladder 13b. Pressure throughout the inflation phase of the intermediate bladder 13b is measured, including an end of inflation pressure just before valve 25b is closed. As the proximal bladder 13c is inflated, the one or more processors 7 receive from the pressure sensor 27 a signal indicative of the pressure in the manifold 29, which is representative of the pressure in the proximal bladder 13c. Pressure throughout the inflation phase of the proximal bladder 13c is measured, including an end of inflation pressure.

The computer executable instructions include instructions to cause the one or more processors 7 to determine an end-of-cycle pressure in each bladder 13a, 13b, 13c. As used herein, the end-of-cycle pressure is the pressure in each respective bladder 13a, 13b. 13c prior to the vent phase. Thus, for the bladders 13a. 13b, the end-of-cycle pressure for each bladder 13a, 13b is the pressure in each bladder 13a. 13b at the end of the respective decay phase of the therapeutic compression cycle of each bladder 13a, 13b. For bladder 13c, the end-of-cycle pressure is the pressure in the bladder 13c at the end of the inflation phase of the bladder 13c.

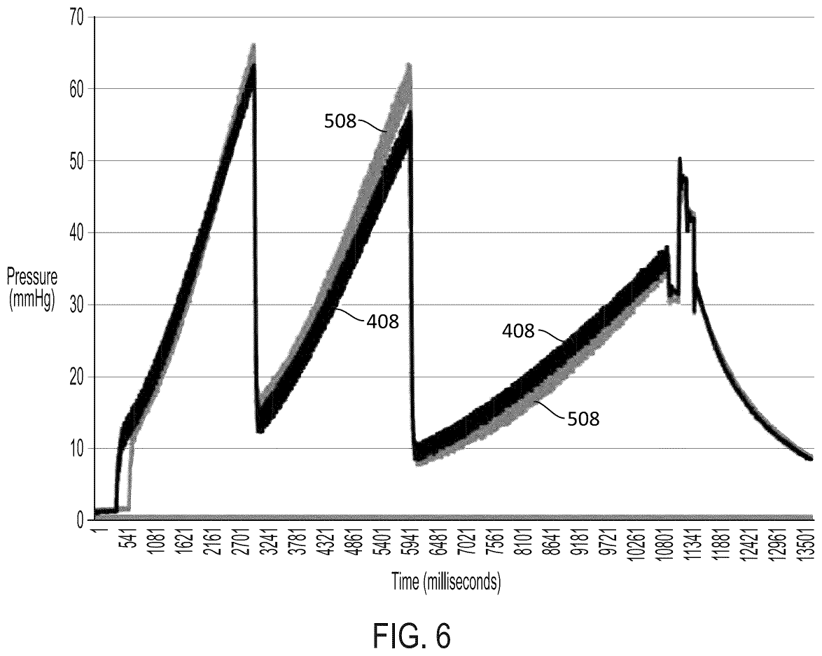

To measure the end-of-cycle pressure, the valves 25a, 25b, 25c are sequentially toggled open and closed after the proximal bladder 13c is inflated to its target pressure to measure an end-of-cycle pressure in each of the bladders 13a, 13b, 13c (FIG. 4). Because the valve 25c is open from having just inflated the proximal bladder 13c, the end of cycle pressure for the proximal bladder 13c is measured first. As will be understood from viewing the pressure profile in FIG. 6, the end of inflation pressure and the end of cycle pressure for the proximal bladder 13c are the same because the proximal bladder does not undergo a decay phase. Valve 25c can be toggled off and then toggled back on at the end of the compression cycle of the proximal bladder 13c. The one or more processors 7 toggle open valve 25a and close valve 25c to measure an end of cycle pressure for the distal bladder 13a. The one or more processors 7 toggle open valve 25b and close valve 25a to measure an end of cycle pressure for the intermediate bladder 13b. While a specific toggling sequence of the valves 25a, 25b, 25c is described, it should be appreciated that other toggling sequences of the valves 25a. 25b, 25c are within the scope of the present disclosure. In one embodiment, each valve 25a, 25b, 25e is toggled open for about 150 milliseconds (ms) to measure the end of cycle pressure in the respective bladder 13a. 13b, 13c. The valves 25a, 25b. 25c could be toggled open for a shorter or longer period of time. For instance, the valves 25a. 25b, 25c could be toggled open for at least about 75 ms. Still other periods of time are envisioned. The pressure readings measured by the pressure sensor 27 are stored in the memory 33. During operation, the compression cycle is repeated multiple times in succession to complete a compression treatment.

The computer executable instructions can include instructions to cause the one or more processors 7 to determine a representative line fit using the end of inflation pressure and the end of cycle pressure for at least one of the bladders 13a, 13b. Using the two pressure points, a line representing the decay phase is produced. The values of this representative line are compared to the end of inflation pressure for a bladder 13b, 13c to determine whether the pressure of the subsequently inflated bladder 13b, 13c potentially rose above the pressure of the previously inflated bladder 13a. 13b at any point during the compression cycle.

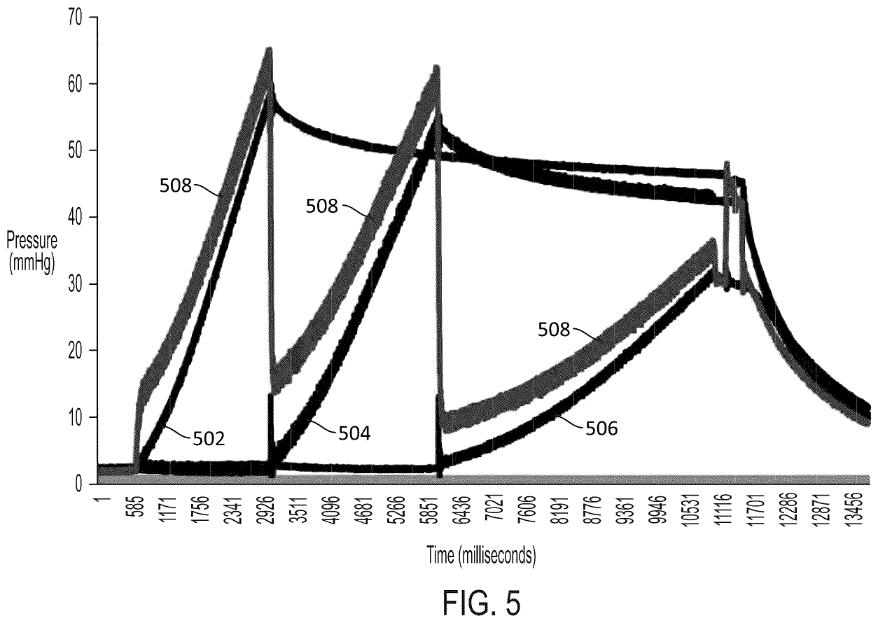

Referring to FIG. 5, a representative compression cycle pressure profile for an unwrapped configuration of the compression system 1 is illustrated. Operation of the compression system 1 to produce the pressure profile of FIG. 5 is identical to the operation described above for the compression cycle pressure profile of FIG. 4. The only difference is the pressure signals in FIG. 5 were taken when the compression garment 10 was in the unwrapped configuration. Pressure plots 502, 504, 506 show an actual pressure of the distal bladder 13a, intermediate bladder 13b, and proximal bladder 13c throughout a single compression cycle when the garment 10 is in the unwrapped configuration. The pressure signal from the pressure sensor 27, which is representative of the pressure in the manifold 29 during the therapeutic compression cycle, is also shown in FIG. 5 as pressure plot 508.

Referring to FIG. 6, the pressure signals of the representative compression cycle pressure profiles detected by the pressure sensor 27 for the wrapped and unwrapped configurations are plotted together. As will be explained in greater detail below, there are characteristics in the representative compression cycle pressure profiles which distinguish the wrapped and wrapped configurations. For instance, referring to FIG. 5, there is a period (e.g., around 6436 ms) when the intermediate bladder 13b (504) pressure exceeds the pressure of the distal bladder 13a (502). Additionally, the pressure in the bladder 13a. 13b, 13e before the bladders are inflated (i.e., initial pressure offset when time=0) is slightly higher in the unwrapped configuration. The offset is a result of more residual air being in the bladder 13a, 13b. 13e when the garment 10 is removed from the limb. Applicant believes this to be because the unwrapped sleeve is less constrained, thereby less evacuative force is applied to expel the residual air (i.e. the sleeve is able to remain “puffed out” thus appearing as though it is smaller in volume). Without wishing to be bound by theory, it is believed that this offset results from the unwrapped compression garment 10 being less constrained, resulting in less evacuative force being applied to expel residual air. Additionally, the end of inflation pressures for bladders 13a and 13b in the unwrapped configuration are slightly higher than the end of inflation pressures for bladders 13a and 13b in the wrapped configuration. The reverse condition is true for the proximal bladder 13c where the end of inflation pressure for the wrapped configuration is slightly higher than the end of inflation pressure for the unwrapped configuration. Another differentiating characteristic is that there is less differential between the end of inflation pressures in the distal and intermediate bladders 13a. 13b for the unwrapped configuration than for the wrapped configuration.

The computer executable instructions embodied on the computer readable storage medium 33 include instructions to cause the one or more processors 7 to model the pressure signals from the pressure sensor 27 in both the wrapped and unwrapped configurations. In an embodiment, the pressure signal from the inflation phase of the distal bladder 13a in the wrapped configuration is modeled by a best fit line. For example, the models are best fit lines generated by simple lincar regression.

Analysis of the pressure signal data using the best fit line can provide an indication of whether the bladder 13a is in a compliant wrapped configuration, or a non-compliant unwrapped configuration when compression therapy is being applied. The difference between the best fit line and the observed pressure signals is mathematically quantifiable as a means squared error (MSE) value. In this instance, the MSE value is an indicator of the degree of curvature of the observed pressure trend over a given interval such as inflation of a bladder of the compression garment 10. Thus, a larger MSE value indicates that the curve fit data has a larger curvature, and a low MSE value indicates that the curve fit data has a smaller curvature. In an embodiment, the plot for the wrapped configuration is generally straighter (i.e., more nearly conforming to the corresponding best fit line) than the plot for the unwrapped configuration. Mathematically this translates to a smaller MSE value for the curve fit line of the plot for the wrapped configuration. In an embodiment, an MSE value under a predetermined number indicates that the bladder is in the wrapped configuration, while an MSE value greater than or equal to the predetermined number indicates that the bladder is in the unwrapped configuration. It is envisioned that other factors may provide an indication of the configuration of the bladder.

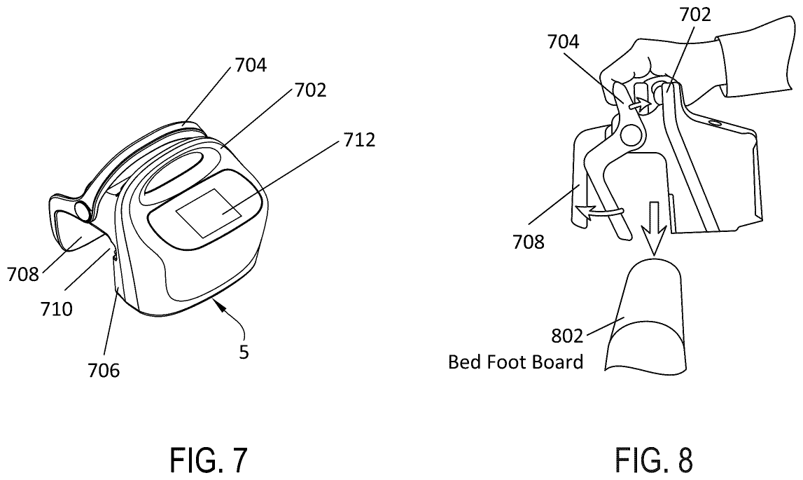

Referring to FIGS. 7 and 8, the controller 5 can include a device handle 702 and a pivoting handle 704. To secure the controller 5 to a bed, e.g., foot board 802, the device handle 702 and the pivoting handle 704 are squeezed together which causes the pivoting handle 702 to pivot away from a backside 706 of the controller 5 and increases a gap 710 between an extension 708 of the pivoting handle 704 and the backside 706 of the controller 5 as shown in FIG. 7. The controller 5 can then be placed over a foot board 802 with the extension of the pivoting handle 704 on one side of the foot board and the backside 706 of the controller 5 on the other side of the foot board 802. By releasing the device handle 702 and the pivoting handle 704 the controller 5 rests on top of foot board 802 with the extension of the pivoting handle 704 pressing against the foot board 802 securing the controller 5 to the foot board 802. In one or more alternative aspects, the controller 5 can be placed on a flat surface, e.g., a table, desk, shelf, etc.

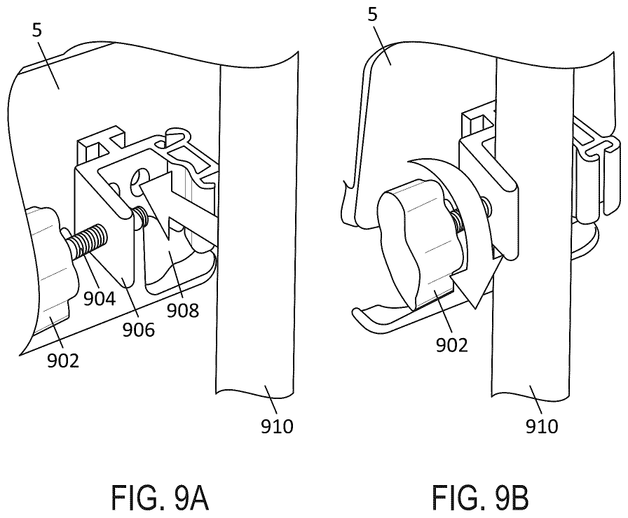

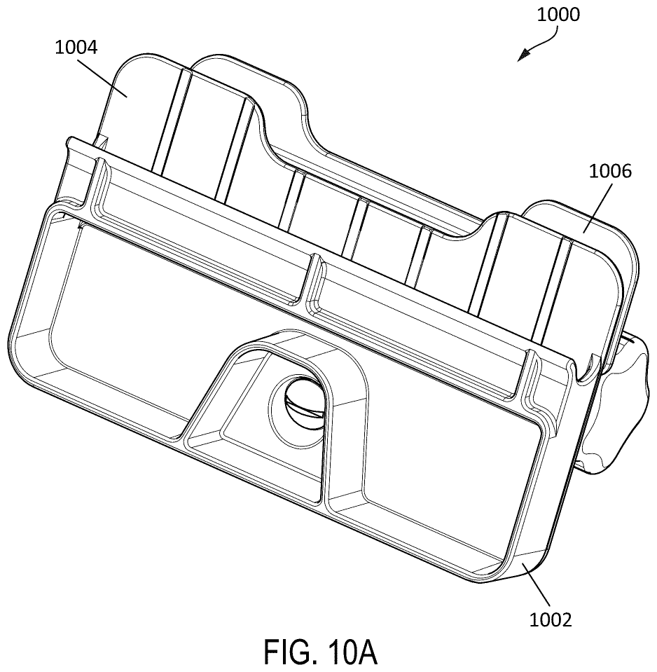

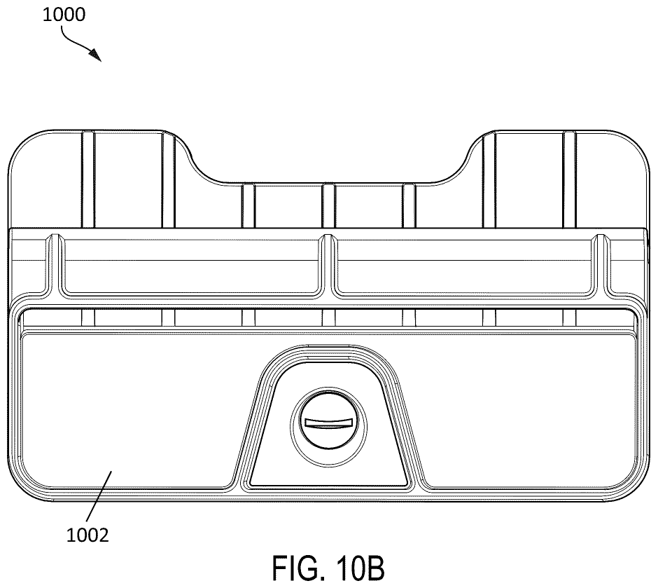

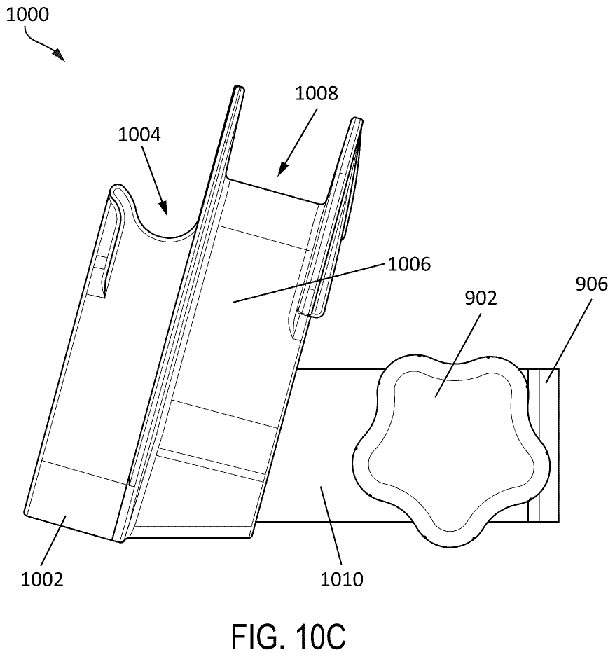

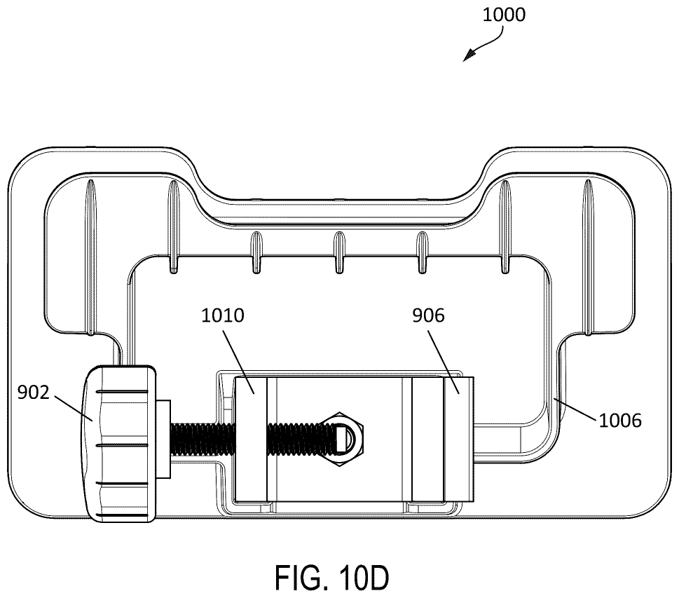

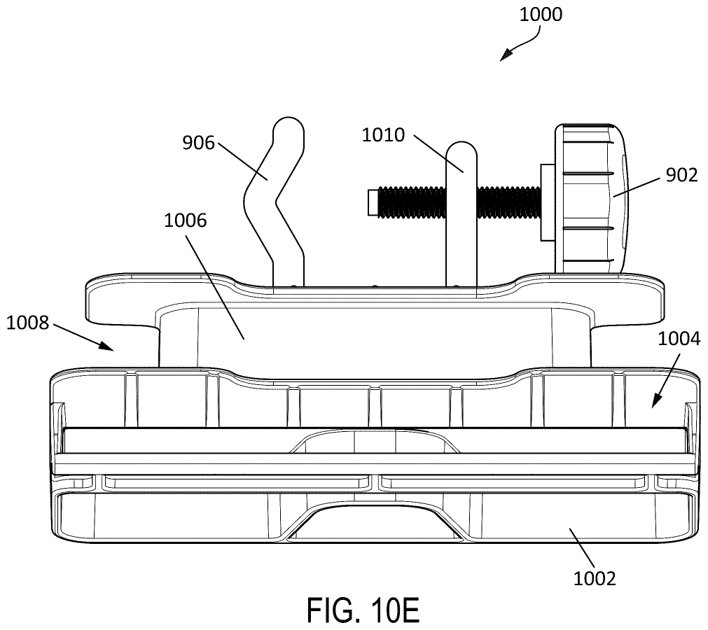

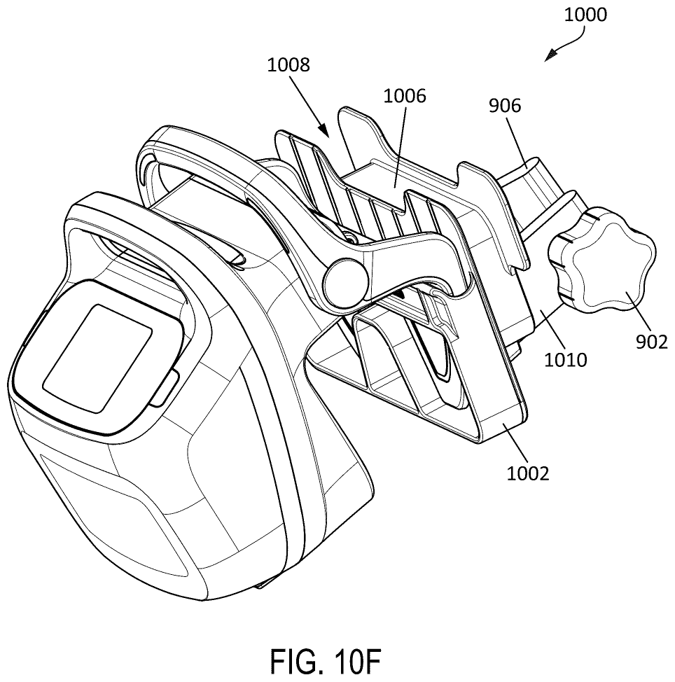

Referring to FIGS. 9A and 9B, the controller 5 can be secured to a pole 910, e.g., an intravenous (IV) pole, via an attachment member 1000 (shown in FIG. 10A-10F). As shown in FIG. 9A, a pole attachment portion 906 of an attachment member 1000 (explained below in more detail) includes an opening 908 which is adapted to captively receive a pole 910, e.g., an IV pole, and engage with the pole 910. The pole attachment portion 906 can be substantially U-shaped. On one side of the pole attachment portion 906, a threaded hole is formed to receive a first end of a screw 904 with a second end of the screw attached to a knob 902 with the first end and second end being opposite the other. The first end of the screw 904 is inserted into the threaded hole and the knob 902 is rotated until the first end of the screw 904 is pressed against the pole 910 thereby securing and/or clamping the attachment member to the pole 910. While FIG. 9B illustrates the attachment member 1000 being attached to the pole 910 using a threaded knob 902, attachment may be accomplished using other fasteners such as screw, clamp, ratchet and the like. In one aspect of the disclosure the attachment member 1000 may also include a rubber gasket or the like to assist in retaining securement. By rotating the threaded knob 902 in a clockwise direction, a first end of the screw 904 moves towards and engages with the pole 910, e.g., an IV pole. By rotating the threaded knob 902 is a counter-clockwise direction, the first end of the screw 904 moves away and disengages with the pole 910, e.g., an IV pole.

Referring to FIGS. 10A-10F, different views of an attachment member 1000 are illustrated. For example, FIG. 10A shows a front perspective view of the attachment member 1000, FIG. 10B shows a front view of the attachment member 1000, FIG. 10C shows a side view of the attachment member 1000, FIG. 10D shows a back view of the attachment member 1000, FIG. 10E shows a top view of the attachment member 1000 and FIG. 10F shows the controller 5 engaging with the attachment member 1000. As shown, the attachment member 1000 includes a first receiving portion 1002, a second receiving portion 1006, an interconnector 1010 and the pole attachment portion 906. The first receiving portion 1002 includes a concave portion 1004 adapted to receive a portion of the pivoting handle 704 of the controller. More specifically, the first receiving portion 1004 is dimensioned and adapted to receive a portion of the extension 708 of the pivoting handle 704 of the controller 5 as shown in FIG. 10F. The second receiving portion 1006 is coupled with the first receiving portion 1002. In one or more aspects, the first receiving portion 1002 and the receiving portion 1006 are a unibody. The second receiving portion 1006 includes a channel 1008 adapted to receive one or more wires or tubes. The interconnector 1010 can have a U-shape with a first side of a vertical portion of the U being angled and coupled with the backside of the second receiving portion 1006 as shown in FIG. 10E. A second side of a vertical portion of the U is vertical and is coupled with the pole attachment portion 906.

The controller 5 can operate and control up to two compression garments attached to the controller 5 and to a wearer, e.g., a patient and/or a user. For example, a first compression garment can be placed on a first limb of a wearer and a second compression garment can be placed on the other limb of the wearer. In another example, a first compression sleeve garment can be placed on a limb of the wearer and a foot cuff can be placed on the foot of the same limb of the wearer. The controller 5 can include two sets of tubes. Each set of tubes can be coupled with the pump 21 of the controller 5 on a first end and a connector can be coupled with a second end. One or both sets of tubes can be coupled with a connector of a compression garment. A first set of tubes of the controller 5 can be marked as “A” and a second set of tubes of the controller 5 can be marked as “B”.

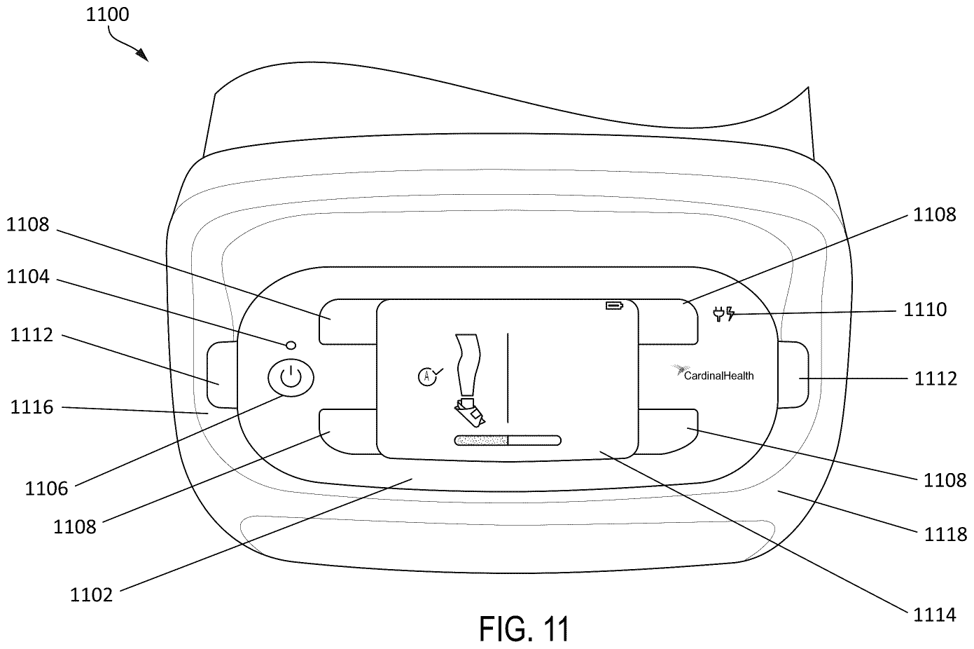

Referring to FIG. 11, a top view 1100 of a display 1102 of a controller 5 is illustrated. As shown, the display 1102 of the controller 5 can include a power on indicator 1104, a power on/standby button 1106, one or more navigation buttons 1108, an AC power/battery charging indicator 1110, one or more LEDs 1112, and a display screen 1114. The power on indicator 1104, e.g., a light or an LED, illuminates when the controller 5 is powered on. Power can be via a plug, e.g., alternating current (AC) power source, or one or more batteries, e.g., direct current (DC) power source. The controller 5 can include a power on/standby button 1106. In one aspect of the disclosure, when the power on/standby button 1106 is pressed, the controller 5 can power on. When the power on/standby button 1106 is pressed a second time, the controller 5 can power down. Any combination of depresses of the power on/standby button 1106 may be configured to operate the controller 5. The one or more navigation buttons 1108 can be buttons and are explained in further detail below. In one or more aspects, the one or more navigation buttons 1108 can be displayed on a graphical user interface (GUI) displayed on the display screen 1114, e.g., a touchscreen display. The AC power/battery charging indicator 1110 can illuminate when AC power is supplied to the controller 5 and can charge one or more batteries when AC power is supplied to the controller 5. The one or more LEDs 1112 can illuminate in different colors, e.g., green, yellow, red and/or a combination thereof. Any combination of colors may be implemented. For example, green can indicate compliance of a patient wearing a compression garment and yellow can indicate non-compliance of the patient wearing a compression garment. Additional colors can also be used. For example, red can indicate an error with controller 5 and an additional color can indicate no compression garment(s) is attached to the controller 5.

In one or more aspects, the one or more LEDs 1112 are positioned on an angled portion 1116 of a controller housing 1118 as shown in FIG. 11. The angled portion 1116 can be angled, e.g., at about fifteen degrees (15°) from horizontal, or any variation thereof to ensure visibility by users. By positioning the one or more LEDs 1112 in such a manner, the one or more LEDs 1112 can be visible from the side. As such, a nurse or doctor walking by can see the one or more LEDs 1112 and can know the status of the controller 5 by the color displayed by the one or more LEDs 1112. In another aspect of the disclosure, the LEDs can be visible from a distance greater than that of viewing a display screen. For example, a nurse or doctor can walk by a room of a patient and instantly determine the status of the device with respect to the patient. This efficiency provided by the LEDs saves valuable time for the providers. For example, without the visibility of the LEDs a nurse or doctor my waste time entering and checking the status of the device within the room of the patient that may not necessary need assistance. Additionally, in hospital settings which are already understaffed, these seconds and minutes used to walk into a room for unnecessary reasons, could be used in a more efficient and desirable situation, for example, helping or assisting an urgent situation.

Additionally, when the controller 5 is attached to a foot board, attached to an IV pole, or placed on a surface, e.g., a flat surface, the nurse or doctor can see the one or more LEDs 1112 from various vantage positions from greater distances. Conventional controllers do not provide such a feature.

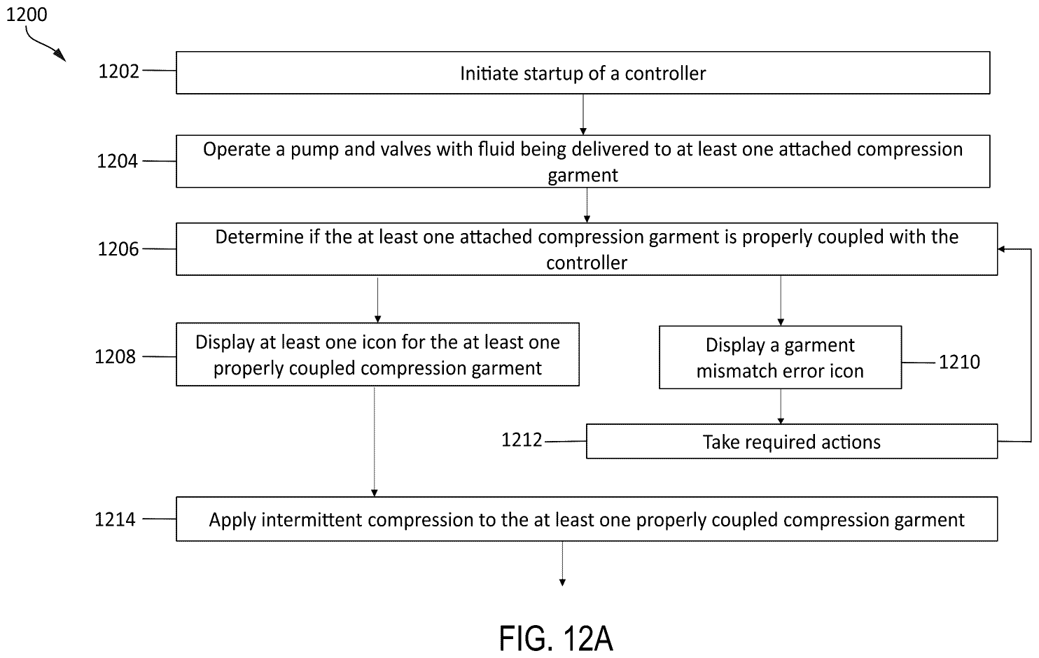

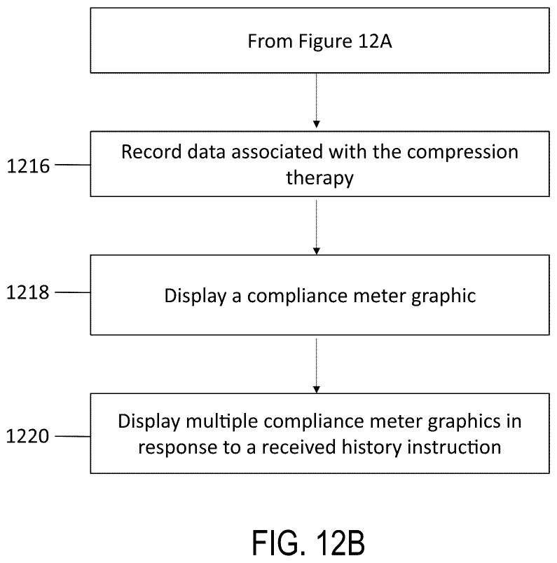

Referring to FIGS. 12A-12B, the computer executable instructions embodied on the computer readable storage medium 33 cause the one or more processors 7 of the controller 5 to execute a method 1200 for initializing the controller 5 at startup. The method 1200 begins at block 1202 by initiating startup of the controller. For example, initiating startup of the controller 5 is in response to the power button 1106 being pressed. During startup, the one or more LEDs 1112 can display or flash a first color, e.g., green.

At block 1204, the method 1200 includes operating a pump and valves with fluid being delivered to at least one attached compression garment. For example, the one or more processors 7 send a signal to the pump 21, e.g., pressurized fluid flow source, causing the pump 21 to pump fluid or direct flow of fluid, e.g., air, into the at least one attached compression garment. This feature is discussed in greater detail herein.

At block 1206, the method includes determining if the at least one attached compression garment is properly coupled/attached with the controller. During startup, the pump 21 and valves are operated and air is delivered out the controller ports to detect the number and type(s) of garment(s) coupled with the controller 5. For example, the at least one processor 7 automatically determines if leg sleeve garments are being used with leg sleeve garments being the default. Examples of the types of garments can be a foot cuff, a three-bladder leg sleeve, and a single bladder leg sleeve. If a one or two garments are properly coupled to the controller 5, then the method proceeds to block 1208. If a one or two garments are not properly coupled to the controller 5, then the method proceeds to block 1210.

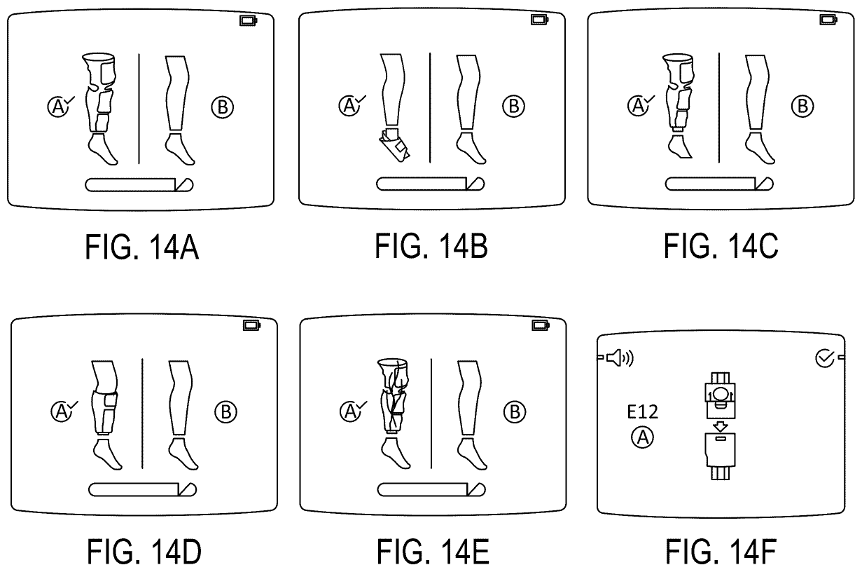

At block 1208, displaying at least once icon for the at least one properly coupled compression garment. For example, if the at least one processor 7 senses a properly attached garment, then a corresponding icon of the detected compression garment is displayed on the screen 814. For example, if only one controller port is coupled with a garment, then the open port is ignored and both the leg and foot will be grayed out. For example, FIG. 14A shows an example of the GUI displaying, on the display screen 1114, a single three bladder leg sleeve garment icon attached to port A and no garment attached to port B, with a second garment (“(B)”) icon representing a leg shown in gray. In various embodiments, icons shown in gray indicate that its representative component is inactive or malfunctioning. FIGS. 14B-14E, show a foot cuff icon, a three-bladder leg sleeve icon, a single bladder leg sleeve icon and a vascular refill detection icon, respectively. Depending on the attached garment(s), the at least one processor 7 displays one or more of these icons via the GUI on the display screen 1114. If one or two garments are properly coupled with the controller 5, then compression therapy is provided as discussed below in more detail.

At block 1210, displaying a garment mismatch error icon on the GUI. For example, if one or two garments are improperly coupled with the controller 5, then the at least one processor 7 displays a garment mismatch error icon on the GUI on the display screen 1114. FIG. 14F shows an example of a garment mismatch error icon.

At block 1212, taking required actions. For example, if any garments are not properly detected or if no garments are coupled with the controller 5, the at least one processor 7 will display an error message on the GUI of the display screen 1114 as discussed above and the user, e.g., a nurse or doctor, can take the appropriate action to address the error. The method can proceed back to block 1206 to determine if the taken action addressed the error.

At block 1214, applying intermittent compression to the at least one properly coupled compression garment. For example, the at least one processor 7 automatically begins applying intermittent compression to the at least one properly coupled compression garment. If two garments are coupled with the controller 5, then intermittent compression is applied to the garments by alternating between the two garments. On successive cycles, the at least one processor 7 automatically adjusts the operating parameters to maintain set pressure. For example, the set pressure is 45 mmHg for a sequential bladder leg sleeve, the set pressure is 130 mmHg for a foot cuff and the set pressure is 40 mmHg for a uniform bladder sleeve. A vascular refill detection method provides customized therapy for each patient's physiology as explained below in more detail. This block is explained in further detail below.

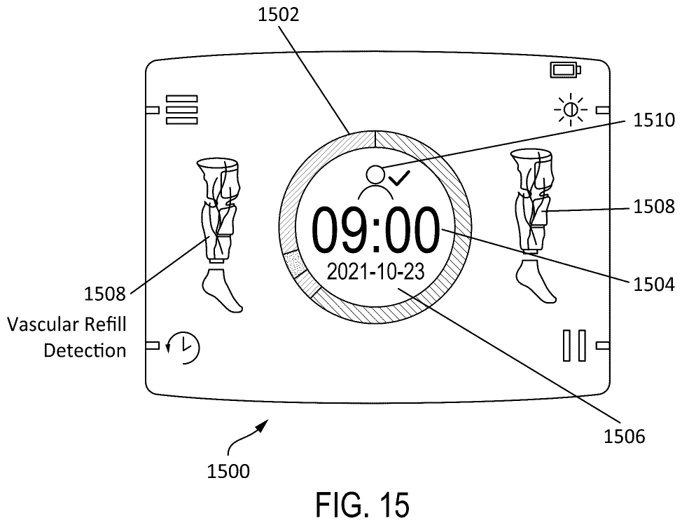

At block 1216, displaying a compliance meter graphic. For example, the at least one processor 7 displays a compliance meter graphic on the GUI of the display screen 814. FIG. 15 shows a compliance meter graphic 1500 for a compression therapy. The compliance meter graphic 1500 can include a circular bar 1502 representing a 24 hour clock. The circular bar 1502 can show the elapsed time when compression therapy was received in one color, e.g., blue, and the time when compression therapy was not given in a second color, e.g., orange. For example, the compression therapy may not have been given because the compression therapy was paused for a patient procedure or a rest room break. The compliance meter graphic 1500 can include a number 1504 representing a time lapse for the compression therapy. The time lapse starts when the compliance meter was reset that day or compression therapy started. The compliance meter graphic 1500 can include the date 1506, e.g., Oct. 23, 2021. A shown, for example, on Oct. 23, 2021, the patient started compression therapy at 2 PM and received 7 hours of compression therapy during the 10 hour period of time with 1 hour of time the patient received no therapy, e.g., non-compliance. The compliance meter graphic 1500 can also show the type of garments attached to the patient. For example, as shown, the patient had two leg sleeve garments applied as represented by the icons 1508. The graphic 1500 can also include a detection icon 1510 indicating that the garment(s) are currently attached to a patient.

At block 1218, recording data associated with the compression treatment. For example, the at least one processor 7 can store data associated with the compression treatment in memory, e.g., computer readable storage medium 33.

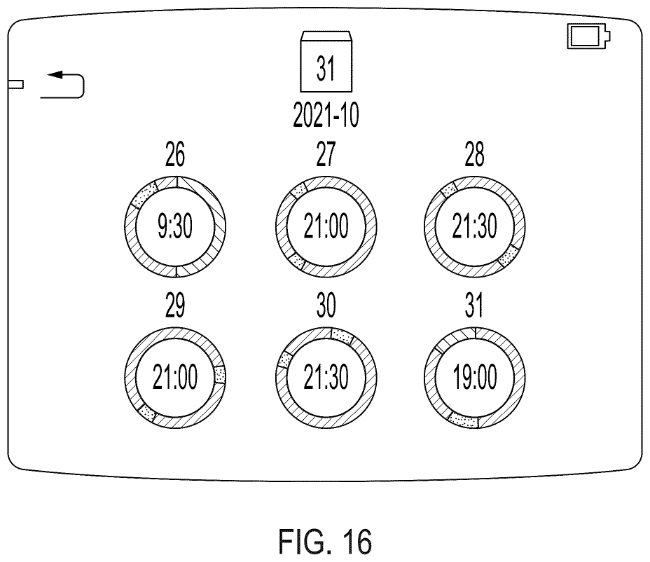

At block 1220, displaying multiple compliance meter graphics in response to response to a received history instruction. For example, the at least one processor 7 can display multiple compliance meters in response to receiving a history instruction. FIG. 16 shows multiple compliance meters being displayed. In one or more aspects, up to six compliance meters can be displayed. As shown, the compliance meters can be shown on a per day basis. As shown, the patient started compression therapy at about noon on Oct. 26, 2021 and received about 9.5 hours of compression therapy. On Oct. 27, 2021, the patient received about 21 hours of compression therapy. On Oct. 28, 2021, the patient received about 21.5 hours of compression therapy. On Oct. 29, 2021, the patient received about 21 hours of compression therapy. On Oct. 30, 2021, the patient received about 21.5 hours of compression therapy. On Oct. 31, 2021, the patient received about 19 hours of compression therapy. The display can include the current date, e.g., Oct. 31, 2021.

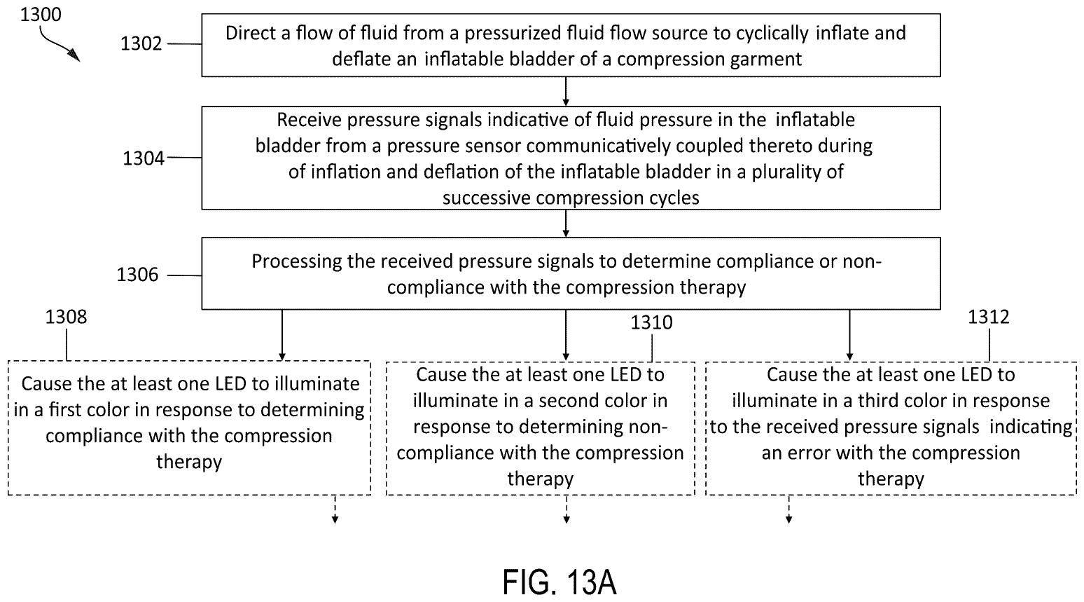

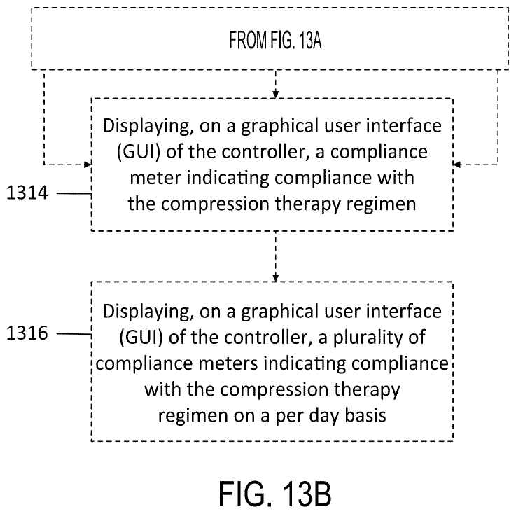

Referring to FIGS. 13A and 13B, the computer executable instructions embodied on the computer readable storage medium 33 cause the one or more processors 7 of the controller 5 to execute a method 1300 for a compression therapy procedure. The method 1300 begins at block 1302 by directing a flow of fluid from a pressurized fluid flow source to repeatably (or cyclically) inflate and deflate at one inflatable bladder of a compression garment. For example, the pump 21 directs a flow of fluid, e.g., air, to repeatably inflate and deflate at least one inflatable bladder of a compression garment, e.g., a properly connect compression garment 10.

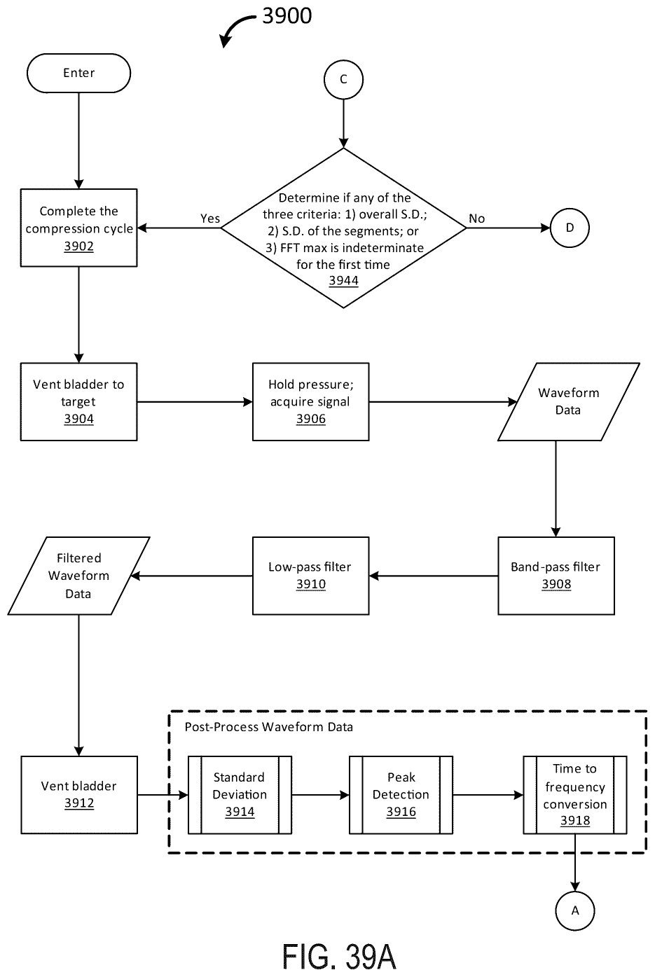

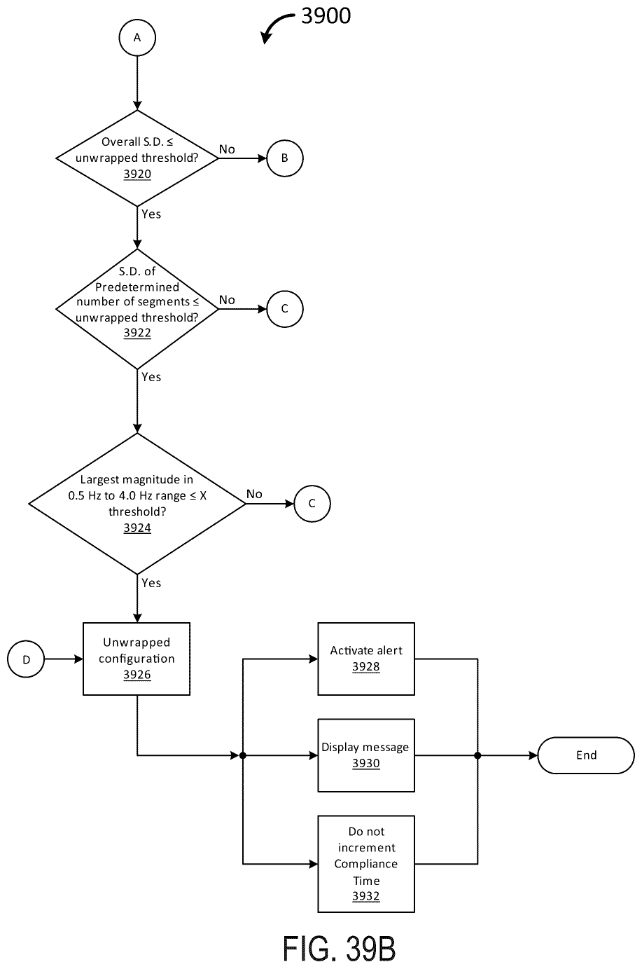

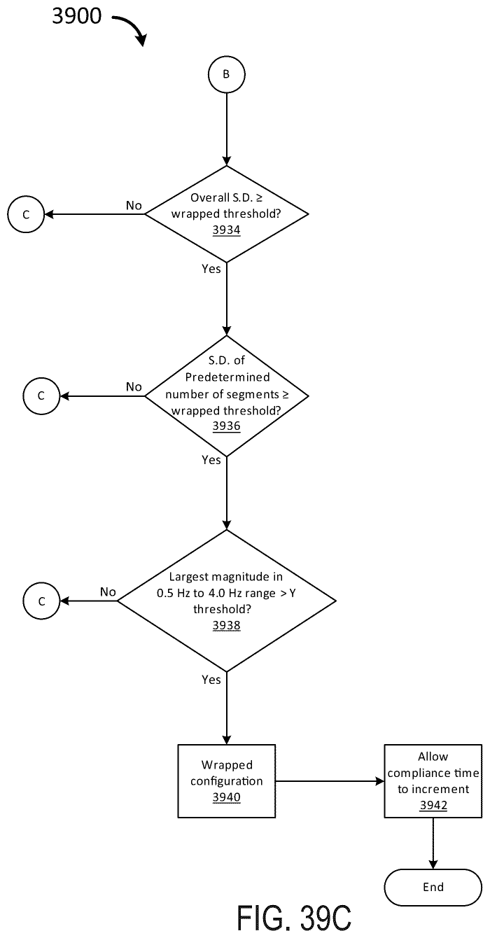

At block 1304, receiving pressure signals indicative of fluid pressure in the at least one inflatable bladder from a pressure sensor communicatively coupled thereto during at least one of inflation and deflation of the at least one inflatable bladder in a plurality of successive compression cycles. For example, the at least one processor 7 receives pressure signals indicative of fluid pressure in the at least one inflatable bladder from a pressure sensor communicatively coupled thereto during at least one of inflation and deflation of the at least one inflatable bladder in a plurality of successive compression cycles. For example, as described with respect to FIGS. 39A-39C, the at least one inflatable bladder can be vented to a target value, held at the pressure and acquire signals. Thus, the signals can be received to determine if the target value is reached e.g.,

during deflation. Similarly, if the at least one inflatable bladder is vented and then inflated to the target value, the signals can be received during inflation. The signals can be received while the at least one bladder is held at the target value/pressure, e.g., during inflation—the at least one bladder is inflated.

At block 1306, processing the received pressure signals and determining if the received pressure signals indicate compliance or non-compliance with a compression therapy. For example, the at least one processor 7 determines if the received pressure signals indicate compliance or non-compliance with a compression therapy. In addition or alternatively, the at least one processor 7 cannot determine compliance or non-compliance based on the received pressure signals, the at least one processor 7 can indicate an error of indetermination. For example, FIGS. 39A-39C provide further details for determining compliance, non-compliance and indetermination/error. Depending on the determination, the method 1300 can proceed to block 1308, 1310 or 1312, thus blocks 1308, 1310 or 1312 are optional.

At block 1308, causing the at least one LED to illuminate a first color in response to determining compliance with the compression therapy. For example, the at least processor 7 causes at least one LED 1112 to illuminate a first color, e.g., green, in response to determining compliance with the compression therapy. The illumination of the first color can be continuous or flashing during compliance with the compression therapy. Any variation of colors may be implemented.

At block 1310, causing the at least one LED to illuminate a second color in response to determining non-compliance with the compression therapy. For example, the at least processor 7 causes at least one LED 1112 to illuminate a second color, e.g., yellow, in response to determining non-compliance with the compression therapy. The illumination of the second color can be continuous or flashing during non-compliance with the compression therapy. Any variation of colors may be implemented.

At block 1312, causing the at least one LED to illuminate a third color in response to determining an error or indetermination. For example, the at least one processor 7 causes at least one LED 1112 to illuminate a third color, e.g., red, in response to not determining compliance or non-compliance with the compression therapy. The illumination of the third color can be continuous or flashing. Any variation of colors may be implemented.

At optional block 1314, displaying, on a graphical user interface (GUI) of the controller, a compliance meter (and/or non-compliance) with the compression therapy or compression therapy regimen. For example, the at least one processor 7 displays the compliance meter as shown in FIG. 15 and further described with respect to FIGS. 12A and 12B.

At optional block 1316, displaying, on a graphical user interface (GUI) of the controller, a plurality of compliance meter (and/or non-compliance) with the compression therapy or compression therapy regimen on a per day basis. For example, the at least one processor 7 displays the compliance meters as shown in FIG. 16 and further described with respect to FIGS. 12A and 12B.

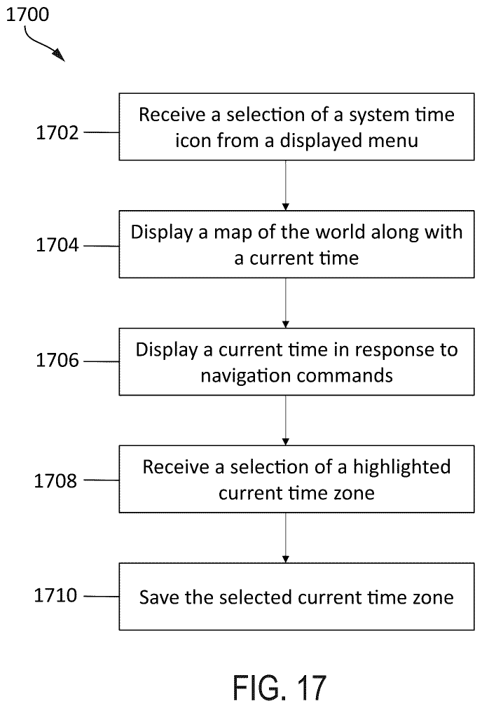

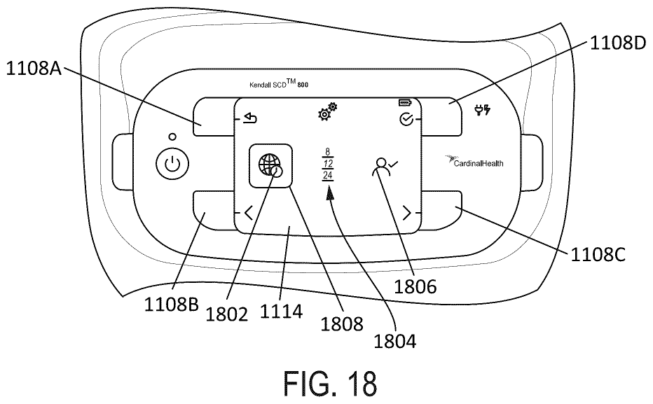

Referring to FIG. 17, the computer executable instructions embodied on the computer readable storage medium 33 cause the one or more processors 7 of the controller 5 to execute a method 1700 for setting the time for the controller 5. The method 1700 begins at block 1702 by receiving a selection of a system time icon from a displayed menu. For example, the at least one processor 7 receives a selection of a system time icon 1802 from a menu displayed by the GUI on the display screen 1114. For example, as shown in FIG. 18, the display screen 1114 includes a plurality of icons including a system time icon 1802, a shift icon 1804 and a patient icon 1806. The system time icon 1802 is for setting the system time. The shift icon 1804 is for setting the shift and/or display period, e.g., 8, 12 or 24 hours as described in relation to 1502 of FIG. 15. The patient icon 1806 indicates whether the patient detection monitoring is on or off. A selection box 1808 can be moved between the menu options by using navigation buttons and a menu option can be selected by using a selection button. To navigate, a go back command is associated with a first button 1108A, a move left command is associated with a second button 1108B, a move right command is associated with a third button 1108C and a select command is associated with a fourth button 1108D. As shown, the system time icon 1802 is selected.

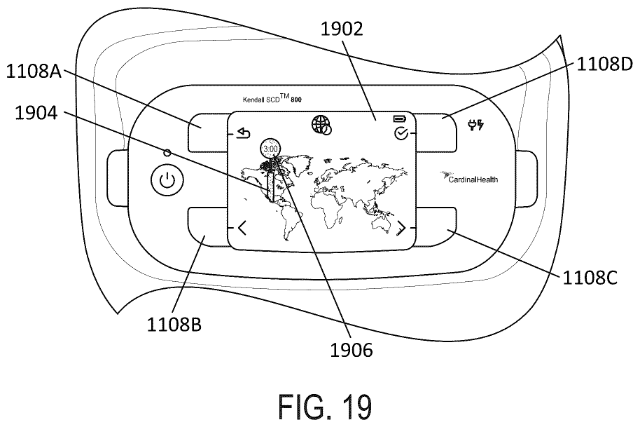

At block 1704, displaying a map of the world along with a current time. For example, the at least one processor 7 causes a display of a map of the world 1902 in response to the system time icon being selected and the current time for a highlighted time zone is displayed. For example, as shown in FIG. 19, the GUI displays the time 1906 is 3:00 in the given time zone 1904 on the display screen 1114 with the given time zone being highlighted. The world map is segmented according to each time zone.

At block 1706, displaying a current item in response to navigation commands. For example, the at least one processor 7 causes the display of a current time in response to navigation commands. For example, FIG. 19 shows a highlighted time zone 1904 and current time 1906. By using the move left command associated with the second button 1108B, the selected time zone moves to the left and using the move right command associated with the third button 808C, the selected time zone moves to the right. The displayed time zone and the current time change in response to the use of the buttons 1108B, 1108C.

At block 1708, receiving a selection of a highlighted current time zone. For example, the at least one processor 7 receives a selection of a time zone in response to the select button associated with the fourth button 1108D being selected.

At block 1710, saving the selected current time zone. For example, the at least one processor 7 saves the selected current time zone in the memory, e.g., computer readable storage medium 33.

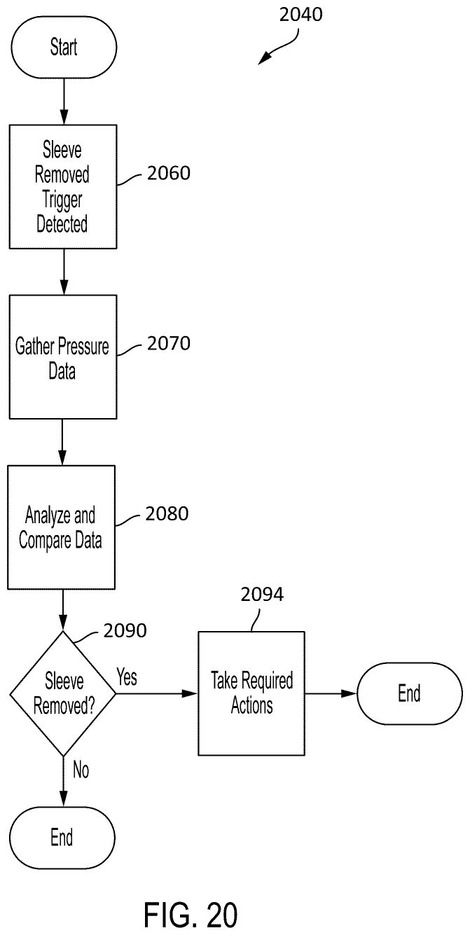

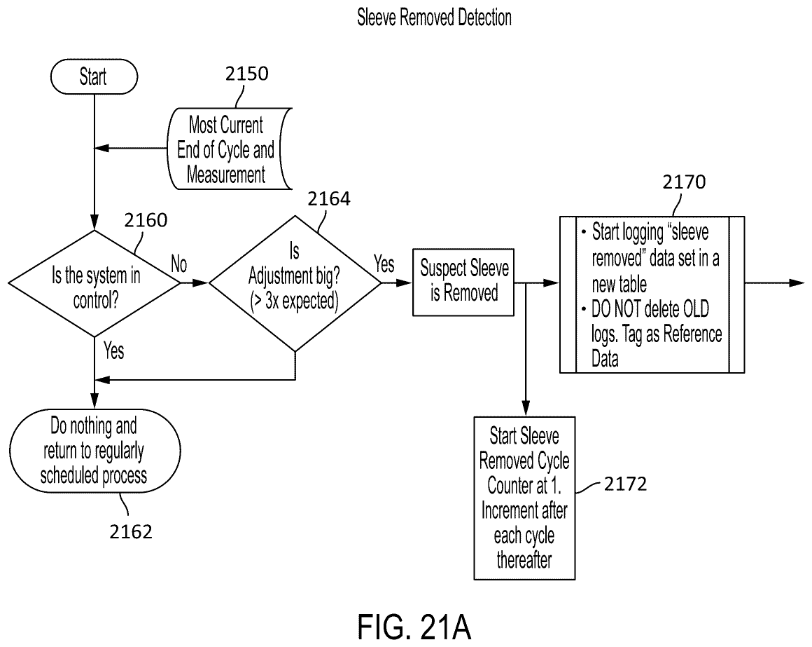

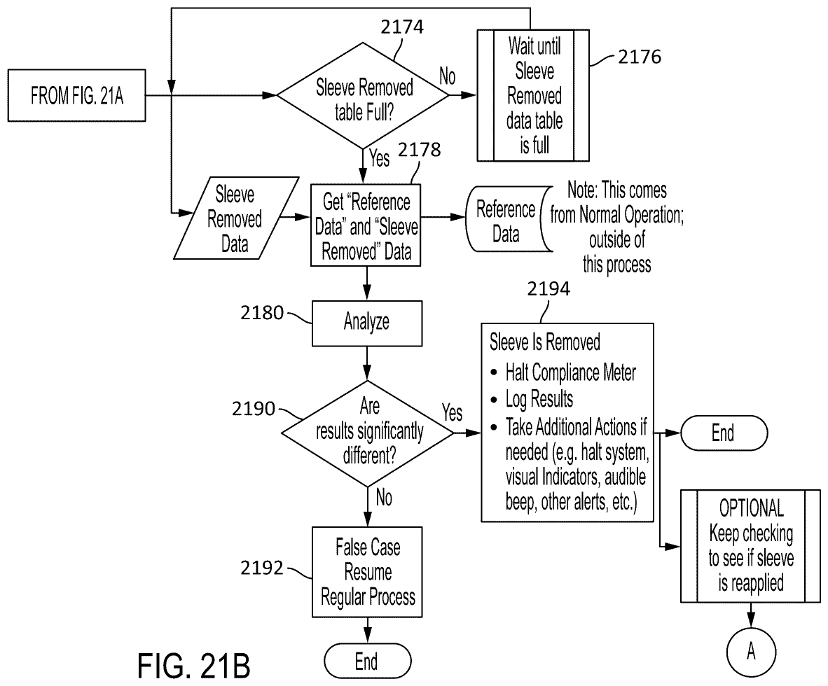

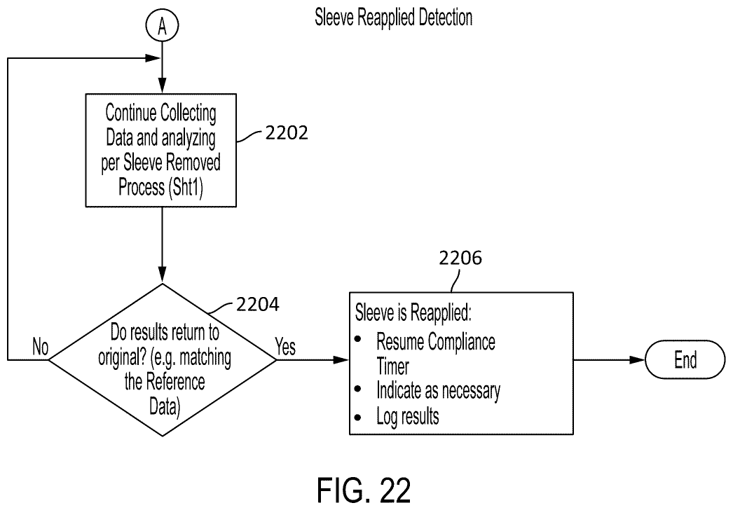

Referring to FIGS. 20-22, the computer executable instructions embodied on the computer readable storage medium 33 cause the one or more processors 7 to execute a method 2040 of determining whether the compression garment 10 is in the wrapped or unwrapped configuration when compression therapy is being applied. The steps set forth in FIG. 20 describe the method of determining whether the compression garment 10 is in the wrapped or unwrapped configuration at a generally high level, and FIGS. 21 and 22 describe the method in greater detail. Reference will be made to all three of the figures in describing the compliance method executed by the one or more processors 7.

Referring to FIGS. 20 and 21, at the start of the compliance determination method 2040, the compression system 1 operates to sequentially inflate and deflate the bladders 13a, 13b, 13c to apply compression treatment to a wearer's limb. The treatment is preferably made according to a predetermined compression regimen or compression therapy, which includes among other things, a prescribed period of time in which the patient should receive the treatment. In one aspect of the disclosure, the compression system 1 may operate indefinitely until stopped. Compliance of the patient with the prescribed treatment time or compression therapy time is monitored. The compression system 1 is operated for several or more cycles as needed to allow the system to settle into a steady state and to collect steady state data before compliance determination begins. However, a compliance timer or counter can be started prior to onset of compliance determination (e.g., implemented as disclosed herein such as in FIGS. 15 and 16). Thus, at the start of the compliance determination method 2040 the compression garment 10 is in the wrapped configuration and operating under a normal (steady state) operating condition. The system 1 operates at step 2050 under default conditions where the one or more processors 7 instruct the pressure sensor 27 to measure the pressure in the manifold 29 throughout the compression cycle. Pressure data is discarded over time and replaced with new more recent pressure data as it becomes available. The one or more processors 7 check at 2060 for the occurrence of a trigger suggesting that the compression garment 10 can have been unwrapped.

In general, a trigger can occur when a measured result differs from an expected result, with the expected result based on the most recent adjustment history and steady state control error(s). A trigger can include, for example and without limitation one or more of the following: an end of cycle pressure change from the previous compression cycle(s) for at least one of the bladders 13a, 13b, 13c; an end of inflation pressure change from the previous compression cycle(s) for at least one of the bladders 13a. 13b, 13c; an adjustment of pump 21 caused by said pressure (e.g., an error in the target measurement); a curvature coefficients change from the previous inflation phase(s) of at least one of the bladders 13a, 13b, 13c; an inflation phase slope change from the previous compression cycle(s) for at least one of the bladders 13a, 13b, 13c; a change in the measured pressure of one or more of the bladders at the end of a cycle of operation, a change in the slope of measured pressure during the vent phase, a change in the initial offset of measured pressure from zero from the previous compression cycle(s); a pressure in one of the inflatable bladders 13b, 13c having a lower target pressure exceeding the pressure in another of the inflatable bladders 13a, 13b having a higher target pressure, a smaller difference in peak pressure between bladders 13a and 13b, a change in the magnitude of adjustment made to operation of the pump 21, a statistically significant change the pressure waveform and any unplanned disturbances in the measured pressures or unplanned adjustments made by the compression system 1.

Referring to FIGS. 21A and 21B, until a trigger occurrence is detected, the compression system 1 continues normal operation (step 2162). If a trigger occurrence is detected, a determination is made at 2164 whether the occurrence exceeds a predetermined condition such as, for example, an expected error for steady state operation. Additionally or alternatively, a pressure change/disturbance producing a control system response greater than three times that of an expected change/disturbance could serve as a predetermined condition. An “expected change/disturbance” could be pre-set or could be criteria established by the controller 5 through operation of the controller in a steady state for a period of time. Additionally or alternatively, an adjustment to pump 21 that is greater than a predetermined threshold as compared to a most recent adjustment could serve as a predetermined condition. For example, a trigger can occur when a new adjustment of pump 21 is greater than 100% of the previous adjustment. The compression system 1 continues 2162 normal operation if it is determined that the trigger occurrence does not exceed the predetermined threshold or satisfy the criteria.

Referring to FIGS. 20-22, data gathering is begun at 2070 if it is determined that the trigger occurrence is valid for use in confirming that a change in condition of the compression garment 10 from wrapped to unwrapped has occurred. The one or more processors 7 activate a “sleeve removed” compression cycle counter at 2072 for counting a number of “sleeve removed” compression cycles for which data is gathered to confirm the trigger occurrence as an indication that the garment 10 has become unwrapped. The number of “sleeve removed” compression cycles are counted at 2074 until a sufficient amount of data (i.e., pressure signals) is obtained. The number of “sleeve removed” compression cycles needed to obtain a sufficient amount of data to determine whether the garment 10 is in the unwrapped configuration can be different under different circumstances. In one aspect, the number of “sleeve removed” compression cycles is between about ten to about twenty compression cycles. Generally, a sufficient amount of data is determined to be obtained when the pressure signals again reach a steady state after the initial trigger occurrence. The memory 33 stores the data associated with the “sleeve removed” cycle separately from the reference data obtained during normal operation of the system 1. Once enough data is obtained at 2076, the one or more processors 7 retrieve the data obtained during the normal operation of the system 1 at step 2078. The one or more processors 7 analyze the “sleeve removed” data after the pressure signals reach the steady state at 2080 to determine bladder pressure values for comparing to the data obtained while the compression system 1 was operating in the normal condition.

The one or more processors 7 determine at step 2090 whether the garment 10 is in the wrapped or unwrapped condition by comparing the “sleeve removed” data to the normal operating condition reference data. The compression system 1 continues normal operation if the one or more processors 7 determine at 1892 that the garment 10 has not been removed and is still in the wrapped configuration. The one or more processors 7 alter recordation of a monitored parameter if it is determined at 2094 that the garment 10 has been removed, placing the garment in an unwrapped configuration. Comparing the “sleeve removed” data to the normal operating condition data at step 2090 can include without limitation one or more of: comparing the end of cycle pressure from the “sleeve removed” data to the end of cycle pressure from the normal operating condition data for at least one of the bladders 13a, 13b, 13c; comparing an end of inflation pressure from the “sleeve removed” data to the end of inflation pressure from the normal operating condition data for at least one of the bladders 13a, 13b, 13c; comparing curvature coefficients from a curve fit on “sleeve removed” data to curvature coefficients from a curve fit on normal operating condition data; comparing an inflation phase slope from the “sleeve removed” data to the inflation phase slope from the normal operating condition data for at least one of the bladders 13a, 13b, 13c; comparing the initial offset of measured pressure from zero on the “sleeve removed” data to the initial offset of measured pressure from zero from the normal operating condition data; comparing a vent phase slope from the “sleeve removed” data to a vent phase slope from the normal operating condition data for at least one of the bladders 13a, 13b, 13c; comparing measured pressures to determine if an inflatable bladder having a lower target pressure has a higher measured pressure than the measured pressure of an inflatable bladder having a higher target pressure; comparing the differences in peak pressures of inflatable bladders 13a, 13b from the “sleeve removed” data to the difference in peak pressures of the bladders 13a, 13b in the normal operating condition data for a decrease in the difference; comparing the magnitude of adjustments to operation of the pump 21 in the “sleeve removed” data to the magnitude of adjustments made in the normal operation data; looking for statistically significant differences in the pressure waveform between the “sleeve removed” data and the normal operation data. For instance, a pressure spike during the vent phase of one of the bladders 13a, 13b, 13c is an indication that the garment 10 is in the wrapped configuration. The comparing step 2090 is a confirmatory analysis for confirming the trigger occurrence as an indication that the garment is in the unwrapped configuration.

If the data comparisons 2090 indicate that a statistically significant change in pressure occurred for any one of the data comparisons, and for any one of the bladders 13a, 13b, 13c, the one or more processors 7 indicate that the garment 10 is in the unwrapped configuration and is no longer being used in a compliant manner. Additionally or alternatively, the one or more processors 7 require confirmation from at least two of the bladders 13a, 13b, 13c that a statistically significant change in pressure occurred for any one of the data comparisons. Additionally or alternatively, the one or more processors 7 require confirmation from all of the bladders 13a, 13b, 13c that a statistically significant change in pressure occurred for any one of the data comparisons. Additionally or alternatively, the one or more processors 7 require confirmation that a statistically significant change in pressure occurred for at least two of the data comparisons.

In response to a confirmation of a pressure change, the one or more processors 7 alter recordation of the monitored parameter at step 2094 by at least one of halting a compliance meter so that no further compression cycles are indicated as being compliant with a compression therapy regimen or compression therapy (e.g., a compliance timer stops incrementing), providing an alarm indication alerting the wearer or clinician of the noncompliance, halting operation of the compression system 1, and storing the results of the comparison in the memory 33 (e.g., a flag).

Optionally, referring to FIG. 22, the method 2040 of determining whether the compression garment 10 is in the wrapped or unwrapped configuration continues by collecting at step 2202 additional “sleeve removed” data after the determination is made by the one or more processors 7 that the garment 10 is in the non-compliant, unwrapped configuration. The one or more processors 7 analyze and compare at 2204 the additional “sleeve removed” data to the normal operating condition data. The one or more processors 7 determine at 2206 that the garment 10 has returned to the wrapped configuration and is again being used in a compliant manner if the data comparisons at 2204 indicate that the additional “sleeve removed” data matches or closely matches the normal operating condition data for any one of the bladders 13a. 13b, 13c. In response, the one or more processors 7 alter recordation of the monitored parameter by at least one of resuming operation of the compression system 1, resuming a compliance meter so that subsequent compression cycles are indicated as being compliant, providing a message alerting the wearer or clinician of the compliance, and storing the results of the comparison in the memory 33. The one or more processors 7 continue to collect at 2202 additional “sleeve removed” data until the one or more processors 7 determine that the pressure signals, such as the measures described above, match or closely match the normal operating condition pressure signal if the data comparisons at 2204 indicate that a statistically significant change in pressure remains for any one of the data comparisons.

In various aspects, the linear regression for the inflation phases of the bladders 13a, 13b, 13c can be further analyzed for comparing between the wrapped and unwrapped conditions. For instance, standard deviation, P-values, max and min values, and an average value can be calculated and compared between the wrapped and unwrapped conditions to further distinguish between the two conditions. Advanced statistics associated with regression analyses (e.g. the curve fitting analysis described herein), such as analysis of residuals, for distinguishing sleeve-on and sleeve-off conditions is also within the scope of the present disclosure.

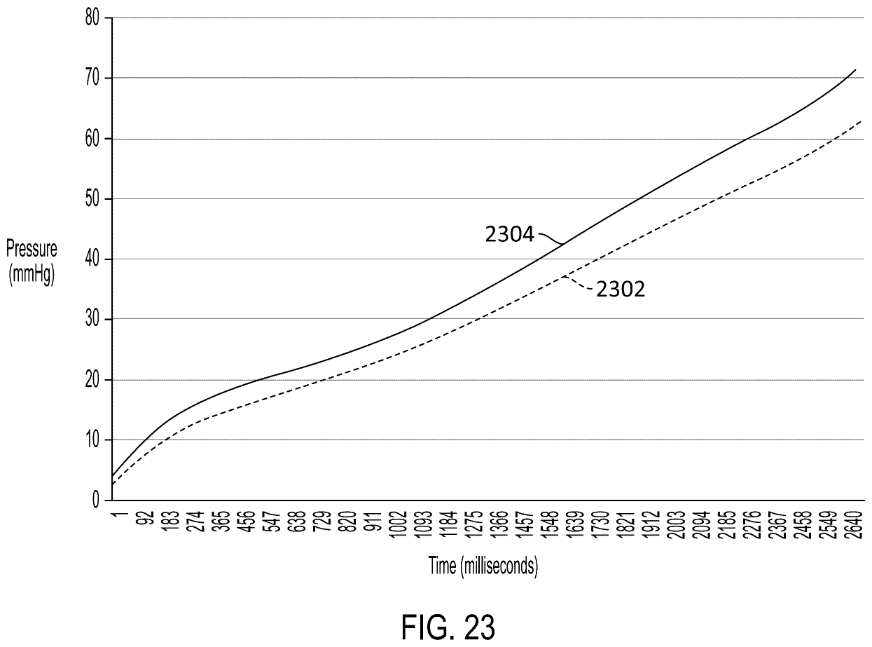

While the curve fits for the inflation phase of the bladders 13a, 13b, 13c have been described as best fit lines, the models could be polynomial curve fits. Referring to FIG. 23, pressure signals from the inflation phase of bladder 13a are modeled with a fifth order polynomial curve fit in the wrapped configuration (2302) and the unwrapped configuration (2304). The fifth order polynomial curve fit accurately represents more dynamic curvature of the inflation phases without being overly responsive to the changes in the pressure signals. Other order polynomial curve fits are also envisioned. As an example, lower orders can be used such as when the curvature is less dynamic and higher orders are not required.

The polynomial curve fits during the inflation phases of the bladders 13a, 13b, 13c in the wrapped configurations are generally straighter (i.e., more linear) than the polynomial curve fits for the inflation phases of the bladders 13a, 13b, 13c in the wrapped configuration. Additionally, for the distal and intermediate bladders 13a, 13b, the pressures throughout the inflation phase in the unwrapped configuration are higher than the pressures throughout the inflation phase in the wrapped configuration. The reverse condition is true for the proximal bladder 13c where the pressures throughout most of the inflation phase in the wrapped configuration are higher than the pressures throughout most of the inflation phase in the unwrapped configuration. Additionally, the starting pressures, or offset, for the bladders 13a and 13b, in the unwrapped configuration are higher than the starting pressures for the bladders 13a and 13b in the wrapped configuration. By recognizing the occurrence of these differing characteristics the compression system 1 can determine when the garment 10 is in a compliant, wrapped configuration and when the garment 10 is in a non-compliant, unwrapped configuration.

Moreover, the polynomial curve fits for the inflation phases of the bladders 13a, 13b, 13c can be further analyzed for comparing between the wrapped and unwrapped conditions. For instance, standard deviation, P-values, max and min values, and an average value can be calculated and compared between the wrapped and unwrapped conditions to further distinguish between the two conditions. Advanced statistics associated with regression analyses (e.g. the curve fitting analysis described herein), such as analysis of residuals, for distinguishing sleeve-on and sleeve-off conditions is also within the scope of the present disclosure.

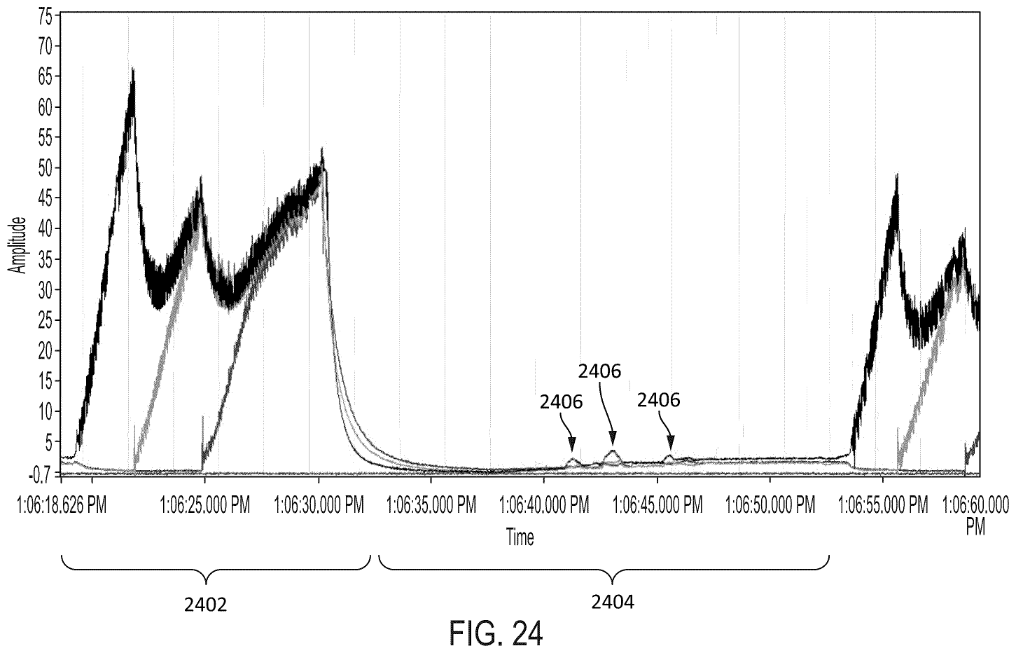

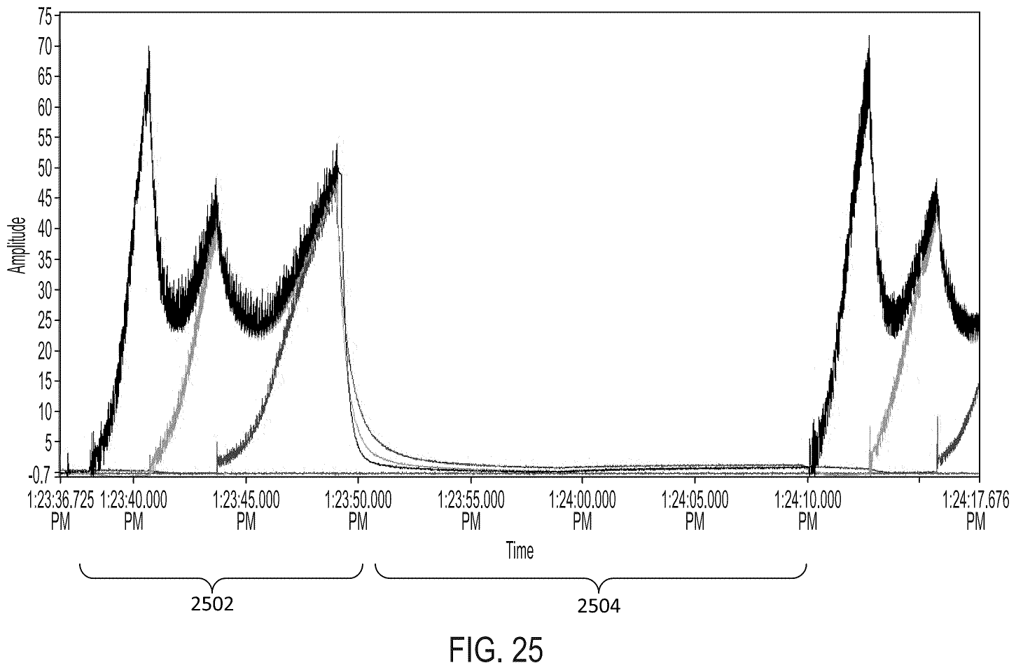

Referring to FIG. 24, a representative compression cycle pressure profile for a wrapped configuration of the compression garment 10 is illustrated. This graph illustrates signals from the pressure sensor 27. A single compression cycle for all three of the bladders 13a, 13b, 13c in a wrapped configuration of the compression garment 10 includes a compression period 2402 and a decompression period 2404. Referring to FIG. 25, a representative compression cycle pressure profile for an unwrapped configuration of the compression garment 10 is illustrated. A compression period 2502 and a decompression period 2504 illustrate a single compression cycle for all three of the bladders 13a, 13b, 13c for the unwrapped configuration of the compression garment 10. The computer executable instructions embodied on the computer readable storage medium 33 include instructions to cause the one or more processors 7 to monitor the signals from the pressure sensor 27 that are indicative of the bladder pressures during the decompression periods 2404, 2504. The computer executable instructions cause the one or more processors 7 to detect a difference between the pressure signal of decompression period 2404 and the pressure signal of decompression period 2504. For example, the pressure signal during the decompression period 2404 includes pressure impulses, indicated generally at 2406 in FIG. 24, which the controller 5 interprets as indicative of wearer movement when the compression garment 10 is in a wrapped configuration. The pressure signal during the decompression period 2504 is relatively static (i.e., no impulses are present) which the controller 5 interprets as indicative of the compression garment 10 being in an unwrapped configuration. By analyzing the pressure signals of the decompression periods 2404, 2504, the computer executable instructions cause the one or more processors 7 to determine whether or not the compression garment 10 is in a wrapped configuration or unwrapped configuration based on the presence (i.e., occurrence) or absence (i.e., non-occurrence) of one or more pressure impulses 2406 during the decompression periods 2404, 2504.

Referring again to FIG. 24, in another aspect of the compression system 1, bladder pressures of the bladders 13a, 13b, 13c are locked and the computer executable instructions cause the one or more processors 7 to detect a rise (e.g., increase) in the pressure signal during the decompression period 2404 when the compression garment 10 is in a wrapped configuration substantially around a limb of a wearer. The pressure signal during the decompression period 2504 (FIG. 25) is relatively static (i.e., no pressure rise is present) which the controller 5 interprets as indicative of the compression garment 10 being in an unwrapped configuration. The computer executable instructions cause the one or more processors 7 to determine whether the compression garment 10 is in a wrapped or unwrapped configuration based on the presence (i.e., occurrence) or absence (i.e., non-occurrence) of a pressure rise during the decompression periods 2404, 2504.

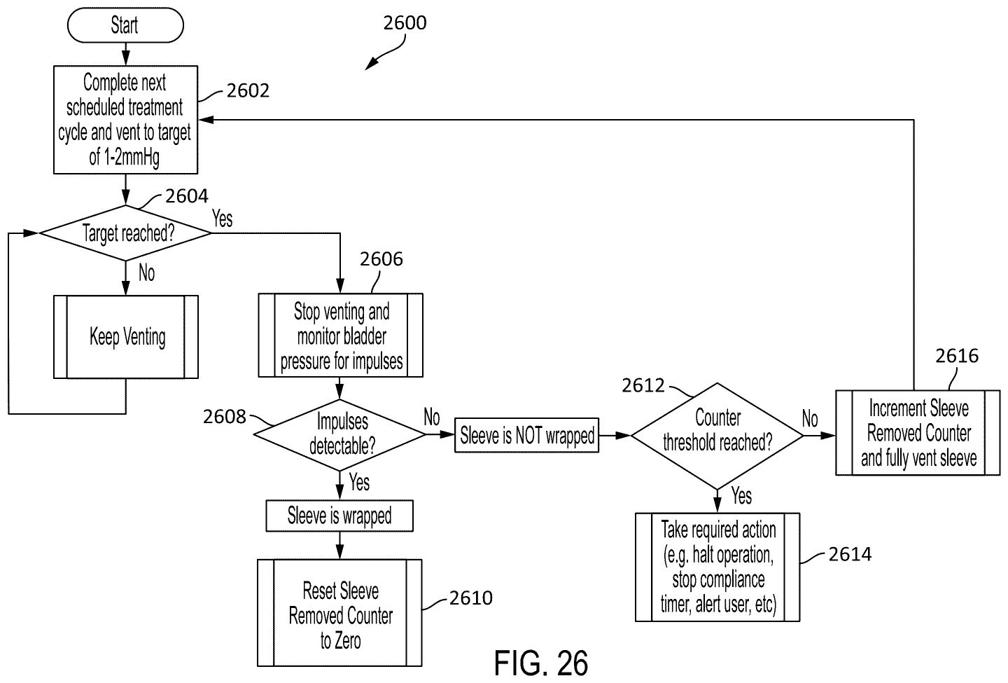

Referring to FIG. 26, the computer executable instructions embodied on the computer readable storage medium 33 cause the one or more processors 7 to execute a method 2600 of determining whether the compression garment is in the wrapped or unwrapped configuration by detecting one or more pressure impulses in the pressure signal received from the pressure sensor 27. The compression system 1 operates at step 2602 to inflate and deflate bladders 13a, 13b, 13c to apply compression treatment to a wearer's limb, and to vent the bladders 13a, 13b, 13c down to a target value, such as 1-2 mmHg. The computer executable instructions cause the one or more processors 7 to determine at step 2604 whether the pressure in the bladders 13a, 13b, 13c has reached the target value. If the target value has not been reached, the computer executable instructions cause the one or more processors 7 to continue venting the bladders 13a, 13b, 13c and the process returns back to step 2604. If the target value has been reached, the computer executable instructions cause the one or more processors 7 to stop venting the bladders 13a, 13b, 13c and monitor the pressure signal from pressure sensor 27 for impulses during the decompression period at step 2606. It is appreciated that a filtered signal can be assumed such that any impulse observed would be above baseline signal noise without departing from the scope of the present disclosure. The signal can be filtered, for example, by filtering circuitry in controller 5 and/or by digital filtering techniques implemented by the one or more processors 7 via the computer executable instructions. It is appreciated that the computer executable instructions can cause the one or more processors 7 to perform waveform peak detection to determine the amplitude of anomalous peaks versus peaks within the expected noise without departing from the scope of the present disclosure. It is also appreciated that the computer executable instructions can cause the one or more processors 7 to utilize signal threshold limit detection without departing from the scope of the present disclosure. For example, if an impulse greater than 1 mmHg above noise is detected, then that impulse is considered a pressure impulse. The computer executable instructions cause the one or more processors 7 to implement a counter, with which a count is kept for the number of consecutive cycles in which no impulses are observed.

At step 2608, the computer executable instructions cause the one or more processors 7 to determine whether an impulse was detected by the processor 7 at step 2606. If an impulse was detected during step 2606, the computer executable instructions cause the one or more processors 7 to reset 2610 the counter to zero because the impulse is indicative of the compression garment 10 being in a wrapped configuration substantially around a limb of a wearer. If an impulse was not detected during step 2606, then such a nonoccurrence (i.e., absence) of an impulse is indicative of the compression garment 10 being in an unwrapped configuration away from a limb of a wearer. In such a case, the computer executable instructions cause the one or more processors 7 to determine whether the count of the counter has met or exceeded a counter threshold at step 2612. For example, the threshold can be ten consecutive cycles, but one skilled in the art will appreciate that the threshold can be any integer value. Meeting or exceeding the threshold indicates that the compression garment 10 is in the unwrapped configuration away from the limb of the wearer because a pressure anomaly (e.g., pressure impulse) would have been detected by the one or more processors 7 if the compression garment 10 were in the wrapped configuration.

If the one or more processors 7 determine at step 2612 that the count of the counter has met or exceeded a counter threshold, then the computer executable instructions cause the one or more processors to take a required action at step 2614. For example, the one or more processors 7 can halt operation, stop a compliance timer, alert a user (e.g., the wearer or caregiver), and the like. If the one or more processors 7 determine at step 2612 that the count of the counter has not reached the counter threshold, then the computer executable instructions cause the one or more processors 7 to increment the count of the counter and fully vent the bladders 20a, 20b, 20c at step 2616 and the process returns to step 2602.

In an alternative aspect, the method 2600 of FIG. 26 is implemented during Venous Refill Measurements. In such an aspect, the bladder 13b is at a compression value, e.g., 45 mmHg, the bladder 13b is vented to a target pressure (e.g., 5-7 mmHg) and therefore is more firmly in contact with the limb of the wearer compared to deflating the bladder 13b. Alternatively, the bladder 13b can be deflated and then inflated to the target bladder pressure. Accordingly, pressure impulses due to patient movement are even more evident in the pressure signal of pressure sensor 27. For example, the bladder 13b is vented to the target pressure (e.g., 6 mmHg) at step 2604 and the bladder pressure response is monitored/analyzed for standard deviation and Fast Fourier Transform (FFT) at steps 2606 and 2608 as explained with respect to FIG. 39. If the standard deviations exceed a threshold (e.g., 0.25) and FFT maximum exceeds a threshold (e.g., 5), the method 2600 determines that there are enough pressure impulses to indicate that the compression garment 10 is being worn by the wearer (e.g., patient).

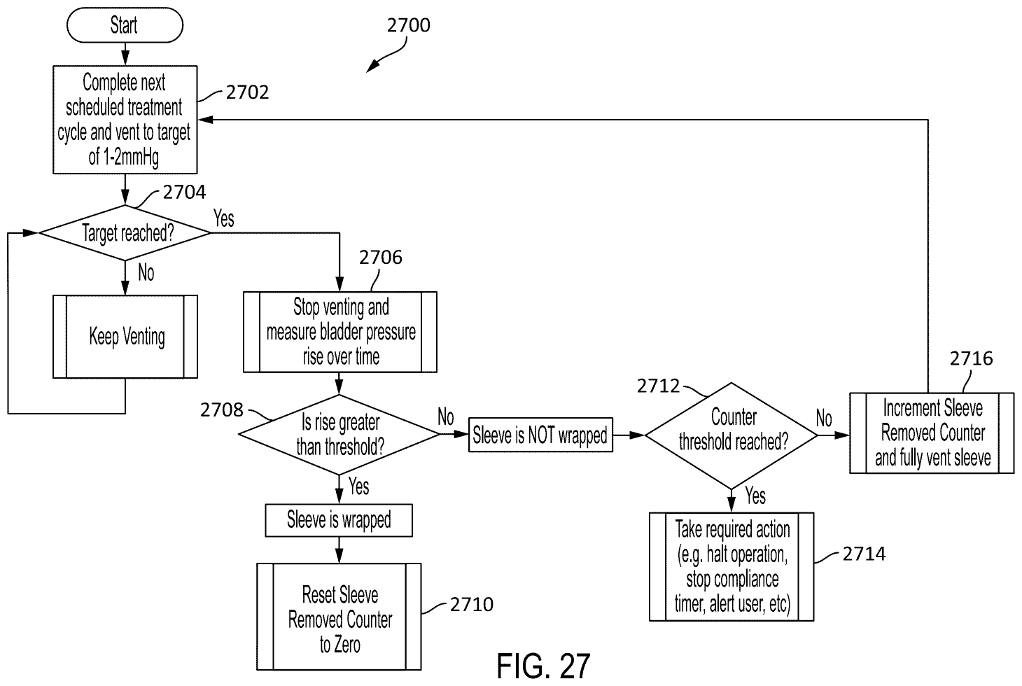

Referring to FIG. 27, the computer executable instructions embodied on the computer readable storage medium 33 cause the one or more processors 7 to execute a method 2700 of determining whether the compression garment is in the wrapped or unwrapped configuration by detecting a rise (e.g., increase) in the pressure signal received from the pressure sensor 27. The compression system 1 operates at step 2702 to inflate and deflate bladders 13a, 13b, 13c to apply compression treatment to a wearer's limb, and to vent the bladders 13a, 13b, 13c down to a target value, such as 1-2 mmHg. The computer executable instructions cause the one or more processors 7 to determine at step 2704 whether the pressure in the bladders 13a, 13b, 13c has reached the target value. If the target value has not been reached, the computer executable instructions cause the one or more processors 7 to continue venting the bladders 13a, 13b, 13c and the process returns to step 2704. If the target value has been reached, the computer executable instructions cause the one or more processors 7 to stop venting the bladders 13a, 13b, 13c and monitor the pressure signal from pressure sensor 27 for a rise during the decompression period at step 2706. In an aspect, a filtered signal is assumed such that any rise observed would be above baseline signal noise. The signal can be filtered for example, by filtering circuitry in controller 5 and/or by digital filtering techniques implemented by the one or more processors 7 via the computer executable instructions. The one or more processors 7 monitor the pressure signal for a pressure rise greater than a threshold value (e.g., 1-2 mmHg), which indicates that the compression garment 10 is in a wrapped configuration substantially around a limb of a wearer. A lack of a rise in the pressure signal, or a rise less than the threshold value, indicates that the compression garment 10 is in an unwrapped configuration away from a limb of a wearer. The computer executable instructions cause the one or more processors 7 to implement a counter, with which a count is kept for each cycle failing to achieve the threshold pressure rise.

At step 2708, the computer executable instructions cause the one or more processors 7 to determine whether a pressure rise greater than the threshold value was detected by the processor 7 at step 2706. If a pressure rise greater than the threshold was detected during step 2706, the computer executable instructions cause the one or more processors 7 to reset 2710 the counter to zero because the pressure rise is indicative of the compression garment 10 being in a wrapped configuration substantially around a limb of a wearer. If a rise above the threshold was not detected during step 2706, then such a nonoccurrence of a pressure rise is indicative of the compression garment 10 being in an unwrapped configuration away from a limb of a wearer. In such a case, the computer executable instructions cause the one or more processors 7 to determine whether the count of the counter has met or exceeded a counter threshold at step 2712. For example, the threshold can be ten consecutive cycles, but one skilled in the art will appreciate that the threshold can be any integer value. Meeting or exceeding the threshold indicates that the compression garment 10 is in the unwrapped configuration away from the limb of the wearer because a pressure anomaly (e.g., pressure rise) would have been detected by the one or more processors 7 if the compression garment 10 were in the wrapped configuration.

If the one or more processors 7 determine at step 2712 that the count of the counter has met or exceeded a counter threshold, then the computer executable instructions cause the one or more processors to take a required action at step 2714. For example, the one or more processors 7 can halt operation, stop a compliance timer, alert a user (e.g., the wearer or caregiver), and the like. If the one or more processors 7 determine at step 2712 that the count of the counter has not reached the counter threshold, then the computer executable instructions cause the one or more processors 7 to increment the count of the counter and fully vent the bladders 13a, 13b, 13c at step 2716 and the process returns to step 2702.

In alternative aspect, the actual shape of the pressure profile of the signal generated by pressure sensor 27 is in itself a potential indicator. For example, the shape of the profile could be calculated such that when the resulting function (i.e., the shape) matches a pre-determined function (i.e., shape), the computer executable instructions cause the one or more processors 7 to determine that the compression garment 10 is in the wrapped configuration. Conversely, failure of the resulting function to match the pre-determined function would result in the computer executable instructions causing the one or more processors 7 to determine that the compression garment 10 is in the unwrapped configuration. Such an aspect can be used with the counters described in conjunction with methods 2600, 2700 described above.

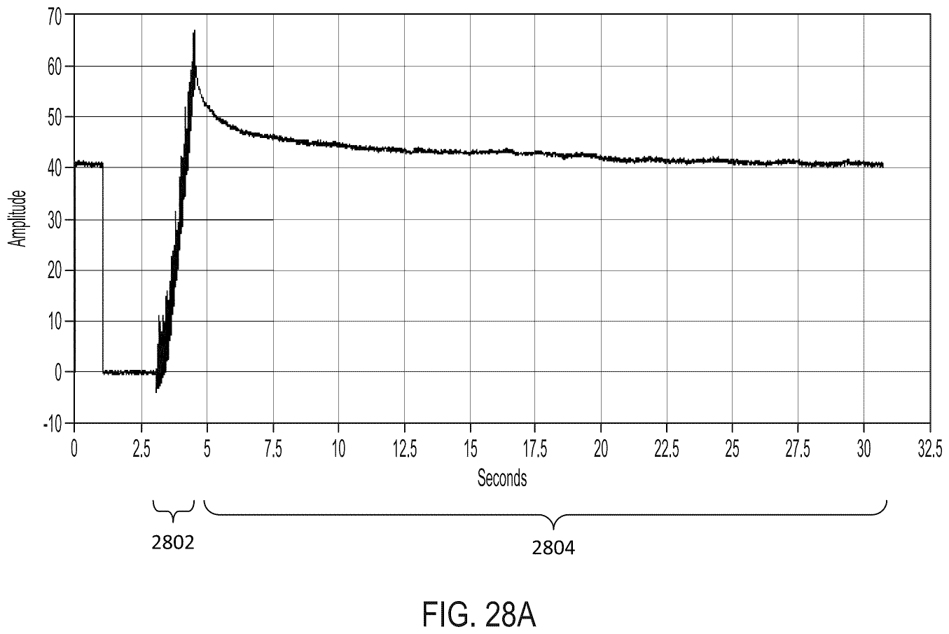

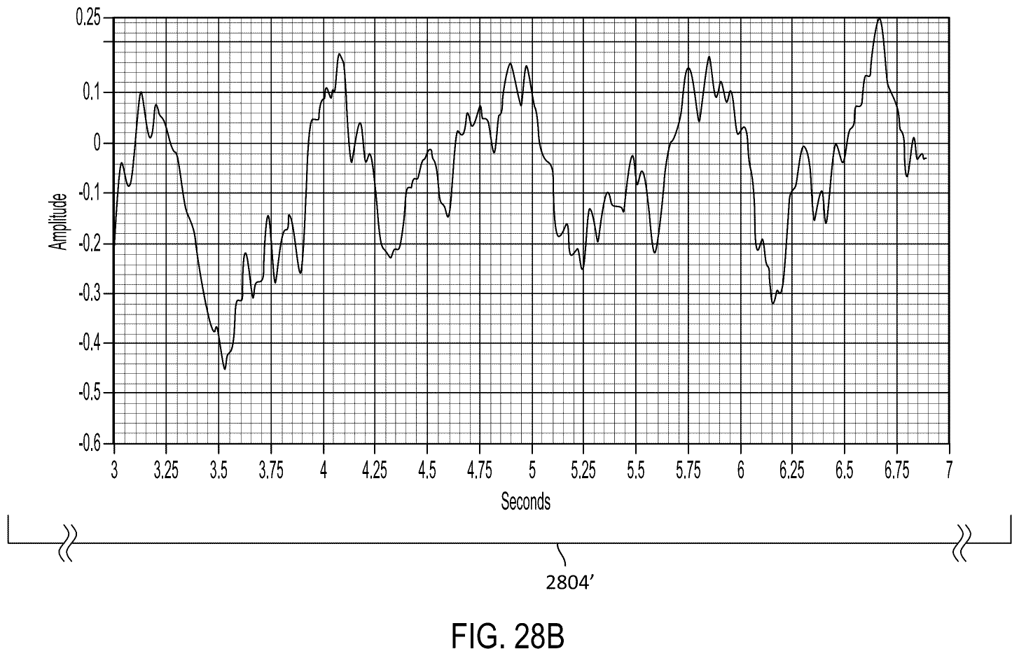

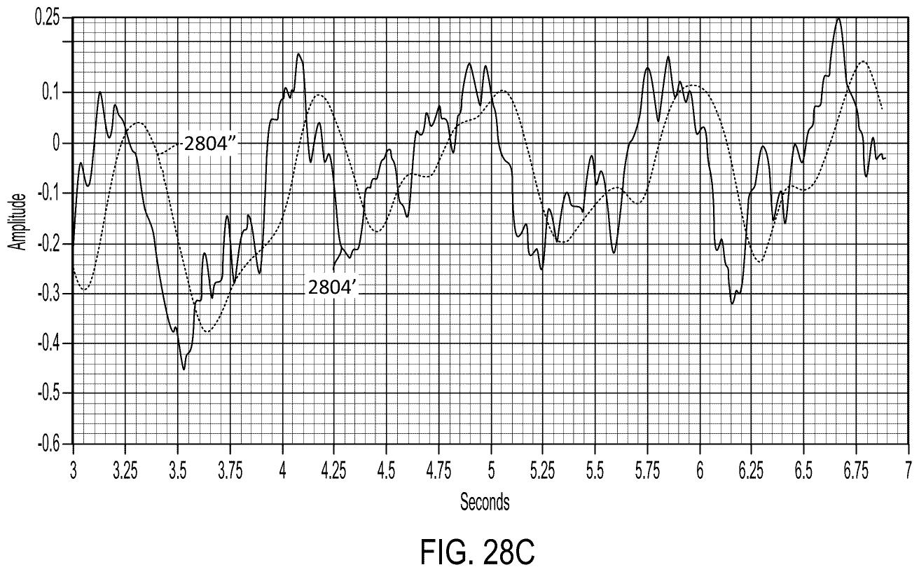

Referring to FIG. 28A, a pressure signal from the pressure sensor 27 is shown for one of the bladders 13a, 13b, 13c in a wrapped configuration of the compression garment 10 on a limb of the wearer during a representative bladder inflation period 2802 and a pressure hold period 2804. In the example in FIG. 28A, the pressure hold period 2804 is about twenty-seven seconds in duration and represents the bladder 13a, 13b, 13c inflated to about 45 mmHg, which is a typical inflation threshold of a therapeutic cycle of the bladders 13a, 13b, 13c. In accordance with another aspect of the disclosure, the pressure hold period 2804 may be about twenty seconds in duration and represent one of the bladders 13a, 13b, or 13c inflated to about 200 mmHg. Accordingly, the oscillation amplitude in the pressure signal for a bladder inflated to about 200 mmHg will be higher than the oscillation amplitudes illustrated herein associated for a bladder inflated to about 45 mmHg.

Referring to FIG. 28B, a waveform 2804′ shows the result of a band-pass filtering technique applied to a subset signal of interest of the pressure hold period 2804 such that a frequency range (e.g., 0.5 Hz to 25 Hz, 0.5 Hz to 5 Hz, etc.) has been extracted. The representative subset portion of the pressure hold period 2804 is shown on a smaller scale, as compared to FIG. 28A, such that pulses are visible in the pressure signal during the pressure hold period 2804′. The pulses in the pressure pulse in FIG. 28B are associated with a pressure effect produced on the bladder 13a, 13b, or 13c by the pulse of the wearer. Waveform pulsations associated with the pulse of the wearer of the compression garment 10 remain evident in waveform 2804′. The computer executable instructions embodied on the non-transitory, computer readable storage medium 33 include instructions to cause the one or more processors 7 to receive a signal from the pressure sensor 27, the received signal being indicative of the fluid pressure in one or more of the bladders 13a, 13b, 13c during the bladder inflation period 2802 and the pressure hold period 2804.

In certain aspects, the computer executable instructions further include instructions to cause the one or more processors 7 to refine further the signal from the pressure sensor 27 to extract, during the pressure hold period 2804, only frequencies associated with the typical cardiac cycle range of a human. For example, the computer executable instructions can include computer executable instructions to cause the one or more processors 7 to extract (e.g., through a band-pass filtering technique) frequencies in the range of 0.5 Hz to 25 Hz.

FIG. 28B shows that, as the oscillation amplitude decreases, the impact of noise on the signal is more significant (i.e., the signal-to-noise ratio is smaller). Additional pre-processing and/or post-processing of the data can be useful to obtain less distorted results. In some aspects, the computer executable instructions further include instructions to cause the one or more processors 7 to filter the signal of the pressure hold period 2804 to remove frequencies that are not associated with a pulse of a human wearer and to cause the one or more processors 7 to implement one or more peak detection algorithms and/or compliance monitoring algorithms. In certain aspects, the one or more computer executable instructions further include instructions to cause the one or more processors 7 to perform the additional pre-processing and/or post-processing to decrease the impact of noise on the signal received from the pressure sensor 27. It should be appreciated that the signal received from the pressure sensor 27 and processed by the one or more processors 7 includes pulsation associated with the heartbeat of the wearer and not the actual heart rate of the wearer. For example, the blood flow as the wearer's heart beats creates pressure on at least one of inflatable bladders 13a, 13b, 13c, which the pressure sensor 27 detects and generates pressure signals representative thereof.

Referring to FIG. 28C, the waveform 2804′ is overlaid on a waveform 2804″, the waveform 2804″ being the result of a smoothing algorithm filtering technique applied to waveform 2804′ by the one or more processors 7. In this exemplary aspect in FIG. 28C, the smoothing follows a rectangular window at five times (e.g., 5×) the moving range. Even at pressures as low as those associated with typical Venous Refill Detection (VRD) techniques (e.g., about 5 to about 20 mmHg), the waveform still provides evidence of pulsations indicative of sufficient contact between the wearer and the compression garment 10.

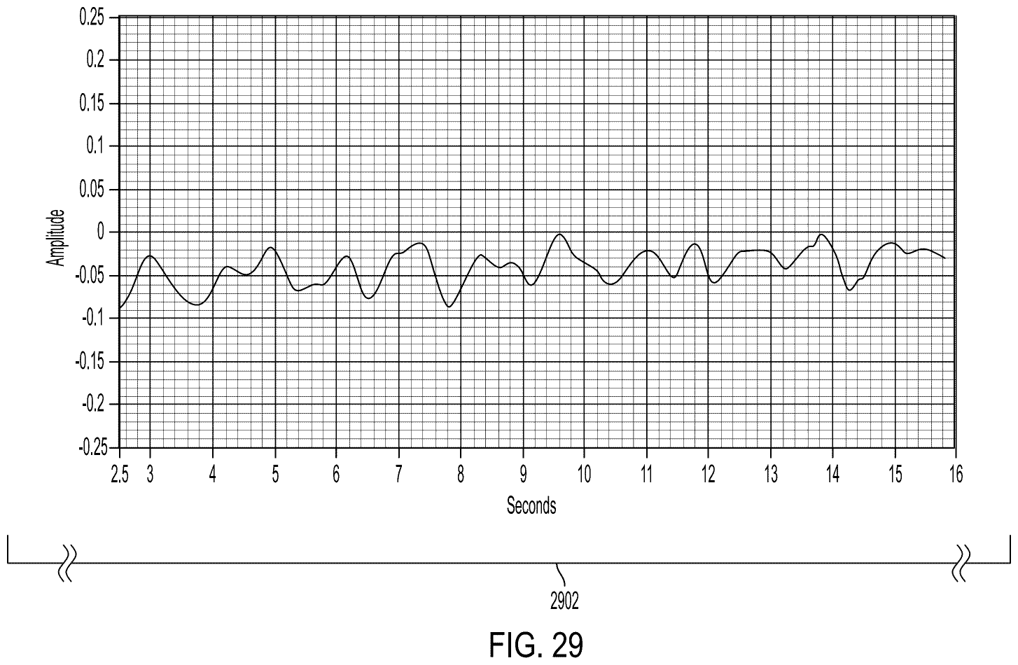

FIG. 29 shows a pressure signal received from the pressure sensor 27 during a representative bladder pressure hold period 2902 pressure profile of one of the bladders 13a, 13b, 13c for an unwrapped configuration of the compression garment 10. The overall amplitude of the pressure profile 2902 is less than the amplitudes of the analogous pressure hold period 2804 (shown in FIG. 28A). The absence of clear, repeating pulses in the pressure profile 2902 is an indication that the compression garment 10 is in an unwrapped configuration or is not properly worn by the wearer.

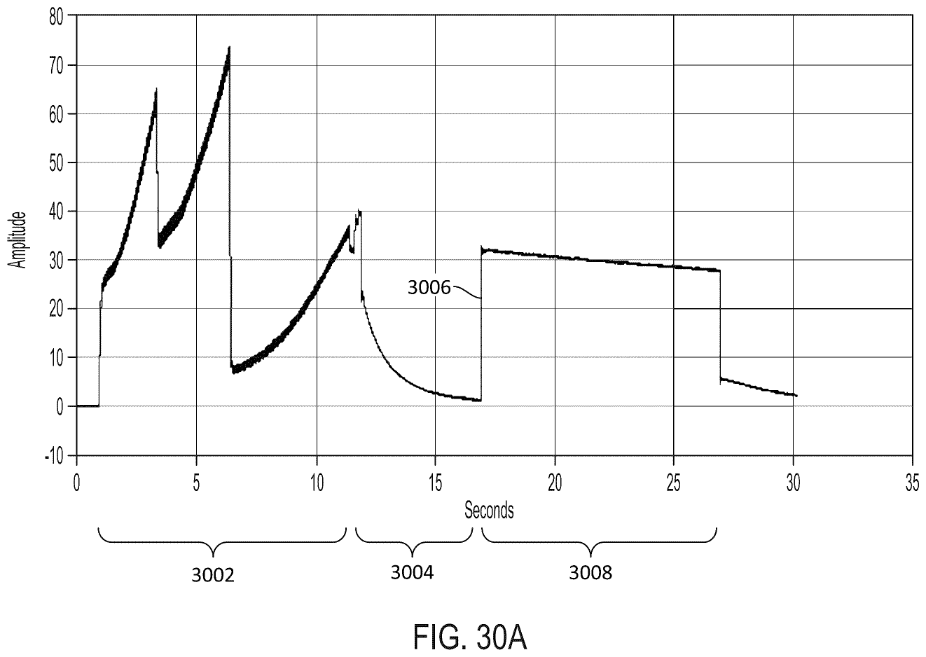

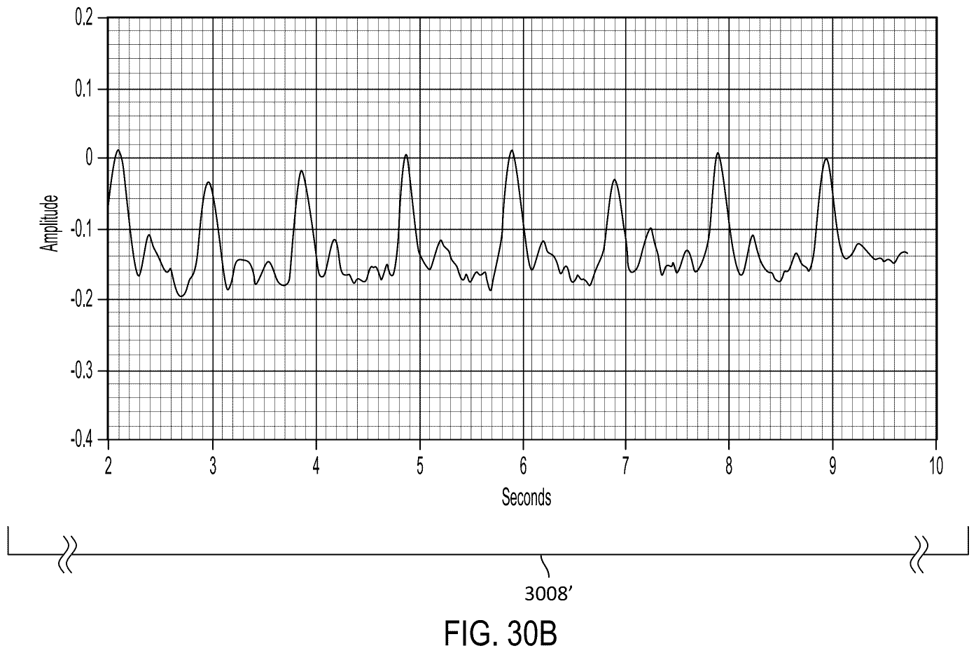

FIG. 30A shows a pressure signal received from the pressure signal 27 and representative bladder pressure profile for one of bladders 13a, 13b, 13c. The pressure profile includes a therapy cycle period 3002, a bladder vent period 3004, a bladder test inflation period 3006, and a bladder pressure hold period 3008. At the end of the therapy cycle period 3002, the tested bladder (e.g., one of bladders 13a, 13b, 13c) vents during the bladder vent period 3004. After the bladder vent period 3004, a short inflation is applied to the tested bladder during the bladder inflation period 3006 until the tested bladder achieves a pressure of about 30 mmHg. The one or more processors 7 execute computer executable instructions such that pulse detection, as further described below, is performed by the one or more processors 7 during the bladder pressure hold period 3008, which is about ten seconds in this exemplary aspect. The bladder pressure hold period 3008 can be for a longer or shorter duration, provided that the duration is long enough to ensure that multiple pulses occur within the duration.

FIG. 30B illustrates a waveform 3008′ indicative of the result of a filtering technique applied to a signal of interest during the pressure hold period 3008. In some aspects, the computer-executable instructions include instructions to cause the one or more processors 7 to detect dominant peaks and check that the waveform falls within an expected range (e.g., 60-100 beats per minute (bpm) for a human wearer). In some aspects, the expected range is 60-100 beats per minute (bpm) for a human wearer. It should be appreciated, however, that a wider range (e.g., 30-120 bpm) can be used to account for wearers who may be of ill-health and/or to account for measurements that may occur at locations on the body far away from the heart (e.g., the lower leg). In this exemplary aspect, the one or more processors 7 detect pulsation associated with the heartbeat of the wearer and not the actual heart rate of the wearer.

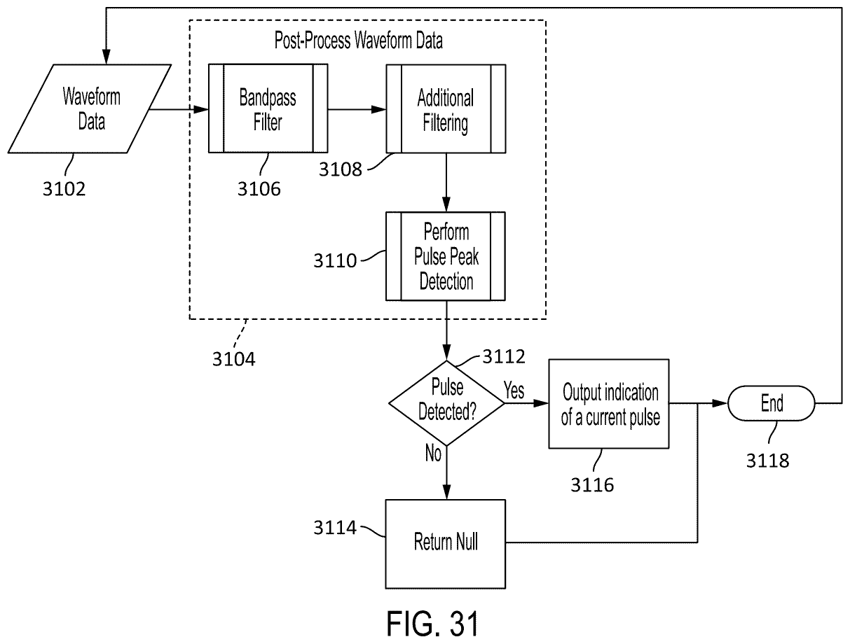

FIG. 31 is a schematic representation of an exemplary method 3100 of analyzing waveform data received from the pressure sensor 27 to determine whether the compression garment 10 is in the wrapped or unwrapped configuration around a limb of a wearer of the garment by detecting pulsations associated with the heartbeat of the wearer. This exemplary method can be carried out by the one or more processors 7 through execution of computer executable instructions embodied on the non-transitory, computer readable storage medium 33.

The one or more processors 7 execute computer executable instructions to sample 3102 initial pressure. In some aspects, the initial pressure sampling is done at a rate of 100 Hz or higher and typical signal conditioning is used to remove baseline noise. Additionally or alternatively, the sampling 3102 may be expanded to include attenuation of frequencies just under a low cutoff (e.g., 0.25 Hz).

A post-process waveform analysis 3104 further includes a bandpass filter 3106, an additional filtering 3108, and a peak detection 3110. During the bandpass filter 3106, the signal of interest is filtered using a bandpass filtering technique in a typical range of frequencies associated with a typical heartrate range of a human wearer (e.g., 0.5-4 Hz for a human wearer).

During the additional filtering 3108, the peaks of the bandpass filtered signal are further refined. The additional filtering can include a lowpass filter with a cutoff of 5 Hz to produce a filtered value. Additionally or alternatively, the additional filtering can include a smoothing algorithm using the five most recent samples of the moving range to produce a filtered value. It should be appreciated that more than one filtering technique may be applied to the bandpass filtered signal during the additional filtering step 3108.

During a peak detection 3110, a peak detection is performed to check that the peaks of the filtered signal correspond to a heartbeat range of a typical human wearer. The peak detection 3110 can be based on a predetermined threshold (e.g., look only at peaks with a magnitude greater than 0.05 mmHg). Additionally or alternatively, the peak detection 3110 can be based on examining for repeating signals with frequencies within a heartbeat range of a typical human wearer, independent of magnitude (e.g., expanded to 30-240 bpm for margin). For example, a frequency analysis computation may be performed to check that a repeating signal with frequency within the heartbeat range of a typical human wearer is detected. Additionally or alternatively, the peak detection 3110 can be based on the highest magnitude peaks and checking that the frequency of those peaks falls within the expected heartbeat range of a typical human wearer. It should be appreciated that more than one peak detection technique may be used during the peak detection 3110. In some aspects, peak detection 3110 includes a combination of peak detection based on a predetermined threshold and based on the highest magnitude peaks and checking that the frequency of those peaks falls within the expected heartbeat range of a typical human wearer because the signal-to-noise ratio is high enough that the pulses are plainly evident.

The computer executable instructions cause the one or more processors 7 to determine 3112 whether a features of a pulse of the wearer were detected during the peak detection 3110. If features of a pulse are determined 3112 to be present, the results of a positive determination can be indicated 3116. For example, the indication 3116 can include sending a visual representation to a display device associated with the compression system 1. Additionally or alternatively, the indication 3116 can include incrementing and/or pausing a timer. Upon the indication 3116, the process ends at step 3118 and returns back to step 3102. If an impulse is not detected at step 3112, the computer executable instructions cause the one or more processors 7 to return a null value at step 3114. After step 3114, the process ends at step 3118 and returns to sampling 3102.

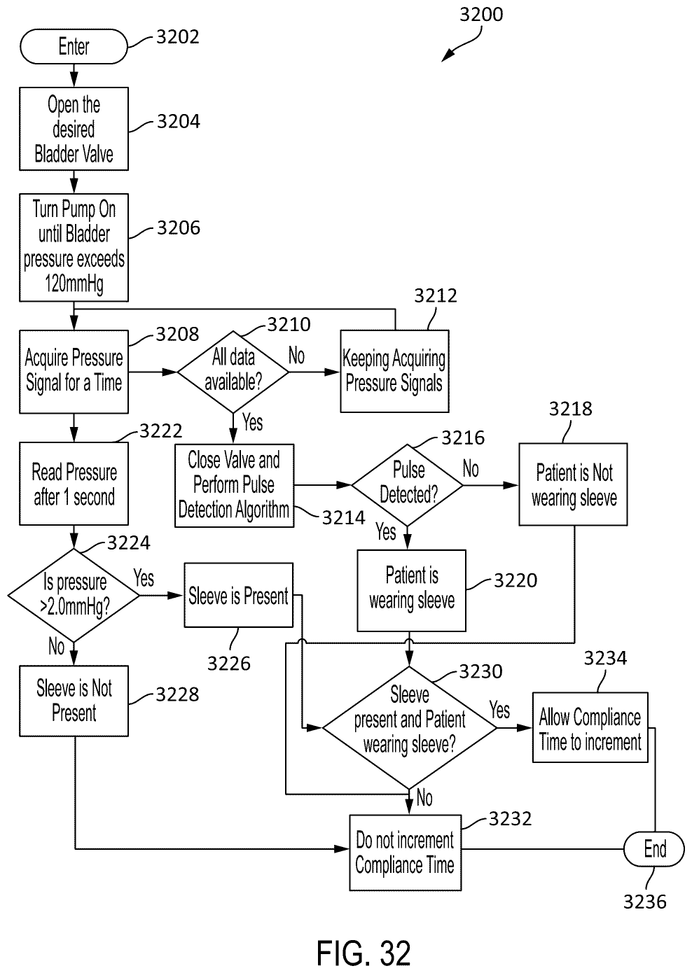

Referring to FIG. 32, is a schematic representation of an exemplary method 3200 of analyzing waveform data received from a pressure sensor (e.g., the pressure sensor 27) to determine whether a compression garment (e.g., compression garment 10) is in the wrapped or unwrapped configuration during a garment verification process. For ease of explanation and for the sake of clarity, the method 3200 is described for a single bladder (e.g., one of the bladders 13a, 13b, or 13c). It should be appreciated, however, that the method 3200 can be repeated to check for additional bladders corresponding to different valves.

The method 3200 begins at step 3202 and the desired bladder valve (e.g., bladder valve 25 a, 25 b. 25 c) is opened 3204. A pressurized fluid source (e.g., pressurized fluid source 21) is turned on 3206 until pressure in the corresponding bladder exceeds about 120 mmHg.

A pressure signal is received 3208 from the pressure sensor 27 for a period of time. A determination 3210 is made regarding whether all data are available. If all data are not available, pressure signals continue to be acquired 3212 and the pressure signal is received 3208. If the determination 3210 is made that all data are available at step 3210, close the corresponding valve is closed 3214 and a pulse detection algorithm is performed.

In some aspects, the pulse detection algorithm includes one or more steps of the post-process waveform analysis 3104 described above.

A determination 3216 is made regarding whether a pulse is detected after the valve is closed 3214 and fluid is isolated in the bladder. The lack of detection of a pulse is indicative of the compression garment 10 being in an unwrapped configuration away from a limb of the wearer at step 3218 and the method proceeds to step 3232, where a compliance time is not incremented, before ending the method at step 3236. The detection of a pulse at step 3216 is indicative of the compression garment 10 being in a wrapped configuration around a limb of the wearer at step 3220 and the method continues to step 3230.

At step 3222, the computer executable instructions cause the one or more processors 7 to read the pressure after one second has elapsed after the pump is turned on in step 3206. At step 3224, the computer executable instructions cause the one or more processors 7 to determine whether the pressure is greater than 2.0 mmHg. The pressure exceeding 2.0 mmHg at step 3224 is indicative of the compression garment 10 being present (e.g., in fluid communication with valve 25 a, 25 b, 25 c) at step 3226 and the method proceeds to step 3230. The pressure not exceeding 2.0 mmHg at step 3224 is indicative of the compression garment 10 not being present (e.g., not in fluid communication with valve 25 a, 25 b, 25 c) at step 3228 and the method proceeds to step 3232, where a compliance time is not incremented, before ending the method at step 3236.

At step 3230, the computer executable instructions cause the one or more processors 7 to determine whether the compression garment 10 is present and in a wrapped configuration around a limb of the wearer. If either the compression garment 10 is determined to not be present or not be in a wrapped configuration around a limb of the wearer, then the method proceeds to step 3232 where a compliance time is not incremented before ending the method at step 3236. If the compression garment 10 is determined by the one or more processors 7 to be present and be in a wrapped configuration, then the method proceeds to step 3234 where a compliance time is incremented before ending the method at step 3236.

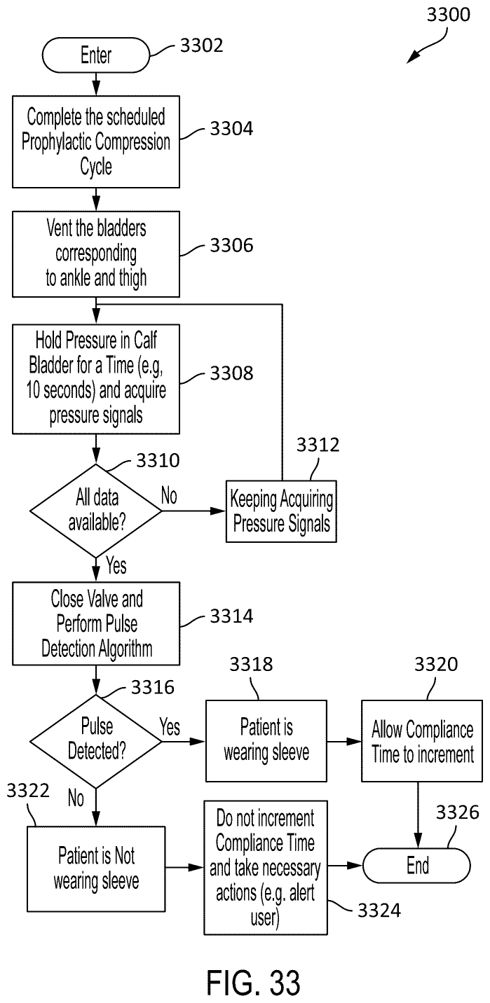

Referring to FIG. 33, the computer executable instructions embodied on the computer readable storage medium 33 cause the one or more processors 7 to execute a method 3300 of analyzing waveform data received from the pressure sensor 27 to determine whether the compression garment is in the wrapped or unwrapped configuration following the end of a cycle pressure. The method 3300 begins at step 3302 and proceeds to step 3304, where the computer executable instructions cause the one or more processors 7 to complete a prophylactic compression cycle. At step 3306, the computer executable instructions cause the one or more processors 7 to vent the bladders corresponding to the ankle and thigh of the wearer (e.g., bladders 13a and 13c). At step 3308, the computer executable instructions cause the one or more processors 7 to hold the pressure in the bladder corresponding to the calf of the wearer (e.g., bladder 13b) for a predetermined period of time (e.g., 10 seconds) and acquire pressure signals via the pressure sensor 27.

At step 3310, the computer executable instructions cause the one or more processors 7 to determine whether all of the data is available. If all of the data is not available at step 3310, then the method proceeds to step 3312 to continue acquiring pressure signals from the pressure sensor 27 before continuing back to step 3308. If all of the data is available at step 3310, then the method proceeds to step 3314 where the computer executable instructions cause the one or more processors 7 to perform the pulse detection algorithm. In some aspects, the pulse detection algorithm includes one or more steps of the post-process waveform analysis 3104 described above. At step 3316, the computer executable instructions cause the one or more processors 7 to determine whether a pulse is detected at step 3314. The lack of detection of a pulse is indicative of the compression garment 10 being in an unwrapped configuration away from a limb of the wearer at step 3322. The method then proceeds to step 3324, where the computer executable instructions cause the one or more processors 7 to not increment a compliance time and cause the one or more processors 7 to take one or more actions (e.g., alert the user) before ending the method at step 3326. The detection of a pulse at step 3316 is indicative of the compression garment 10 being in a wrapped configuration around a limb of the wearer at step 3318. The method then proceeds to step 3320, where the computer executable instructions cause the one or more processors 7 to increment a compliance time before ending the method at step 3326.

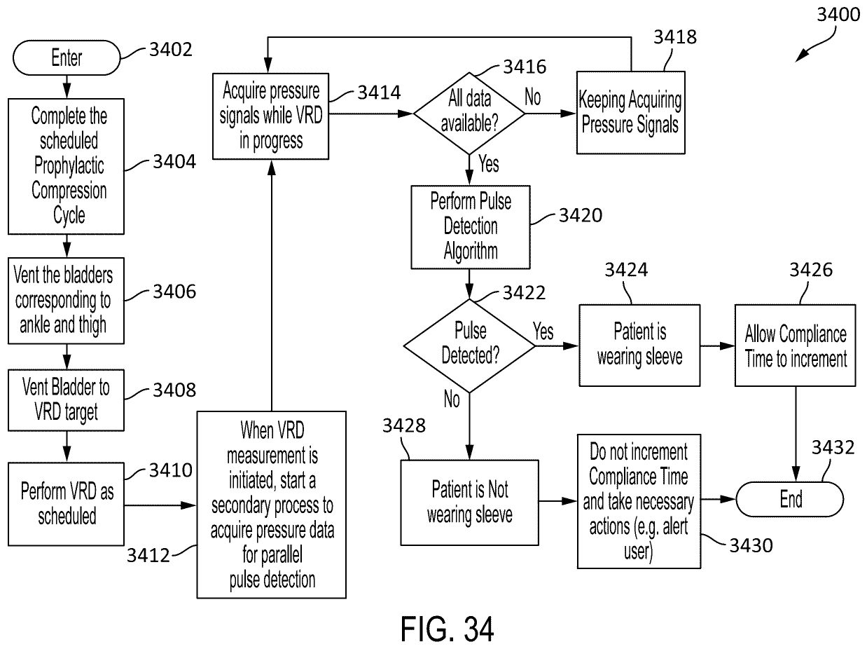

Referring to FIG. 34, the computer executable instructions embodied on the computer readable storage medium 33 cause the one or more processors 7 to execute a method 3400 of analyzing waveform data received from the pressure sensor 27 to determine whether the compression garment is in the wrapped or unwrapped configuration during a Venous Refill Determination (VRD). The method 3400 begins at step 3402 and proceeds to step 3404, where the computer executable instructions cause the one or more processors 7 to complete a compression cycle or a prophylactic compression cycle. At step 3406, the computer executable instructions cause the one or more processors 7 to vent the bladders corresponding to the ankle and thigh and of the wearer (e.g., bladders 13a and 13c). At step 3408, the computer executable instructions cause the one or more processors 7 to vent the pressure in the bladder corresponding to the calf of the wearer (e.g., bladder 13b) to a VRD target. Alternatively, the computer executable instructions cause the one or more processors 7 to vent the bladders corresponding to the ankle and thigh of the wearer (e.g., bladders 13a and 13c) and then inflate the ankle and thigh bladders to the VRD target. At step 3410, the computer executable instructions cause the one or more processors 7 to perform VRD as scheduled. Once the VRD measurement is initiated, the computer executable instructions cause the one or more processors 7 to start a secondary process to acquire pressure data from the pressure sensor 27 for parallel pulse detection. At step 3414, the computer executable instructions cause the one or more processors 7 to acquire pressure signals from the pressure sensor 27 while VRD is in progress.

At step 3416, the computer executable instructions cause the one or more processors 7 to determine whether all of the data is available. If all of the data is not available at step 3416, then the method proceeds to step 3418 to continue acquiring pressure signals from the pressure sensor 27 before continuing back to step 3414. If all of the data is available at step 3416, then the method proceeds to step 3420 where the computer executable instructions cause the one or more processors 7 to perform the pulse detection algorithm. In some aspects, the pulse detection algorithm includes one or more steps of the post-process waveform analysis described above. At step 3422, the computer executable instructions cause the one or more processors 7 to determine whether a pulse is detected at step 3420. The lack of detection of a pulse is indicative of the compression garment 10 being in an unwrapped configuration away from a limb of the wearer at step 3428. The method then proceeds to step 3430, where the computer executable instructions cause the one or more processors 7 to not increment a compliance time and cause the one or more processors 7 to take one or more actions (e.g., alert the user) before ending the method at step 3432. The detection of a pulse at step 3422 is indicative of the compression garment 10 being in a wrapped configuration around a limb of the wearer at step 3424. The method then proceeds to step 3426, where the computer executable instructions cause the one or more processors 7 to increment a compliance time before ending the method at step 3432.

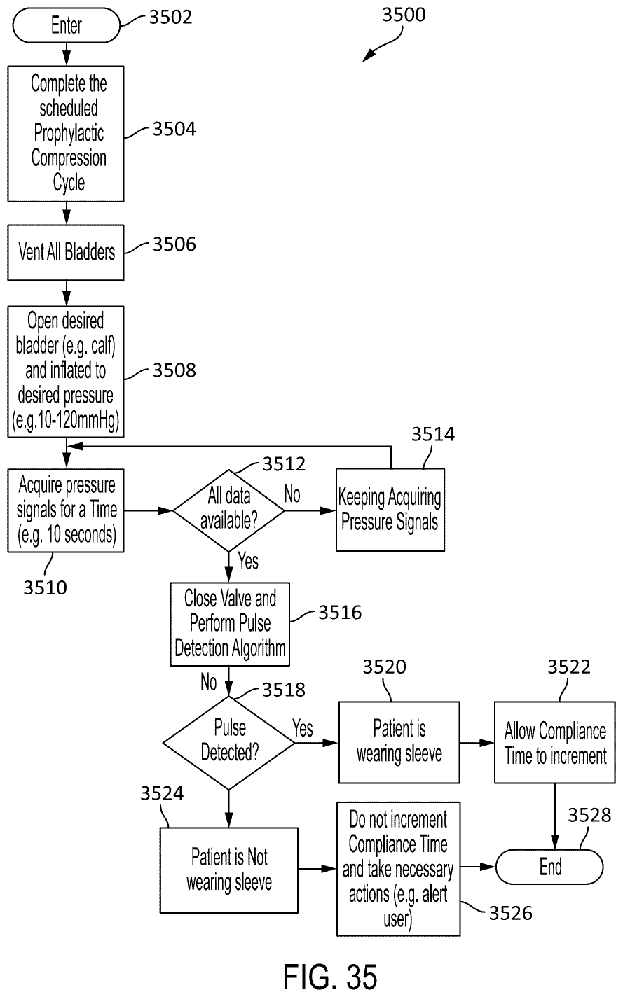

Referring to FIG. 35, the computer executable instructions embodied on the computer readable storage medium 33 cause the one or more processors 7 to execute a method 3500 of analyzing waveform data received from the pressure sensor 27 to determine whether the compression garment is in the wrapped or unwrapped configuration as an independent cycle. The method 3500 begins at step 3502 and proceeds to step 3504, where the computer executable instructions cause the one or more processors 7 to complete a prophylactic compression cycle. At step 3506, the computer executable instructions cause the one or more processors 7 to vent bladders 13a, 13b, 13c. At step 3508, the computer executable instructions cause the one or more processors 7 to open a desired valve (e.g., valve 25 b) and inflate a desired bladder (e.g., bladder 13b) to a desired pressure (e.g., 10-120 mmHg). At step 3510, the computer executable instructions cause the one or more processors 7 to acquire pressure signals via the pressure sensor 27 for a predetermined period of time (e.g., 10 seconds).

At step 3512, the computer executable instructions cause the one or more processors 7 to determine whether all of the data is available. If all of the data is not available at step 3512, then the method proceeds to step 3514 to continue acquiring pressure signals from the pressure sensor 27 before continuing back to step 3510. If all of the data is available at step 3512, then the method proceeds to step 3516 where the computer executable instructions cause the one or more processors 7 to close the corresponding valve (e.g., 25 b) and perform the pulse detection algorithm. In some aspects, the pulse detection algorithm includes one or more steps of the post-process waveform analysis 804 described above. At step 3518, the computer executable instructions cause the one or more processors 7 to determine whether a pulse is detected at step 3516. The lack of detection of a pulse is indicative of the compression garment 10 being in an unwrapped configuration away from a limb of the wearer at step 3524. The method then proceeds to step 3526, where the computer executable instructions cause the one or more processors 7 to not increment a compliance time and cause the one or more processors 7 to take one or more actions (e.g., alert the user) before ending the method at step 3528. The detection of a pulse at step 3518 is indicative of the compression garment 10 being in a wrapped configuration around a limb of the wearer at step 3520. The method then proceeds to step 3522, where the computer executable instructions cause the one or more processors 7 to increment a compliance time before ending the method at step 3528.

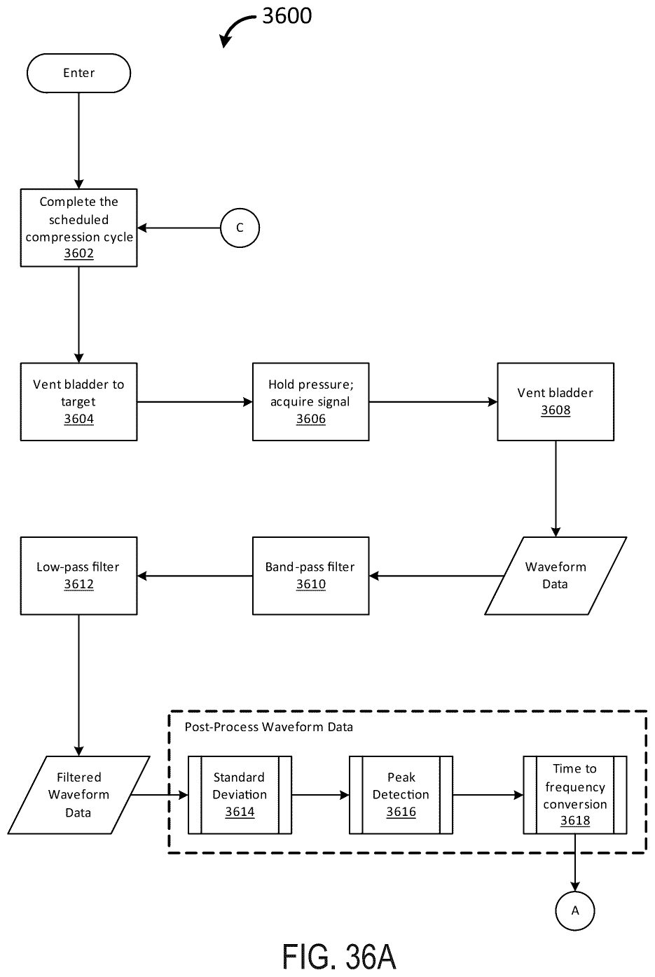

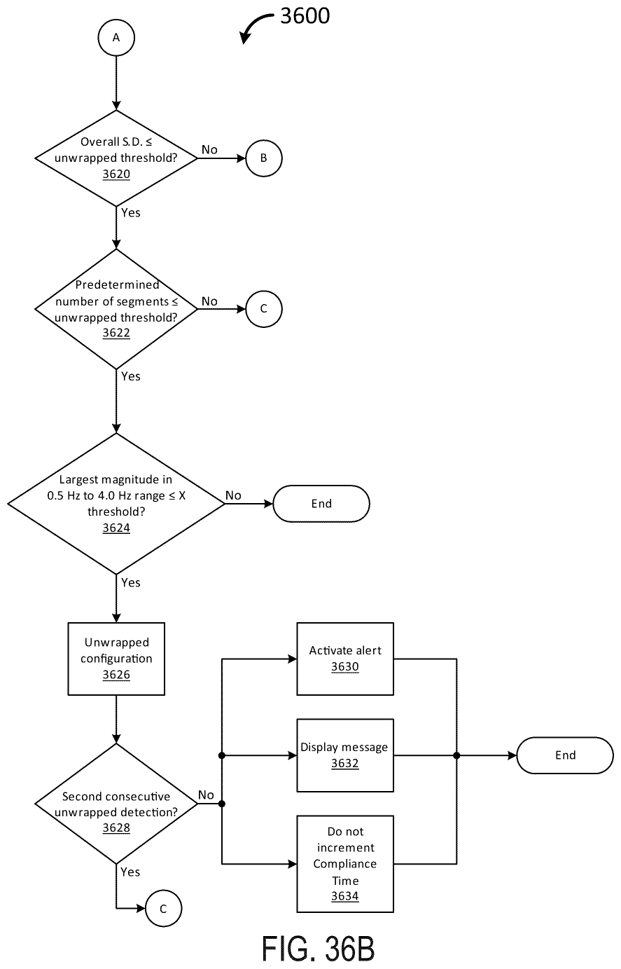

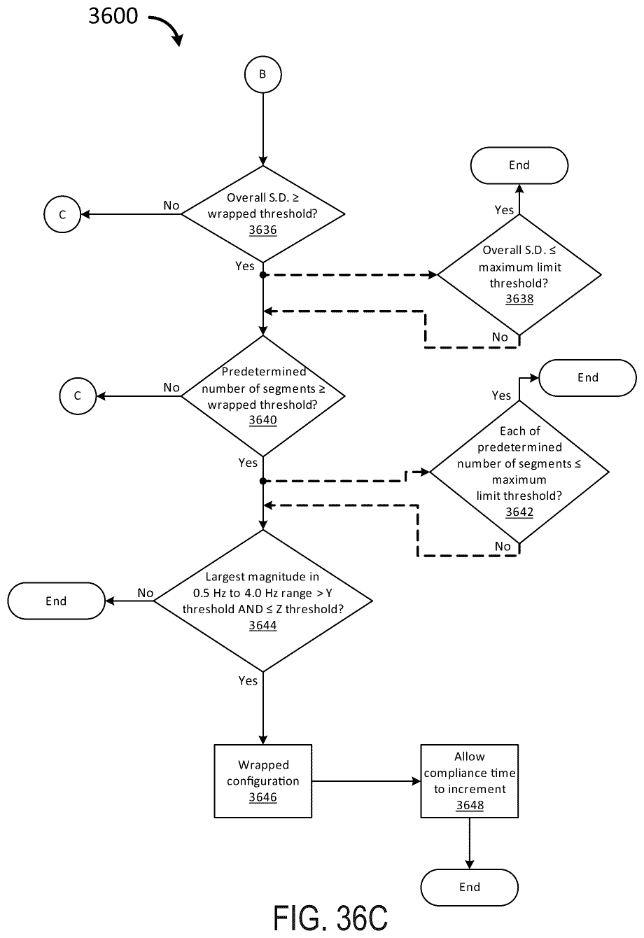

FIGS. 36A-C are a schematic representation of an exemplary method 3600 of analyzing waveform data received from the pressure sensor 27 to determine whether the compression garment 10 is in the wrapped or unwrapped configuration around a limb of a wearer of the garment by detecting pulsations associated with the heartbeat of the wearer. This exemplary method can be carried out by the one or more processors 7 through execution of computer executable instructions embodied on the non-transitory, computer readable storage medium 33.

The method 3600 begins and proceeds to step 3602, where the computer executable instructions cause the one or more processors 7 to complete a compression cycle or prophylactic compression cycle. At step 3604, the computer executable instructions cause the one or more processors 7 to vent the bladders corresponding to, for instance, the ankle and thigh of the wearer (e.g., bladders 13a and 13c) and to vent the bladder corresponding to, for instance, the calf of the wearer (e.g., bladder 13b) until a target pressure is achieved. In an aspect, the target pressure comprises an initial lower target pressure of about 5 to about 7 mmHg. Alternatively, the target pressure comprises about 26 to about 32 mmHg when the initial lower target pressure does not produce the expected result. The initial lower target pressure provides an exemplary benefit of exerting less pressure against the limb of the wearer, which is more comfortable for the patient relative to higher pressures, before re-trying at the higher target pressure, which is less comfortable for the patient.

At step 3606, upon reaching the target pressure, the computer executable instructions cause the one or more processors 7 to retain the pressure in the bladder corresponding to the calf of the wearer (e.g., bladder 13b) while the signal is acquired at a rate of about 100 Hz for a period of at least about 15 seconds. In an aspect, the period comprises pressure hold period 2804, as further described herein. A hold period of longer than about 15 seconds may also be utilized without departing from the scope of the invention. At step 3608, the computer executable instructions cause the one or more processors 7 to vent the pressure in the bladder corresponding to the calf of the wearer (e.g., bladder 13b).

Following the venting of the measurement bladder (e.g., bladder 13b), the computer executable instructions cause the one or more processors 7 to perform further signal conditioning which prepares the data for the patient detection algorithm. As shown in FIG. 36A, the computer executable instructions cause the one or more processors 7 to band-pass filter 3610 the waveform data. In an aspect, the most recent 1024 acquired samples, which correspond to a time window of about 10 seconds, are passed through band-pass filter 3610 having a pass-band of about 0.5-5 Hz to isolate the signals reflective of a cardiac cycle of the wearer. In an aspect, the first three samples of the 1024 acquired samples are disregarded as a settle time period. It will be understood by one of ordinary skill in the art that other amounts of most recent acquired samples may be utilized without departing from the scope of the invention. For example, any number of most recent acquired samples being a power of two aids in frequency calculation.

The computer executable instructions cause the one or more processors 7 to pass the output of the band-pass filter 3610 through a low-pass filter 3612 having a low pass cutoff frequency of about 5 Hz. In an aspect, low-pass filter 3612 further removes noise in the waveform data and reveals pulsations associated with the circulatory system of the lower limb of the wearer. Referring to FIG. 36, an exemplary signal from the output of low-pass filter 3612 is shown. In this aspect, the signal includes about 1024 samples having crisp pulsations associated with the circulatory system of the lower limb of the wearer.

With the filtered waveform data available, the computer executable instructions cause the one or more processor 7 to perform several subsequent calculations on the filtered waveform data to determine whether the compression garment 10 is in the wrapped or unwrapped configuration around a limb of a wearer of the garment. In an aspect, the subsequent calculations are referred to as post-processing of the filtered waveform.

Referring again to FIG. 36A, the computer executable instructions cause the one or more processors 7 to perform post-processing of the filtered waveform at 3614, 3616, and 3618. As shown, one or more processors 7 calculate the standard deviation of the filtered waveform data and/or portions thereof. It is empirically known that a compression garment in an unwrapped configuration (i.e., idle) has a stable, flat pressure signal including only normal white noise. In contrast, a pressure signal representative of a pressure in a compression garment in a wrapped configuration around a limb of a wearer of the garment includes pulsations and/or other measurable signal characteristics. Therefore, it is possible to distinguish a compression garment in a wrapped configuration around a limb of a wearer from a compression garment in an unwrapped configuration based, in whole or in part, on this calculation.

In an aspect, the computer executable instructions cause the one or more processors 7 to divide the low-pass filtered signal (e.g., 1024 samples) into five sample groups and calculate the standard deviation 3614 (σ) for each group. It will be understood by one of ordinary skill in the art that the low-pass filtered signal may be divided into a different number of samples groups, such as when a different number of samples are used for example. An exemplary purpose of dividing the low-pass filtered signal into sample groups is to isolate portions of time. For example, it is known that large anomalous pressure spikes (e.g., due to wearer sneezing, coughing, and the like) in a representative pressure signal occur during normal treatment due to movement of the limb of the wearer and/or other factors. Time-slicing of the signal (e.g., dividing the signal into sample groups) allows the one or more processors 7 to determine if the entire waveform is “steady” or if there is an anomaly within a particular range of the sample. In an aspect, the computer executable instructions cause the one or more processors 7 to calculate the total standard deviation 3614 (σ) for the entire low-pass filtered signal (e.g., 1024 samples).

After calculating the standard deviation, the computer executable instructions cause the one or more processors 7 to perform peak detection 3616. In an aspect, the one or more processors 7 process the filtered waveform (e.g., 1024 samples) using a windowing technique comprising 32 samples per window. The one or more processors 7 index the peak from each 32-sample window one after the other to produce a down-sampled waveform comprising only the signal peaks (e.g., the signal of interest). For example, the one or more processors 7 may initially index each peak from 1 to 32 and then increment the index by one (e.g. from 2 to 33) as additional waveform signal data is generated. The one or more processors 7 ignore negative peaks. In an aspect, the 32-sample window leaves a local maximum for each window. Additionally and/or alternatively, the 32-sample window reduces the number of samples by one-quarter, removes negative peaks, and provides awareness that the down-sampled signal is representative of about 10 seconds of real time. Referring to FIG. 38, an exemplary signal from the output of peak detection 3616 is shown, including only the true peaks which ultimately reveal the pulsation of interest. In this aspect, the signal includes about 250 to 300 samples which still correspond to about 10 seconds of real time. In an aspect, the number of samples will vary depending on the number of peaks identified by the one or more processors 7. In the aspect illustrated in FIG. 25, the sampling frequency is calculated as the result of the number of samples divided by the amount of time (e.g., Sampling f=N samples/10.24 seconds).

Referring further to FIG. 36A, with the down-sampled peak detection waveform available, the one or more processors 7 utilize the fundamental frequency to assist in confirming if the compression garment 10 is in the wrapped configuration around a limb of a wearer of the garment by performing a time to frequency conversion 3618. In an aspect, the computer executable instructions cause the one or more processors 7 to compute a Fourier Transform (e.g., Fast Fourier Transform) of the signal and output the highest magnitude between 0.5 Hz (e.g., about 30 bpm) and 4 Hz (e.g., about 200 bpm). One having ordinary skill in the art will understand that transforms other than a Fast Fourier Transform may be used to discover a cardiac cycle of the wearer without departing from the scope of the invention.

After completing the post-processing, the computer executable instructions cause the one or more processors 7 to determine whether the compression garment 10 is in an unwrapped configuration or a wrapped configuration around a limb of a wearer of the garment. Referring to FIG. 36B, the computer executable instructions cause the one or more processors 7 to determine, at step 3620, whether the total standard deviation 3614 (σ) for the entire low-pass filtered signal (e.g., 1024 samples) is less than or equal to an unwrapped threshold (e.g., 0.18). When the one or more processors 7 determine the total standard deviation is not less than or equal to the unwrapped threshold, the method 3600 continues to step 3636 as further described herein. When the one or more processors 7 determine the total standard deviation is less than or equal to the unwrapped threshold, the method 3600 continues to step 3622.

At step 3622, the computer executable instructions cause the one or more processors 7 to determine whether a predetermined number of segments (e.g. sample groups) into which the low-pass filtered signal has been divided are each less than or equal to the unwrapped threshold (e.g., 0.18). In an alternative aspect, the one or more processors 7 divide the low-pass filtered signal into five sample groups and determine at 3622 whether the standard deviation of each of the five sample groups is less than or equal to the unwrapped threshold. Alternatively, the one or more processors 7 divide the low-pass filtered signal into five sample groups and determine at 3622 whether the standard deviation of at least three of the five sample groups is less than or equal to the unwrapped threshold. When the one or more processors 7 determine each of the predetermined number of segments is not less than or equal to the unwrapped threshold, the method 3600 continues back to step 3602 to re-try the cycle. When the one or more processors 7 determine each of the predetermined number of segments is less than or equal to the unwrapped threshold, the process continues to step 3624.

At step 3624, the computer executable instructions cause the one or more processors 7 to determine whether the largest (e.g., highest amplitude) magnitude in the 0.5-4.0 Hz range of the time to frequency transformed (e.g., Fast Fourier Transform) signal is less than or equal to a threshold X (e.g., 5 Hz). When the one or more processors 7 determine the largest magnitude in the 0.5-4.0 Hz range is not less than or equal to the threshold X, the method 3600 ends. When the processors 7 determine at 3624 the largest magnitude in the 0.5-4.0 Hz range is less than or equal to the threshold X, the one or more processors 7 determine at step 3626 that the compression garment 10 is in an unwrapped configuration. In an aspect, the computer executable instructions cause the one or more processors 7 to declare the compression garment 10 is in an unwrapped configuration (e.g., the wearer is not wearing the compression garment) when the Boolean result of step 3620 is logical true AND the result of step 3622 is logical true AND the result of step 3624 is logical true.

At step 3628, the computer executable instructions cause the one or more processors 7 to determine whether the unwrapped configuration detection at step 3626 is the second consecutive such determination. When the one or more processors 7 determine the unwrapped configuration detection 3626 is not the second consecutive detection, the method 3600 continues back to step 3602 to perform a second measurement on the next cycle for the corresponding limb of the wearer. When the one or more processors 7 determine the unwrapped configuration 3626 is the second consecutive detection, the method 3600 continues to at least one of three steps. At step 3630, the computer executable instructions cause the one or more processors 7 to activate an audible alert, such as via a speaker and/or other electromechanical devices that produce sound connected to controller 5 of compression system 1. In an aspect, the alert is a multi-toned audible alert. At step 3632, the computer executable instructions cause the one or more processors 7 to display an error message on a display device associated with the compression system 1. At step 3634, the computer executable instructions cause the one or more processors 7 to not increment a compliance time before ending the method 3600. In an aspect, therapy using compression garment 10 is not stopped by halting 3634 the compliance time and the compliance time remains in its current state until receiving a response via a display device and/or an input device (e.g. from a human user).

Referring to FIG. 36C, the computer executable instructions cause the one or more processors 7 to determine, at step 3636, whether the total standard deviation 3614 (σ) for the entire low-pass filtered signal (e.g., 1024 samples) is greater than or equal to a wrapped threshold (e.g., 0.35). When the one or more processors 7 determine the total standard deviation is not greater than or equal to the wrapped threshold, the method 3600 continues back to step 3602. When the one or more processors 7 determine the total standard deviation is greater than or equal to the wrapped threshold, the method 3600 continues to step 3638 and/or step 3640.

In an aspect, the method 3600 continues to step 3638 in which the computer executable instructions cause the one or more processors 7 to determine whether the total standard deviation 3614 (σ) for the entire low-pass filtered signal (e.g., 1024 samples) is less than or equal to a maximum limit threshold (e.g. 10.0). When the one or more processors 7 determine the total standard deviation for the entire low-pass filtered signal is not less than or equal to the maximum limit threshold, the method 3600 ends. When the one or more processors 7 determine the total standard deviation of the entire low-pass filtered signal is less than or equal to the maximum limit threshold, the method 3600 continues to step 3640.

At step 3640, the computer executable instructions cause the one or more processors 7 to determine whether a predetermined number of segments (e.g., sample groups) into which the low-pass filtered signal has been divided are each greater than or equal to the wrapped threshold (e.g., 0.35). In an aspect, the one or more processors 7 divide the low-pass filtered signal into five sample groups and determine 3640 whether the standard deviation of each of the five sample groups is greater than or equal to the wrapped threshold. Alternatively, the one or more processors 7 divide the low-pass filtered signal into five sample groups and determine 3640 whether the standard deviation of at least three of the five sample groups is greater than or equal to the wrapped threshold. When the one or more processors 7 determine each of the predetermined number of segments is not greater than or equal to the wrapped threshold, the method 3600 continues back to step 3602 to re-try the cycle. When the one or more processors 7 determine each of the predetermined number of segments is greater than or equal to the wrapped threshold, the process continues to step 3642 and/or step 3644.

At step 3642, the computer executable instructions cause the one or more processors 7 to determine whether each of a predetermined number of segments (e.g., sample groups) into which the low-pass filtered signal has been divided are each less than or equal to the maximum limit threshold (e.g., 10.0). When the one or more processors 7 determine the predetermined number of segments (e.g., all five or at least three out of five) is each not less than or equal to the maximum limit threshold, the method 3600 ends. When the one or more processors 7 determine the predetermined number of segments is each less than or equal to the maximum limit threshold, the method 3600 continues to step 3644.

At step 3644, the computer executable instructions cause the one or more processors 7 to determine whether the largest (e.g., highest amplitude) magnitude in the 0.5-4.0 Hz range of the time to frequency transformed (e.g., Fast Fourier Transform) signal is both greater than a threshold Y (e.g., 20) and less than or equal to a threshold Z (e.g., 50.0). When the one or more processors 7 determine the largest magnitude in the 0.5-4.0 Hz range is not both greater than the threshold Y and less than or equal to the threshold Z, the method 3600 ends. The one or more processors 7 determine the compression garment 10 is in a wrapped configuration 3646 around a limb of a wearer of the garment when the one or more processors 7 determine the largest magnitude in the 0.5-4.0 Hz range is both greater than the threshold Y and less than or equal to the threshold Z. In an aspect, the computer executable instructions cause the one or more processors 7 to declare the compression garment 10 is in a wrapped configuration (e.g., the wearer is wearing the compression garment) when the Boolean result of step 3636 is logical true AND the result of step 3638 is logical true AND the result of step 3640 is logical true AND the result of step 3642 is logical true AND the result of step 3644 is logical true. Alternatively, the computer executable instructions cause the one or more processors 7 to declare the compression garment 10 is in a wrapped configuration when the Boolean result of step 3636 is logical true AND the result of step 3640 is logical true AND the result of step 3644 is logical true.

After determining the compression garment 10 is in the wrapped configuration 3646, the method 3600 continues to step 3648 in which the computer executable instructions cause the one or more processors 7 to increment a compliance time before ending the method 3600.

FIGS. 39A-C are a schematic representation of a second exemplary method 3900 of analyzing waveform data received from the pressure sensor 27 to determine whether the compression garment 10 is in the wrapped or unwrapped configuration around a limb of a wearer of the compression garment 10 by detecting pulsations associated with the heartbeat of the wearer in accordance with an aspect of the present invention. This exemplary method can be carried out by the one or more processors 7 through execution of computer executable instructions embodied on the non-transitory, computer readable storage medium 33. The method 3900 occurs during VRD (starting at step 3904) and is a more detailed flowchart of FIG. 34.

The method 3900 begins and proceeds to step 3902, where the computer executable instructions cause the one or more processors 7 to complete a compression cycle or a prophylactic compression cycle. At step 3904, the computer executable instructions cause the one or more processors 7 to vent the bladders corresponding to, for instance, the ankle and thigh of the wearer (e.g., bladders 13a and 13c) and to vent the bladder corresponding to, for instance, the calf of the wearer (e.g., bladder 13b) until a target pressure is achieved. Alternatively, the computer executable instructions cause the one or more processors 7 to vent the bladders corresponding to, for instance, the ankle and thigh of the wearer (e.g., bladders 13a and 13c) and to vent the bladder corresponding to, for instance, the calf of the wearer (e.g., bladder 13b) and then inflate the bladder corresponding to, for instance the calf of the wearer (e.g., bladder 13b) until a target pressure is achieved. In an aspect, the target pressure comprises an initial lower target pressure of about 5 to about 7 mmHg. Alternatively, the target pressure comprises about 26 to about 32 mmHg when the initial lower target pressure does not produce the expected result. The initial lower target pressure provides an exemplary benefit of exerting less pressure against the limb of the wearer, which is more comfortable for the patient relative to higher pressures, before re-trying at the higher target pressure, which is less comfortable for the patient.

At step 3906, upon reaching the target pressure, the computer executable instructions cause the one or more processors 7 to retain/hold the pressure in the bladder corresponding to the calf of the wearer (e.g., bladder 13b) while the signal is acquired at a rate of about 100 Hz for a period of at least about 15 seconds. In an aspect, the period comprises pressure hold period 2804, as further described herein. A hold period of longer than about 15 seconds may also be utilized without departing from the scope of the invention. For example, the at least one inflatable bladder can be vented to a target value, held at the pressure and acquire signals. Thus, the signals can be received to determine if the target value is reached e.g., during deflation. Similarly, if the at least one inflatable bladder is vented and then inflated to the target value, the signals can be received during inflation. The signals can be received while the at least one bladder is held at the target value/pressure, e.g., during inflation—the at least one bladder is inflated.

During the acquiring of the signals, waveform data is acquired, e.g., in real time, from the measurement bladder (e.g., bladder 13b), the computer executable instructions cause the one or more processors 7 to perform further signal conditioning which prepares the data for the patient detection algorithm. As shown in FIG. 39A, at step 3908, the computer executable instructions cause the one or more processors 7 to band-pass filter the waveform data. In an aspect, the most recent 1024 acquired samples, which correspond to a time window of about 10 seconds, are passed through band-pass filter 3908 having a pass-band of about 0.5-5 Hz to isolate the signals reflective of a cardiac cycle of the wearer. In an aspect, the first three samples of the 1024 acquired samples are disregarded as a settle time period. It will be understood by one of ordinary skill in the art that other amounts of most recent acquired samples may be utilized without departing from the scope of the invention. For example, any number of most recent acquired samples being a power of two aids in frequency calculation.

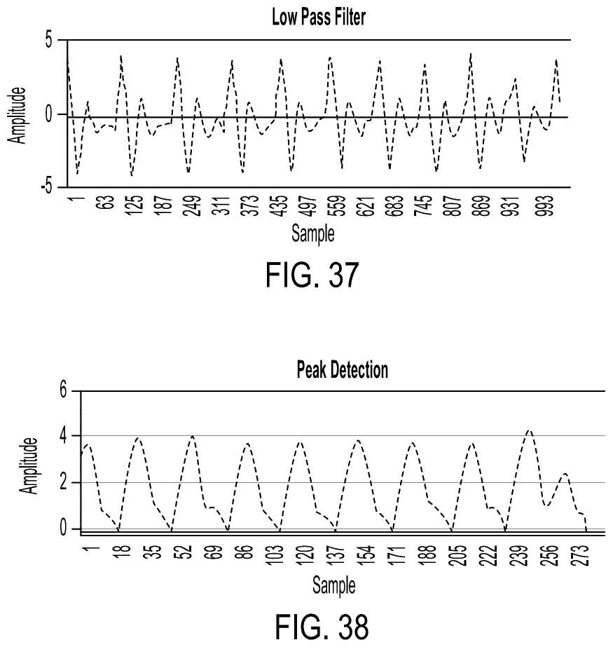

At step 3910, the computer executable instructions cause the one or more processors 7 to pass the output of the band-pass filter through a low-pass filter having a low pass cutoff frequency of about 5 Hz. In an aspect, low-pass filter 3910 further removes noise in the waveform data and reveals pulsations associated with the circulatory system of the lower limb of the wearer. Referring to FIG. 37, an exemplary signal from the output of low-pass filter is shown. In this aspect, the signal includes about 1024 samples having crisp pulsations associated with the circulatory system of the lower limb of the wearer.

With the filtered waveform data available, the computer executable instructions cause the one or more processor 7 to perform several subsequent calculations on the filtered waveform data to determine whether the compression garment 10 is in the wrapped or unwrapped configuration around a limb of a wearer of the garment. In an aspect, the subsequent calculations are referred to as post-processing of the filtered waveform. In an aspect, the method 3900 maintains the last 1024 samples as the Patient Detected (PD) filtered data set for further calculations as described below.

Referring again to FIG. 39A, at step 3912, the computer executable instructions cause the one or more processors 7 to vent the pressure in the bladder corresponding to the calf of the wearer (e.g., bladder 13b) to an ambient value, e.g., release the pressure in the bladder. Next, at steps 3914, 3916 and 3918, the computer executable instructions cause the one or more processors to perform post-processing of the filtered waveform. As shown, one or more processors 7 calculate the standard deviation of the filtered waveform data and/or portions thereof. It is empirically known that a compression garment in an unwrapped configuration (i.e., idle) has a stable, flat pressure signal including only normal white noise. In contrast, a pressure signal representative of a pressure in a compression garment in a wrapped configuration around a limb of a wearer of the garment includes pulsations and/or other measurable signal characteristics. Therefore, it is possible to distinguish a compression garment in a wrapped configuration around a limb of a wearer from a compression garment in an unwrapped configuration based, in whole or in part, on this calculation.

At step 3914, the computer executable instructions cause the one or more processors 7 to calculate standard deviation(s) (σ). For example, the computer executable instructions cause the one or more processors 7 to divide the low-pass filtered signal (e.g., 1024 samples/PD filtered data set) into five sample groups and calculate the standard deviation 3914 (σ) for each group. For example, four groups include 200 samples of the PD filtered data set and one group includes 224 samples of the PD filtered data set. These groups can be referred to as s1-s5. Thus, five standard deviations are calculated (e.g., a standard deviation for each group s1-s5). It will be understood by one of ordinary skill in the art that the low-pass filtered signal may be divided into a different number of samples groups, such as when a different number of samples are used for example. An exemplary purpose of dividing the low-pass filtered signal into sample groups is to isolate portions of time. For example, it is known that large anomalous pressure spikes (e.g., due to wearer sneezing, coughing, and the like) in a representative pressure signal occur during normal treatment due to movement of the limb of the wearer and/or other factors. Time-slicing of the signal (e.g., dividing the signal into sample groups) allows the one or more processors 7 to determine if the entire waveform is “steady” or if there is an anomaly within a particular range of the sample. For example, the computer executable instructions cause the one or more processors 7 to calculate the total standard deviation 3914 (σ) for the entire low-pass filtered signal (e.g., 1024 samples/PD filtered data set) which can be referred to as “s”.

At step 3916, the computer executable instructions cause the one or more processors 7 to perform peak detection. For example, the one or more processors 7 process the filtered waveform (e.g., 1024 samples) using a windowing technique comprising 32 samples per window. The one or more processors 7 index the peak from each 32-sample window one after the other to produce a down-sampled waveform comprising only the signal peaks (e.g., the signal of interest). For example, the one or more processors 7 may initially index each peak from 1 to 32 and then increment the index by one (e.g. from 2 to 33) as additional waveform signal data is generated. The one or more processors 7 ignore negative peaks. In an aspect, the 32-sample window leaves a local maximum for each window. Additionally and/or alternatively, the 32-sample window reduces the number of samples by one-quarter, removes negative peaks, and provides awareness that the down-sampled signal is representative of about 10 seconds of real time. Referring to FIG. 38, an exemplary signal from the output of peak detection 3916 is shown, including only the true peaks which ultimately reveal the pulsation of interest. In this aspect, the signal includes about 250 to 300 samples which still correspond to about 10 seconds of real time. In an aspect, the number of samples will vary depending on the number of peaks identified by the one or more processors 7. In the aspect illustrated in FIG. 25, the sampling frequency is calculated as the result of the number of samples divided by the amount of time (e.g., Sampling f=N samples/10.24 seconds).

Referring further to FIG. 39A, with the down-sampled peak detection waveform available, the one or more processors 7 utilize the fundamental frequency to assist in confirming if the compression garment 10 is in the wrapped configuration around a limb of a wearer of the garment by performing a time to frequency conversion 3918. At step 3918, the computer executable instructions cause the one or more processors 7 to compute a Fourier Transform (e.g., Fast Fourier Transform or FFT) of the signal/PF filtered data set and output the highest magnitude between 0.5 Hz (e.g., about 30 bpm) and 4 Hz (e.g., about 200 bpm). One having ordinary skill in the art will understand that transforms other than a Fast Fourier Transform may be used to discover a cardiac cycle of the wearer without departing from the scope of the invention.

After completing the post-processing, the computer executable instructions cause the one or more processors 7 to determine whether the compression garment 10 is in an unwrapped configuration or a wrapped configuration around a limb of a wearer of the garment. Referring to FIG. 39B, the computer executable instructions cause the one or more processors 7 to determine, at step 3920, whether the total standard deviation 3914 (σ) and overall standard deviation for the entire low-pass filtered signal (e.g., 1024 samples/PD filtered data set) (also referred to as group s) is less than or equal to an unwrapped threshold (e.g., 0.18). When the one or more processors 7 determine the total standard deviation is not less than or equal to the unwrapped threshold, the method 3900 continues to step 3934 as further described herein. When the one or more processors 7 determine the total standard deviation is less than or equal to the unwrapped threshold, the method 3900 continues to step 3922.

At step 3922, the computer executable instructions cause the one or more processors 7 to determine whether a standard deviation (S.D.) of predetermined number of segments (e.g. sample groups s1-s5) into which the low-pass filtered signal has been divided are each less than or equal to the unwrapped threshold (e.g., 0.18). In an alternative aspect, the one or more processors 7 divide the low-pass filtered signal into five sample groups and determine at 3922 whether the standard deviation of each of the five sample groups is less than or equal to the unwrapped threshold. Alternatively, the one or more processors 7 divide the low-pass filtered signal into five sample groups and determine at 3922 whether the standard deviation of at least three of the five sample groups is less than or equal to the unwrapped threshold. When the one or more processors 7 determine each of the predetermined number of segments is not less than or equal to the unwrapped threshold, the method 3900 continues to step 3944 to determine whether to re-try the cycle. When the one or more processors 7 determine each of the predetermined number of segments is less than or equal to the unwrapped threshold, the process continues to step 3924.

At step 3924, using the low-pass filtered signal (e.g., 1024 samples/PD filtered data set), the computer executable instructions cause the one or more processors 7 to determine whether the largest (e.g., highest amplitude) magnitude in the 0.5-4.0 Hz range of the time to frequency transformed (e.g., Fast Fourier Transform) signal is less than or equal to a threshold X (e.g., 5). When the one or more processors 7 determine the largest magnitude in the 0.5-4.0 Hz range is not less than or equal to the threshold X, the method 3900 continues to step 3944 to determine whether to re-try the cycle. When the processors 7 determine at 3924 the largest magnitude in the 0.5-4.0 Hz range is less than or equal to the threshold X, the one or more processors 7 determine at step 3926 that the compression garment 10 is in an unwrapped configuration. In an aspect, the computer executable instructions cause the one or more processors 7 to declare the compression garment 10 is in an unwrapped configuration (e.g., the wearer is not wearing the compression garment) when the Boolean result of step 3920 is logical true AND the result of step 3922 is logical true AND the result of step 3924 is logical true.

At step 3926, the computer executable instructions cause the one or more processors 7 to determine that the compression garment is unwrapped, e.g., not wrapped around the wearer's limb.

At step 3928, the computer executable instructions cause the one or more processors 7 to activate an audible alert, such as via a speaker and/or other electromechanical devices that produce sound connected to controller 5 of compression system 1. In an aspect, the alert is a multi-toned audible alert. At step 3930, the computer executable instructions cause the one or more processors 7 to display an error message on a display device associated with the compression system 1. At step 3932, the computer executable instructions cause the one or more processors 7 to not increment a compliance time before ending the method 3900. In an aspect, therapy using compression garment 10 is not stopped by halting 3932 the compliance time and the compliance time remains in its current state until receiving a response via a display device and/or an input device (e.g. from a human user).

Referring to FIG. 39C, at step 3934, the computer executable instructions cause the one or more processors 7 to determines whether the total/overall standard deviation 3914 (σ) for the entire low-pass filtered signal (e.g., 1024 samples/PD filtered data set) is greater than or equal to a wrapped threshold (e.g., 0.25). When the one or more processors 7 determine the total standard deviation is not greater than or equal to the wrapped threshold, the method 3900 continues to step 3944 to determine whether to re-try the cycle. When the one or more processors 7 determine the total standard deviation is greater than or equal to the wrapped threshold, the method 3900 continues to step 3936.

At step 3936, the computer executable instructions cause the one or more processors 7 to determine whether a standard deviation (S.D.) of a predetermined number of segments (e.g., sample groups s1-s5) into which the low-pass filtered signal has been divided are each greater than or equal to the wrapped threshold (e.g., 0.25). In an aspect, the one or more processors 7 determine 3936 whether the standard deviation of each of the five sample groups is greater than or equal to the wrapped threshold. Alternatively, the one or more processors 7 divide the low-pass filtered signal into five sample groups and determine whether the standard deviation of at least three of the five sample groups is greater than or equal to the wrapped threshold. When the one or more processors 7 determine each of the predetermined number of segments is not greater than or equal to the wrapped threshold, the method 3900 continues to step 3944 to determine whether to re-try the cycle. When the one or more processors 7 determine each of the predetermined number of segments is greater than or equal to the wrapped threshold, the method 3900 continues to step 3938.

At step 3938, the computer executable instructions cause the one or more processors 7 to determine whether the largest (e.g., highest amplitude) magnitude in the 0.5-4.0 Hz range of the time to frequency transformed (e.g., Fast Fourier Transform (FFT)) signal is greater than a threshold Y (e.g., 5). When the one or more processors 7 determine the largest magnitude in the 0.5-4.0 Hz range is not greater than the threshold Y, the method 3900 continues to step 3944 to determine whether to re-try the cycle. When the one or more processors 7 determine the largest magnitude in the 0.5-4.0 Hz range is greater than the threshold Y, the one or more processors 7 determine the compression garment 10 is in a wrapped configuration 3940 around a limb of a wearer of the garment. The computer executable instructions cause the one or more processors 7 to declare the compression garment 10 is in a wrapped configuration when the Boolean result of step 3934 is logical true AND the result of step 3936 is logical true AND the result of step 3938 is logical true.

After determining the compression garment 10 is in the wrapped configuration 3940, the method 3900 continues to step 3942 in which the computer executable instructions cause the one or more processors 7 to increment a compliance time before ending the method 3900.

At step 3944, the one or more processors 7 determine if any one of the three criteria: 1) overall S.D.; 2) S.D. of the segments; or FFT max is indeterminate for the first time. If the one or more processors 7 determine that any one of three criteria indeterminate for the first time, the method 3900 proceeds to step 3902. If the one or more processors 7 determine that any one of three criteria: 1) overall S.D.; 2) S.D. of the segments; or FFT max is indeterminate for a second time, the one or more processors 7 determine that the compression garment is unwrapped, e.g., not wrapped around the wearer's limb and the method 3900 proceeds to step 3926. Indeterminate refers to the inability to determine if the compression garment 10 is in a wrapped configuration or unwrapped configuration.

While certain aspects have been described, other aspects are additionally or alternatively possible.

While compression systems have been described as being used with thigh length compression sleeves, it should be understood that the compression systems can additionally or alternatively be used with other types of compression garments. For example, the compression systems can be used with knee-length compression sleeves and/or with sleeves having a different number of bladders configured to be disposed over different areas of the wearer's body.

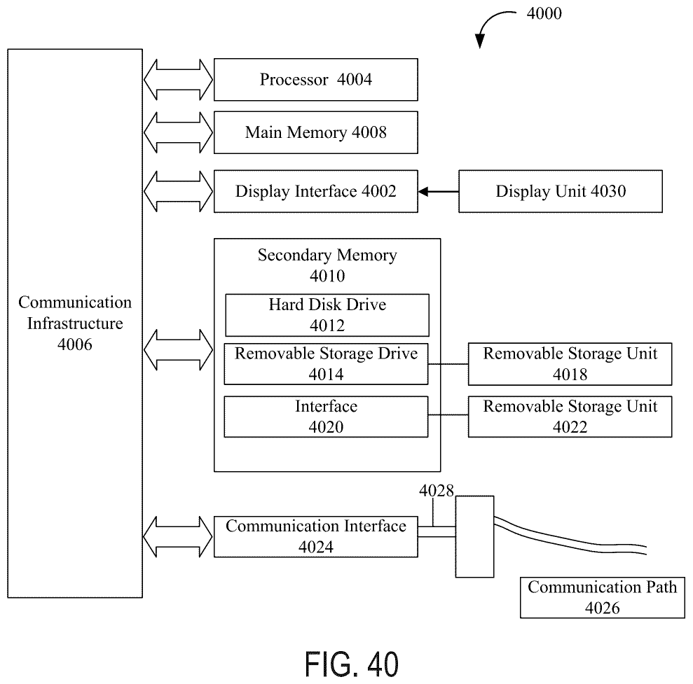

Aspects of the present disclosure may be implemented using hardware, software, or a combination thereof and can be implemented in one or more computer systems or other processing systems. In one aspect, the disclosure is directed toward one or more computer systems capable of carrying out the functionality described herein. An example of such a computer system 4000 is shown in FIG. 40.

FIG. 40 presents an example system diagram of various hardware components and other features, for use in accordance with an aspect of the present disclosure. Aspects of the present disclosure can be implemented using hardware, software, or a combination thereof and can be implemented in one or more computer systems or other processing systems. In one example variation, aspects described herein can be directed toward one or more computer systems capable of carrying out the functionality described herein. An example of such a computer system 4000 is shown in FIG. 40.

Computer system 4000 includes one or more processors, such as processor 4004. The processor 4004 is connected to a communication infrastructure 4006 (e.g., a communications bus, cross-over bar, or network). In one example, processor 7 in FIGS. 1-2, described above, can include processor 4004. Various software aspects are described in terms of this example computer system. After reading this description, it will become apparent to a person skilled in the relevant art(s) how to implement aspects described herein using other computer systems and/or architectures.

Computer system 4000 can include a display interface 4002 that forwards graphics, text, and other data from the communication infrastructure 4006 (or from a frame buffer not shown) for display on a display unit 4030. Computer system 4000 also includes a main memory 4008, preferably random access memory (RAM), and can also include a secondary memory 4010. The secondary memory 4010 can include, for example, a hard disk drive 4012 and/or a removable storage drive 4014, representing a floppy disk drive, a magnetic tape drive, an optical disk drive, etc. The removable storage drive 4014 reads from and/or writes to a removable storage unit 4018 in a well-known manner. Removable storage unit 4018, represents a floppy disk, magnetic tape, optical disk, etc., which is read by and written to removable storage drive 4014. As will be appreciated, the removable storage unit 4018 includes a computer usable storage medium having stored therein computer software and/or data.

In alternative aspects, secondary memory 4010 can include other similar devices for allowing computer programs or other instructions to be loaded into computer system 4000. Such devices can include, for example, a removable storage unit 4022 and an interface 4020. Examples of such can include a program cartridge and cartridge interface (such as that found in video game devices), a removable memory chip (such as an erasable programmable read only memory (EPROM), or programmable read only memory (PROM)) and associated socket, and other removable storage units 4022 and interfaces 4020, which allow software and data to be transferred from the removable storage unit 4022 to computer system 4000.

Computer system 4000 can also include a communications interface 4024. Communications interface 4024 allows software and data to be transferred between computer system 4000 and external devices. Examples of communications interface 4024 can include a modem, a network interface (such as an Ethernet card), a communications port, a Personal Computer Memory Card International Association (PCMCIA) slot and card, etc. Software and data transferred via communications interface 4024 are in the form of signals 4028, which can be electronic, electromagnetic, optical or other signals capable of being received by communications interface 4024. These signals 4028 are provided to communications interface 4024 via a communications path (e.g., channel) 4026. This communication path 4026 carries signals 4028 and can be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 4080, a hard disk installed in hard disk drive 4070, and signals 4028. These computer program products provide software to the computer system 400. Aspects described herein can be directed to such computer program products.

Computer programs (also referred to as computer control logic) are stored in main memory 4008 and/or secondary memory 4010. Computer programs can also be received via communications interface 4024. Such computer programs, when executed, enable the computer system 4000 to perform various features in accordance with aspects described herein. In particular, the computer programs, when executed, enable the processor 4004 to perform such features. Accordingly, such computer programs represent controllers of the computer system 4000.

In variations where aspects described herein are implemented using software, the software can be stored in a computer program product and loaded into computer system 4000 using removable storage drive 4014, hard disk drive 4012, or communications interface 4020. The control logic (software), when executed by the processor 4004, causes the processor 4004 to perform the functions in accordance with aspects described herein as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

The aspects discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, can be desirably combined into many other different systems or applications. Also that various presently unforeseen or unanticipated alternatives, modifications, variations, or improvements therein can be subsequently made by those skilled in the art which are also intended to be encompassed by the following claims.

A number of aspects have been described. Nevertheless, it will be understood that various modifications can be made without departing from the spirit and scope of the disclosure. For example, while a controller with a single pressure sensor has been described, additional pressure sensors (e.g., one for each inflatable bladder) can also be used without departing from the scope of the present disclosure. Accordingly, other aspects are within the scope of the following claims.

What is claimed is:

1. A compression garment controller for monitoring compliance of a user with respect to wearing a compression garment in accordance with a compression therapy, the controller comprising:
a display screen configured to display a graphical user interface;
at least one light emitting diode (LED) configured to selectively illuminate different colors;
at least one computer readable storage medium configured for storing one or more monitored parameters;
one or more processors coupled to the at least one computer readable storage medium; and
computer-executable instructions embodied on the at least one computer readable storage medium, the computer-executable instructions including instructions for causing the one or more processors to:
direct a flow of fluid from a pressurized fluid flow source to cyclically inflate and deflate at least one inflatable bladder of the compression garment configured to be wrapped around a limb of a wearer of the garment;
receive pressure signals indicative of fluid pressure in the at least one inflatable bladder from a pressure sensor communicatively coupled thereto during at least one of inflation and deflation of the at least one inflatable bladder in a plurality of successive compression cycles;
process the received pressure signals;
cause the at least one LED to illuminate a first color in response to the received pressure signals indicating compliance with compression therapy; and
cause the at least one LED to illuminate a second color in response to the received pressure signals indicating an interruption of operation or non-compliance with compression therapy.

2. The compression garment controller of claim 1, wherein the at least one processor is further configured to cause the at least one LED to illuminate a third color in response to the received pressure signals indicating an error with the compression therapy.

3. The compression garment controller of claim 1, wherein the compression garment controller further comprises a housing with an angled surface on each of vertical sides of the display screen with an LED located on each angled surface, whereby at least one LED is visible from the side of the compression garment controller.

4. The compression garment controller of claim 1, wherein the at least one processor is further configured to display a graphical user interface (GUI) on the display screen with the GUI including a compliance meter indicating compliance with the compression therapy.

5. The compression garment controller of claim 4, wherein the compliance meter is displayed as a twenty four (24) hour circular bar with a first color indicating compliance and a second color indicating non-compliance.

6. The compression garment controller of claim 5, wherein the first color is blue.

7. The compression garment controller of claim 5, wherein the second color is orange.

8. The compression garment controller of claim 5, wherein the displayed compliance meter indicates an amount of time for the compression therapy in a twenty four period.

9. The compression garment controller of claim 8, wherein the displayed compliance meter includes a current time and date within the circular bar.

10. The compression garment controller of claim 1, wherein the at least one processor is further configured to display a graphical user interface (GUI) on the display screen with the GUI including a plurality of compliance meters indicating compliance with the compression therapy on a per day basis.

11. The compression garment controller of claim 10, wherein the GUI displays up to six compliance meters on the display screen.

12. The compression garment controller of claim 1, wherein the at least one processor is further configured to:
receive a selection of a system time icon from a displayed menu;
display a map of a world along with a current time;
display a current time in response to navigation commands;
receive a selection of a highlighted current time zone; and
save the selected current time zone.

13. A controller attachment configured to couple a compression garment controller with a pole, the controller attachment comprising:
a first receiving portion including a concave portion adapted to receive a portion of a handle of the compression garment controller;
a second receiving portion coupled with the first receiving portion and including a channel adapted to receive one or more wires or tubes;
an interconnector coupled with the second receiving portion; and
a pole attachment portion coupled with the interconnector and having a U shape adapted to captively receive a pole.

14. The controller attachment of claim 13, wherein the pole attachment portion includes a threaded hole adapted to receive a screw with a knob coupled to an opposite end of the screw, whereby turning the knob advances the screw to secure the pole to the pole attachment portion.

15. The controller attachment of claim 14, wherein the pole is an intravenous (IV) pole.

16. A compression garment system for monitoring compliance of a user wearing a compression garment wrapped around a limb of the user in accordance with a compression therapy, the system comprising:
a compression garment; and
a controller, wherein the controller includes:
a display screen configured to display a graphical user interface (GUI);
a plurality of light emitting diodes (LEDs) arranged at a visible angle on the controller;
a memory; and
a processor coupled to the memory and configured to:
direct a flow of fluid from a pressurized fluid flow source to cyclically inflate and deflate an inflatable bladder of the compression garment configured to be wrapped around a limb of a wearer of the compression garment;
receive pressure signals indicative of fluid pressure in the inflatable bladder from a pressure sensor communicatively coupled thereto during at least one of inflation and deflation of the inflatable bladder in a plurality of successive compression cycles;
process the received pressure signals to determine compliance or non-compliance with the compression therapy;
cause the plurality of LEDs to illuminate in a first color in response to the received pressure signals indicating compliance with the compression therapy; and
cause the plurality of LEDS to illuminate in a second color in response to the received pressure signals indicating an interruption of operation or non-compliance with the compression therapy.

17. The compression garment system according to claim 16, wherein the compression garment is at least one of a leg sleeve, an ankle sleeve, a thigh sleeve, or a calf sleeve.

18. The compression garment system according to claim 17, wherein the compression garment includes a plurality of garments.

19. The compression garment system according to claim 18, wherein the plurality of garments include a combination of different sleeves.

20. The compression garment system according to claim 18, wherein the plurality of garments include two of a same sleeve.

21. The compression garment system according to claim 16, further comprising a pole attachment portion configured to secure the controller to a pole.

22. A method for a compression garment controller for monitoring compliance of a user wearing a compression garment wrapped around a limb of the user in accordance with a compression therapy, the method comprising:
directing a flow of fluid from a pressurized fluid flow source to cyclically inflate and deflate an inflatable bladder of the compression garment;
receiving pressure signals indicative of fluid pressure in the inflatable bladder from a pressure sensor communicatively coupled thereto during at least one of inflation and deflation of the inflatable bladder in a plurality of successive compression cycles;
processing the received pressure signals to determine compliance or non-compliance with the compression therapy;
causing at least one light emitting diode (LED) to illuminate in a first color in response to the received pressure signals indicating compliance with the compression therapy; and
causing the at least one LED to illuminate in a second color in response to the received pressure signals indicating an interruption of operation or non-compliance with the compression therapy.

23. The method according to claim 22, further comprising displaying, on a graphical user interface (GUI) of the controller, a compliance meter indicating compliance with the compression therapy.

24. The method according to claim 23, wherein the compliance meter is displayed as a twenty four (24) hour circular bar with a first color indicating compliance and a second color indicating non-compliance.

25. The method according to claim 23, wherein the displayed compliance meter indicates an amount of time for the compression therapy in a twenty four period.

26. The method according to claim 24, wherein the displayed compliance meter includes a current time and date within a circular bar.

27. The method according to claim 22, further comprising causing the LED to illuminate in a third color in response to the received pressure signals indicating an error with the compression therapy.

28. The method according to claim 22, further comprising displaying, on a graphical user interface (GUI) of the controller, a plurality of compliance meters indicating compliance with the compression therapy on a per day basis.

29. The method according to claim 28, wherein the GUI displays up to six compliance meters.
